(19) United States
(12) Patent Application Publication
(10) Pub. No.: US 2015/0085943 A1
(43) Pub. Date: Mar. 26, 2015

(54) VIDEO PROCESSING DEVICE, VIDEO PROCESSING METHOD, TELEVISION RECEIVER, PROGRAM, AND RECORDING MEDIUM

(71) Applicant: Sharp Kabushiki Kaisha, Osaka-shi, Osaka (JP)

(72) Inventors: Shigeki Taniguchi, Osaka-shi (JP); Akira Koike, Osaka-shi (JP); Yoshinori Kohno, Osaka-shi (JP); Tetsuo Ikeyama, Osaka-shi (JP); Masahiko Takiguchi, Osaka-shi (JP); Mihoko Watanabe, Osaka-shi (JP)

(73) Assignee: Sharp Kabushiki Kaisha, Osaka-shi, Osaka (JP)

(21) Appl. No.: 14/391,826

(22) PCT Filed: Mar. 22, 2013
(86) PCT No.: PCT/JP2013/058336

§ 371 Date: Oct. 10, 2014

(30) Foreign Application Priority Data
Apr. 11, 2012 (JP) 2012-090510
Apr. 11, 2012 (JP) 2012-090511
Apr. 11, 2012 (JP) 2012-090512
Apr. 12, 2012 (JP) 2012-091339
Apr. 16, 2012 (JP) 2012-093259
Apr. 16, 2012 (JP) 2012-093260
Feb. 27, 2013 (JP) 2013-037917

(51) Int. Cl. H04N 19/117; H04N 19/14; H04N 5/21; H04N 19/86; H04N 5/14; H04N 19/137; H04N 19/176

(52) U.S. Cl. CPC H04N 19/117; H04N 19/137; H04N 19/14; H04N 19/176; H04N 19/86; H04N 5/145; H04N 5/21
USPC 375/240.29

(57) ABSTRACT

On the basis of quantization codes of each separate block and results of motion determination of each separate block, a noise amount calculating section (150) of a video processing device (100) selects at least one noise reduction process that is applied to the target frame from among a plurality of noise reduction processes having different characteristics from each other.

### TECHNICAL FIELD

The present invention relates mainly to a video processing device and a video processing method for reducing noise in a picture.

### BACKGROUND ART

Conventionally, technologies for reducing noise that is generated in the process of decoding compression-encoded pictures have been under development.

Patent Literature 1, listed below, discloses a technology for setting a weighting coefficient on the basis of the distance from the boundary of an encoded block of block encoding, and for controlling the amount of image quality correction during image quality correction in accordance with the weighting coefficient.

Further, Patent Literature 2, listed below, discloses a technology for performing motion detection on the basis of the difference between a video signal obtained by performing a compression process on a video signal at a predetermined compression ratio and a video signal obtained by delaying the video signal by a predetermined number of frames and performing a compression process on it at a predetermined compression ratio, and for controlling, in accordance with a result of the motion detection, whether or not to cause the processing means to perform a noise reduction process on the video signal.

Further, Patent Literature 3, listed below, discloses a technology for attenuating or enhancing high-frequency components on the basis of a first activity value, a second activity value, and a quantization width value detected for each separate range of different size designated in a decoded image.

Further, Patent Literature 4, listed below, discloses a technology for predicting the compression ratio of a jpeg-compressed image, and for determining, in accordance with the compression ratio thus predicted, the order in which an image compression and noise reduction process and a color noise reduction process are performed. Further, Patent Literature 4 also teaches that in a case where it is possible to find out a compression ratio per se, a jpeg compression ratio determination process may be configured with the compression ratio as an index.

Further, Patent Literature 5, listed below, discloses a technology for switching, between a motion signal detected by a motion detection circuit and an amount of noise detected by a noise amount detection circuit, a multiplication coefficient of a coefficient unit that sets noise reduction characteristics.

Further, Patent Literature 6, listed below, discloses a technology for changing noise reduction characteristics for a video signal after decoding in accordance with whether the video signal after decoding is one obtained by decoding an I picture, a P picture, or a B picture. Further, Patent Literature 2 also discloses a technology for changing noise reduction characteristics for an I picture, a P picture, or a B picture in accordance with the transfer rate of an encoded video signal.

### CITATION LIST

Patent Literature 1

Japanese Patent Application Publication, Tokukaihei, No. 10-229546 A (Publication Date: Aug. 25, 1998)

Patent Literature 2

Japanese Patent Application Publication, Tokukai, No. 2007-166400 A (Publication Date: Jun. 28, 2007)

Patent Literature 3

Japanese Patent Application Publication, Tokukaihei, No. 8-149471 A (Publication Date: Jun. 7, 1996)

Patent Literature 4

Japanese Patent Application Publication, Tokukai, No. 2001-177731 A (Publication Date: Jun. 29, 2001)

Patent Literature 5

Japanese Patent Application Publication, Tokukaihei, No. 7-131680 A (Publication Date: May 19, 1995)

Patent Literature 6

Japanese Patent Application Publication, Tokukai, No. 2003-32685 A (Publication Date: Jan. 31, 2003)

### SUMMARY OF INVENTION

### Technical Problem

The technology disclosed in Patent Literature 1 is based on the premise that the distance from the boundary of an encoded block of block encoding is obtained. For this reason, a device that is incapable of obtaining the distance cannot employ the method, and ends up being incapable of a noise reduction process and an image-quality correction process. Further, a configuration in which the distance is obtained can be a cause of cost increases.

Further, even if a configuration, like the technology disclosed in Patent Literature 2, in which a noise reduction process is switched between on and off, there is such a first problem that image quality is not as improved as expected.

The present invention has been made in view of the first problem, and it is an object of the present invention to achieve a video processing device that is capable of performing an effective noise reduction process while suppressing cost increases.

Further, even if a configuration, like the technology disclosed in Patent Literature 3, in which a high-frequency component is attenuated or enhanced on the basis of a first activity value, a second activity value, and a quantization width value is used, there is such a second problem that image quality is not as improved as expected.

The present invention has been made in view of the second problem, and it is an object of the present invention to achieve a video processing device that is capable of performing an effective noise reduction process while suppressing cost increases.

Further, even if the technology disclosed in Patent Literature 4 is used, there is such a third problem that image quality is not as improved as expected.

The present invention has been made in view of the third problem, and it is an object of the present invention to achieve a video processing device that is capable of performing a more effective color noise reduction process than the conventional technologies while suppressing cost increases.

Further, the technology disclosed in Patent Literature 5, which requires a motion detection circuit and a noise amount detection circuit, has such a fourth problem as to invite cost increases.

The present invention has been made in view of the fourth problem, and it is an object of the present invention to achieve a video processing device that is capable of performing an effective noise reduction process while suppressing cost increases.

Further, there are also known technologies for determining the intensity of a noise reduction process on the basis of a quantization code value of a block constituting a target frame. For example, there is known a technology for determining whether or not a quantization code value of a block constituting a target frame is greater than a predetermined threshold value and thereby determines whether or not to execute a noise reduction process. Such a technology has such a problem that a noise reduction process of a uniform intensity is applied to a target frame determined as exceeding a predetermined threshold value. For example, in a case where a predetermined threshold value for quantization code values is 10, noise reduction processes of the same intensity are applied to a picture in which quantization code values of all blocks constituting a target frame are 11 and a picture in which quantization code values of all blocks constituting a target frame are 31, respectively. In actuality, the picture in which the quantization code values are 11 and the picture in which the quantization code values are 31 are different from each other in terms of the quantization code values at which the pictures are encoded and decoded, respectively. In a case where noise reduction processes of the same intensity are applied to such two pictures, the noise reduction process applied to the picture in which the quantization codes value are 11 is excessive in intensity for that picture and the noise reduction process applied to the picture in which the quantization codes value are 31 is insufficient in intensity for that picture.

Further, the aforementioned technology has such a problem that while an excessive noise reduction process is applied to a picture in which the quantization code values are 11, no noise reduction process is applied to a picture in which the quantization code values are 10. Such a noise reduction process may cause a feeling of strangeness in a user who is viewing the pictures.

That is, the aforementioned technology has such a fifth problem that depending on the value of a quantization code, a noise reduction of an appropriate intensity cannot be performed.

The present invention has been made in view of the fifth problem, and it is an object of the present invention to provide a video processing device that is capable of conducting a noise reduction of a more appropriate intensity than the conventional technologies while suppressing cost increases.

Further, although the technology disclosed in Patent Literature 6 changes noise reduction characteristics on each picture with attention focused on the difference among an I picture, a P picture, and a B picture, there has been such a sixth problem that image quality is not as improves as expected even by using the technology.

The present invention has been made on the basis of the inventors' findings in view of the sixth problem, and it is an object of the present invention to provide a video processing device that is capable of performing an effective noise reduction process while suppressing cost increases.

### Solution to Problem

In order to solve the first problem, a video processing device according to an aspect of the present invention is a video processing device for reducing noise in a picture obtained by decoding a video signal, the video processing device including: a noise reduction process selecting unit configured to, on a basis of quantization codes of each separate block constituting a target frame and results of motion determination of each separate block constituting the target frame, select at least one noise reduction process that is applied to the target frame from among a plurality of noise reduction processes having different characteristics from each other; and a noise reducing unit configured to apply the noise reduction process selected by the noise reduction process selecting unit to the target frame.

In order to solve the first problem, a video processing method according to an aspect of the present invention is a video processing method for reducing noise in a picture obtained by decoding a video signal, the video processing method including: a noise reduction process selecting step of, on a basis of quantization codes of each separate block constituting a target frame and results of motion determination of each separate block constituting the target frame, selecting at least one noise reduction process that is applied to the target frame from among a plurality of noise reduction processes having different characteristics from each other; and a noise reducing step of applying the noise reduction process selected in the noise reduction process selecting step to the target frame.

Further, in order to solve the second problem, a video processing device according to an aspect of the present invention is a video processing device for reducing noise in a picture obtained by decoding a video signal, the video processing device including: a setting unit configured to set a mosquito noise reduction parameter on a basis of quantization codes of each separate block constituting a target frame and either frequency characteristics or edge information of each separate block constituting the target frame; and a noise reducing unit configured to subject the target frame to a mosquito noise reduction process using the mosquito noise reduction parameter set by the setting unit.

Further, in order to solve the second problem, a video processing method according to an aspect of the present invention is a video processing method for reducing noise in a picture obtained by decoding a video signal, the video processing method including: a setting step of setting a mosquito noise reduction parameter on a basis of quantization codes of each separate block constituting a target frame, as well as frequency characteristics of each separate block constituting the target frame or edge information of each separate pixels constituting the target frame; and a noise reducing step of subjecting the target frame to a mosquito noise reduction process using the mosquito noise reduction parameter set in the setting step.

Further, in order to solve the third problem, a video processing device according to an aspect of the present invention is a video processing device for reducing noise in a picture obtained by decoding a video signal, the video processing device including: an intensity determining unit configured to determine an intensity of a color noise reduction process on a basis of quantization codes of each separate block constituting a target frame, a number of primary color pixels included in the target frame, and an area formed by primary pixels adjacent to each other; and a noise reducing unit configured to apply a color noise reduction process having an intensity determined by the intensity determining unit to the target frame.

Further, in order to solve the third problem, a video processing method according to an aspect of the present invention is a video processing method for reducing noise in a picture obtained by decoding a video signal, the video processing method including: an intensity determining step of determining an intensity of a color noise reduction process on a basis of quantization codes of each separate block constituting a target frame, a number of primary color pixels included in the target frame, and an area formed by primary pixels adjacent to each other; and a noise reducing step of applying a color noise reduction process having an intensity determined by the intensity determining unit to the target frame.

Further, in order to solve the fourth problem, a video processing device according to an aspect of the present invention is a video processing device for reducing noise in a picture obtained by decoding a video signal, the video processing device including: a noise reduction process selecting unit configured to, on a basis of quantization codes of each separate block constituting a target frame and motion vector information of each separate block constituting the target frame, select at least one noise reduction process that is applied to the target frame from among a plurality of noise reduction processes having different characteristics from each other; and a noise reducing unit configured to apply the noise reduction process selected by the noise reduction process selecting unit to the target frame.

Further, in order to solve the fourth problem, a video processing method according to an aspect of the present invention is a video processing method for reducing noise in a picture obtained by decoding a video signal, the video processing method including: a noise reduction process selecting step of, on a basis of quantization codes of each separate block constituting a target frame and motion vector information of each separate block constituting the target frame, selecting at least one noise reduction process that is applied to the target frame from among a plurality of noise reduction processes having different characteristics from each other; and a noise reducing step of applying the noise reduction process selected in the noise reduction process selecting step to the target frame.

Further, in order to solve the fifth problem, a video processing device according to an aspect of the present invention is a video processing device for reducing noise in a picture obtained by decoding a video signal, the video processing device including: a setting unit configured to obtain quantization code values of each separate block constituting a target frame, to calculate a noise reduction parameter in the target frame on a basis of each of the quantization code values, and to set a noise reduction process intensity within a predetermined range to have a positive correlation with the noise reduction parameter within a predetermined range; and a noise reducing unit configured to subject the target frame to a noise reduction process using the noise reduction process intensity set by the setting unit.

Further, in order to solve the fifth problem, a video processing method according to an aspect of the present invention includes: a setting unit configured to obtain quantization code values of each separate block constituting a target frame, of calculating a noise reduction parameter in the target frame on a basis of each of the quantization code values, and of setting a noise reduction process intensity within a predetermined range to have a positive correlation with the noise reduction parameter within a predetermined range; and a noise reducing unit configured to subject the target frame to a noise reduction process using the noise reduction process intensity set by the setting unit.

Further, in order to solve the sixth problem, a video processing device according to an aspect of the present invention includes: a setting unit configured to set an offset of a noise reduction parameter on a basis of quantization codes of each separate block constituting an I picture contained in video data; a changing unit configured to change the offset in accordance with a frame interval between I pictures; and a noise reducing unit configured to subject the video data to a noise reduction process using the noise reduction parameter including the offset changed by the changing unit.

Further, in order to solve the sixth problem, a video processing method according to an aspect of the present invention includes: a setting step of setting an offset of a noise reduction parameter on a basis of quantization codes of each separate block constituting an I picture contained in video data; a changing step of changing, in accordance with a frame interval between I pictures, the offset set by the setting unit; and a noise reducing step of subjecting the video data to a noise reduction process using the noise reduction parameter including the offset changed by the changing unit.

### Advantageous Effects of Invention

As described above, a video processing device according to an aspect of the present invention is a video processing device for reducing noise in a picture obtained by decoding a video signal, the video processing device including: a noise reduction process selecting unit configured to, on a basis of quantization codes of each separate block constituting a target frame and results of motion determination of each separate block constituting the target frame, select at least one noise reduction process that is applied to the target frame from among a plurality of noise reduction processes having different characteristics from each other; and a noise reducing unit configured to apply the noise reduction process selected by the noise reduction process selecting unit to the target frame.

As described above, a video processing device according to an aspect of the present invention is a video processing device for reducing noise in a picture obtained by decoding a video signal, the video processing device including: a setting unit configured to set a mosquito noise reduction parameter on a basis of quantization codes of each separate block constituting a target frame, as well as frequency characteristics of each separate block constituting the target frame or edge information of each separate pixels constituting the target frame; and a noise reducing unit configured to subject the target frame to a mosquito noise reduction process using the mosquito noise reduction parameter set by the setting unit.

As described above, a video processing device according to an aspect of the present invention is a video processing device for reducing noise in a picture obtained by decoding a video signal, the video processing device including: an intensity determining unit configured to determine an intensity of a color noise reduction process on a basis of quantization codes of each separate block constituting a target frame, a number of primary color pixels included in the target frame, and an area formed by primary pixels adjacent to each other; and a noise reducing unit configured to apply a color noise reduction process having an intensity determined by the intensity determining unit to the target frame.

As described above, a video processing device according to an aspect of the present invention is a video processing device for reducing noise in a picture obtained by decoding a video signal, the video processing device including: a noise reduction process selecting unit configured to, on a basis of quantization codes of each separate block constituting a target frame and motion vector information of each separate block constituting the target frame, select at least one noise reduction process that is applied to the target frame from among a plurality of noise reduction processes having different characteristics from each other; and a noise reducing unit configured to apply the noise reduction process selected by the noise reduction process selecting unit to the target frame.

As described above, a video processing device according to an aspect of the present invention is a video processing device for reducing noise in a picture obtained by decoding a video signal, the video processing device including: a setting unit configured to obtain quantization code values of each separate block constituting a target frame, for calculating a noise reduction parameter in the target frame on a basis of each of the quantization code values, and for setting a noise reduction process intensity within a predetermined range to have a positive correlation with the noise reduction parameter within a predetermined range; and a noise reducing unit configured to subject the target frame to a noise reduction process using the noise reduction process intensity set by the setting unit.

As described above, a video processing device according to an aspect of the present invention includes: a setting unit configured to set an offset of a noise reduction parameter on a basis of quantization codes of each separate block constituting an I picture contained in video data; a changing unit configured to change the offset in accordance with a frame interval between I pictures; and a noise reducing unit configured to subject the video data to a noise reduction process using the noise reduction parameter including the offset changed by the changing unit.

Each of these configurations makes it possible to perform an effective noise reduction process while suppressing cost increases.

### BRIEF DESCRIPTION OF DRAWINGS

FIG. 1 is a functional block diagram of a video processing device according to Embodiment 1.

FIG. 2 is a flow chart of an operation of a video processing device according to Embodiment 2.

FIG. 3 is a functional block diagram of a video processing device according to Embodiment 4.

FIG. 4 is a functional block diagram of a video processing device according to Embodiment 5.

FIG. 5 is a diagram conceptually showing a relationship between the amount of a correction that the video processing device 100 makes to a picture and the amount of noise in the picture.

FIG. 6 is a block diagram showing a configuration of a video processing device according to an embodiment of the present invention.

FIG. 7, which is a diagram for explaining a video processing device according to an embodiment of the present invention, is a diagram showing examples of quantization codes for each separate pixel and an example of a threshold value.

FIG. 8, which is a set of diagrams (a) and (b) for explaining a video processing device according to an embodiment of the present invention, (a) showing a frame that is referred to in a 3D noise reduction process, (b) showing a frame that is referred to in a 2D noise reduction process.

FIG. 9, which is a diagram for explaining a video processing device according to an embodiment of the present invention, shows a “moving” block and a “motionless” block.

FIG. 10, which is a diagram for explaining a video processing device according to an embodiment of the present invention, is a diagram showing intensities of each separate noise reduction process that are designated by the percentage of quantization codes exceeding the threshold value and the percentage of “moving” blocks.

FIG. 11, which is a diagram for explaining a video processing device according to an embodiment of the present invention, is a diagram showing examples of quantization codes for each separate pixel and an example of a threshold value.

FIG. 12, which is a diagram for explaining a video processing device according to an embodiment of the present invention, is a diagram showing intensities of each separate noise reduction process that are designated by the percentage of quantization codes exceeding the threshold value and the percentage of “moving” blocks.

FIG. 13 is a block diagram showing a configuration of a video processing device according to an embodiment of the present invention.

(a) of FIG. 14 is a conceptual diagram for explaining mosquito noise, and (b) of FIG. 14 is an outside view for explaining a region that is referred to in a mosquito reduction process.

FIG. 15 which is a diagram for explaining a video processing device according to an embodiment of the present invention, is a histogram showing the frequency characteristics of pixels constituting a target frame.

FIG. 16, which is a diagram for explaining a video processing device according to a modification of an embodiment of the present invention, is a diagram showing intensities of each separate noise reduction process that are designated by the percentage of quantization codes exceeding the threshold value and the percentage of frequency components constituting a target frame.

FIG. 17, which is a diagram for explaining a video processing device according to a modification of an embodiment of the present invention, is a diagram showing intensities of each separate noise reduction process that are designated by the percentage of quantization codes exceeding the threshold value and the percentage of frequency components constituting a target frame.

FIG. 18 is a block diagram showing a configuration of a video processing device according to an embodiment of the present invention.

FIG. 19, which is a diagram for explaining a video processing device according to an embodiment of the present invention, is a conceptual diagram showing a case where a frame in which a picture is displayed contains a pattern that is determined as color noise and a pattern that is determined as having been artificially added.

FIG. 20, which is a diagram for explaining a video processing device according to an embodiment of the present invention, is a diagram showing intensities of each separate noise reduction process that are designated by the percentage of quantization codes exceeding the threshold value and results of determination of primary color pixels.

FIG. 21 is a block diagram showing a configuration of a video processing device according to an embodiment of the present invention.

FIG. 22, which is a diagram for explaining a video processing device according to an embodiment of the present invention, shows an example of a motion vector.

FIG. 23 is a block diagram showing a configuration of a video processing device according to an embodiment of the present invention.

FIG. 24, which is a set of diagrams (a) and (b) for explaining a video processing device according to an embodiment of the present invention, (a) showing a histogram of quantization code values of each separate block constituting a target frame, (b) showing a correlation between a noise reduction parameter and a noise reduction process intensity.

FIG. 25 is a block diagram showing a configuration of a video processing device according to an embodiment of the present invention.

FIG. 26, which is a diagram for explaining a video processing device according to an embodiment of the present invention, is a diagram showing a plurality of pictures contained in video data, an NR parameter in each of the pictures, an offset in each of the pictures, and an NR gain in each of the pictures.

FIG. 27, which is a diagram for explaining a video processing device according to an embodiment of the present invention, is a diagram schematically showing an offset (N) and an offset (M).

### DESCRIPTION OF EMBODIMENTS

### Embodiment 1

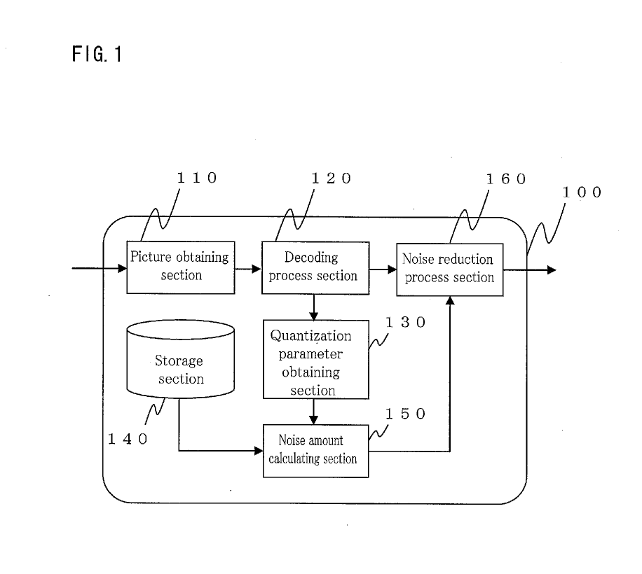

FIG. 1 is a functional block diagram of a video processing device 100 according to Embodiment 1 of the present invention. The video processing device 100 is a device that corrects noise in a video signal inputted thereto. The video processing device 100 includes a picture obtaining section 110, a decoding process section 120, a quantization parameter obtaining section 130, a storage section 140, a noise amount calculating section 150, and a noise reduction process section 160.

The video processing device 100 is suitably used in a television receiver that decodes a TS (transport stream) transmitted as a broadcast signal and displays a picture obtained by decoding the TS.

(Picture Obtaining Section 110)

The picture obtaining section 110 receives a video signal obtained by converting a picture into a signal. A possible source from which such a video signal is obtained may be any form of video signal source such as a broadcast wave or video data stored in a storage medium. However, such a video signal needs to be one obtained by employing such a method that the after-mentioned quantization parameter can be obtained.

(Decoding Process Section 120)

The decoding process section 120 decodes a video signal obtained by the picture obtaining section 110. Since it is usual that such a video signal has been encoded by some sort of method, the video signal needs to be processed by the decoding process section 120.

A vide signal that is decoded by the decoding process section 120 is one encoded, for example, by MPEG-1, MPEG-2, H.264/MPEG-4.AVC, or the like.

The decoding process section 120 generates a decoded image by generating a predicted image by either intra-screen prediction (intra prediction) or inter-screen prediction (inter prediction) and adding, to pixel values of the predicted image, pixel values obtained through decoding from the video signal, respectively.

In generating a predicted image by inter prediction, the decoding process section 120 generates the predicated image by, with reference to one or more decoded images stored in a frame memory (not illustrated), making a motion compensation using motion vectors with respect to each separate block constituting the decoded image(s). It should be noted here that motion vector information representing each motion vector is decoded from the video signal.

Further, a video signal usually contains a quantization transform coefficient (also referred to simply as “transform coefficient”) that is obtained by performing frequency transform (e.g. DCT (Discrete Cosine Transform)) on pixel values of pixels contained in each block and then performing a quantization process according to the quantization parameter. For example, in the case of a video signal encoded for each block of 8×8 pixels, the video signal contains a quantization transform coefficient of 8×8 components for each block.

In decoding such a video signal, the decoding process section 120 decodes each pixel value by performing inverse frequency transform after performing inverse quantization on each transform coefficient with reference to the quantization parameter.

Further, frames (pictures) contained in a video signal fall roughly into the following categories:
I Picture: A picture that can be decoded without reference to another picture. An I picture is, for example, an image encoded by the aforementioned intra prediction.
P Picture: A picture that can be decoded with reference to another one picture. A P picture is, for example, an image encoded by the aforementioned inter prediction.
B Picture: A picture that can be decoded with reference to another two pictures. A B picture is, for example, an image encoded by the aforementioned inter prediction.

(Quantization Parameter Obtaining Section 130)

The quantization parameter obtaining section 130 obtains a quantization parameter that the decoding process section 120 uses in the process of decoding a video signal. As mentioned above, most image encoding methods include performing a quantization process in encoding a picture. This quantization parameter is passed in any form onto a side that performs a decoding process, as it is needed for performing the decoding process. For example, a quantization parameter for each video block can be described in the header portion of a video stream. The quantization parameter obtaining section 130 obtains this quantization parameter in accordance with a format that an encoding method employs.

It should be noted that a quantization parameter is also referred to as “quantization code”.

Further, in the case of a picture that has not been encoded, a quantization parameter cannot be obtained; however, since an encoding process has not been performed and accordingly noise due to encoding is not generated, there is no need to employ a method according to the present invention.

(Storage Section 140)

The storage section 140 has stored therein a threshold value for calculating the amount of noise in the picture using a quantization parameter. This threshold value is used for determining, on the basis of the magnitude of the value of the quantization parameter, whether or not many high-frequency components have been eliminated from a video block to which the quantization parameter is applied.

(Noise Amount Calculating Section 150)

The noise amount calculating section 150 calculates the amount of noise in the picture using a quantization parameter obtained by the quantization parameter obtaining section 130 and a threshold value stored in the storage section 140. The method of calculation will be described later.

(Noise Reduction Process Section 160)

The noise reduction process section 160 performs a process of reducing noise in the picture on the basis of a noise amount calculated by the noise amount calculating section 150. Specific examples include a process of eliminating a high-frequency component from an image (mosquito noise reduction process), a process of reducing noise that is generated at a boundary portion of an image (block noise reduction process), etc.

The picture obtaining section 110, the decoding process section 120, the quantization parameter obtaining section 130, the noise amount calculating section 150, and the noise reduction process section 160 can be achieved by the use of hardware such as a circuit device that performs these functions, or can also be configured by the use of an arithmetic device such as a microcomputer or a CPU (central processing unit) and software that defines the operation of the arithmetic device.

The storage section 140 can be configured by the use of a storage device such as an HDD (hard disk drive).

A configuration of the video processing device 100 according to Embodiment 1 has been described above. Next, a process by which the video processing device 100 calculates the amount of noise in a picture is described, together with a basic concept.

### Embodiment 1

### Concept of Noise Amount Calculation

In general, for encoding of a video signal, a quantization process is performed. This process can be said to be intended mainly to compress the amount of information by thinning high-frequency components of a video signal. For example, a scale of amplitude value is reduced by dividing the amplitude value of each frequency component by a quantization parameter. This leads to a reduction in the number of bits that are necessary for expressing the amplitude value of each frequency component, and also makes it possible to perform a process such as simplification by approximation of a minute amplitude value to 0. This in turn makes it possible to reduce the amount of information that is necessary for expressing the picture.

For decoding of a video signal, the picture may be divided into a plurality of regions (blocks) and an encoding process and a quantization process may be performed on each of the blocks. In this case, different quantization parameters can be adopted for each separate block. A great value of a quantization parameter for a block means that a larger number of high-frequency components were eliminated in the process of encoding. That is, decoding a block whose quantization parameter takes on a great value tends to easily generate noise in a picture after decoding, as a larger number of high-frequency components have been lost.

In each of the embodiments according to the present invention, with attention focused on this point, the magnitude of the amount of noise in the block after decoding is estimated on the basis of the magnitude of a value of a quantization parameter. With a system of encoding in which a quantization process is performed in performing an encoding process, it is always possible to obtain a quantization parameter at the decoding side. Therefore, by calculating a noise amount using a quantization parameter under a system of encoding that employs quantization, such an advantage is brought about that a noise amount can be surely calculated without employing a special system of encoding or calculation method.

Once a noise amount has been calculated, such an optimum correction process can be performed that by subjecting the picture to a correction process (noise reduction process) appropriate for the noise amount, a small correction amount is set for a block with little noise and a large correction amount is set for a block with much noise.

### Embodiment 1

### Noise Reduction Procedure

The following describes a procedure by which the video processing device 100 calculates a noise amount and performs a noise reduction process using the noise amount.

(Step 1: Obtain a Video Signal)

The picture obtaining section 110 obtains a video signal from a given video signal source.

(Step 2: Obtain a Quantization Parameter)

The decoding process section 120 decodes the video signal obtained by the picture obtaining section 110. The quantization parameter obtaining section 130 obtains a quantization parameter that is obtained in the process of decoding the video signal. In a case where quantization parameters are set for each separate block in a picture, quantization parameters for each separate block are obtained.

(Step 2: Supplementary Explanation)

Methods by which the quantization parameter obtaining section 130 obtains a quantization parameter vary from encoding method to encoding method. For example, as mentioned earlier, in a case where a quantization parameter is recorded in a video signal per se, it is only necessary to obtain the value of the quantization parameter. A quantization parameter does not necessarily need to be derived from a video signal per se; however, since a value of a quantization parameter is needed in performing a decoding process, no matter which encoding method is employed, it is only necessary to obtain the value of the quantization parameter.

(Step 3: Obtain a Threshold Value)

The noise amount calculating section 150 obtains the quantization parameter obtained by the quantization parameter obtaining section 130, and also obtains, from the storage section 140, a threshold value for calculating the amount of noise in the picture on the basis of the quantization parameter.

(Step 4: Calculate a Noise Amount)

The noise amount calculating section 150 counts the number of those ones of the video blocks in the picture whose quantization parameters take on values exceeding the threshold value. The noise calculating section 150 calculates the amount of noise in the picture by using a result of the counting.

(Step 4: Supplementary Explanation 1)

It should be noted that a large number of blocks whose quantization parameters takes on values exceeding the threshold value means a large number of blocks from which many high-frequency components have been eliminated. Since decoding a block from which many high-frequency components have been eliminated tends to lead to a greater difference between before and after encoding, the block is treated as one with much noise after decoding. Since a larger number of blocks with much noise tend to lead to a larger amount of noise in the picture as a whole. Therefore, the noise amount is defined by the number of blocks whose quantization parameters exceed the threshold value.

(Step 4: Supplementary Explanation 2)

Further, in this step, the noise amount may be the number of blocks whose quantization parameters exceed the threshold value, or the noise amount may be recalculated by applying some sort of arithmetic expression to the number of blocks. It is common to both of the cases that the amount of noise in the picture is calculated on the basis of the number of blocks whose quantization parameters exceed the threshold value. The same applies to the embodiments described below.

(Step 5: Noise Reduction Process)

The noise reduction process 160 performs a noise reduction process after adjusting, in accordance with the noise amount calculated by the noise amount calculating section 150, an amount by which noise in the picture is reduced. Specifically, when the amount of noise in the picture is large, the intensity of the noise reduction process is made higher. For example, the amount of reduction (filter gain) in a high-frequency component that is eliminated by a high-frequency filter is made larger.

(Step 5: Supplementary Explanation 1)

It should be noted that since the quantization process is a process of eliminating a high-frequency component in the process of encoding, increasing the amount by which a high-frequency component is eliminated in this step seems to be doubly eliminating the high-frequency component. However, decoding a picture from which a high-frequency component was eliminated in the process of encoding may undesirably generate high-frequency noise all the more because the original high-frequency component was lost in the process of encoding. A typical example of this case is block noise, which looks as if the image is divided in a grid-like pattern by block boundaries. In this way, this step is also effective for effectively eliminating noise that is generated after decoding.

(Step 5: Supplementary Explanation 2)

Further, Embodiment 1 uses a quantization parameter as a reference for calculating the amount of noise after decoding. A reason for this is that a quantization parameter can be obtained at the decoding side without fail, taking into account the point that a quantization parameter suggests a degree of information compression. That is, since a large value of a quantization parameter means that more high-frequency components have been eliminated, it is probable that more noise is generated after decoding. Therefore, it is reasonable to estimate a noise amount on the basis of the magnitude of a quantization parameter. The present invention is advantageous because these two benefits are effectively enjoyed.

### Embodiment 1

### Summary

As described above, the video processing device 100 according to Embodiment 1 calculates the amount of noise in the picture using the number of blocks whose quantization parameters take on values exceeding the threshold value. In a case where a quantization process was performed in the process of video encoding, the quantization parameters can also be obtained at the decoding side. This eliminates the need to use special information for calculating the noise amount or employ a unique calculation method, and makes it possible to surely calculate the noise amount.

Further, in Embodiment 1, the calculation of a noise amount using the number of blocks whose quantization parameters take on values exceeding the threshold value is based on the findings that decoding a block from which a high-frequency component was eliminated in the process of encoding generates more noise. This makes it possible to calculate a noise amount in accordance with the course of an encoding process, thus making it possible to find a noise amount appropriate for the characteristics of an image.

Further, in Embodiment 1, a noise reduction amount is adjusted in accordance with the noise amount thus calculated. This makes it possible to avoid such a problem that noise is undesirably increased by setting a large noise reduction amount for a picture with little noise, thus making it possible to carry out an appropriate noise reduction process.

### Embodiment 2

Embodiment 1 calculates a noise amount with reference to whether a quantization parameter exceeds a threshold value. Embodiment 2 of the present invention performs classifies the values of quantization parameters into a plurality of levels on the basis of their magnitude, assigns a weighting coefficient to each of the levels, multiplies the values of the quantization parameters at each of the levels by the weighting coefficient, and then sums up the results. This is intended to analyze the degree of noise in the picture in more detail and more properly calculate the amount of noise after decoding. Since the video processing device 100 of Embodiment 2 is identical in configuration to that of Embodiment 1, the following mainly describes points of difference in the calculation method.

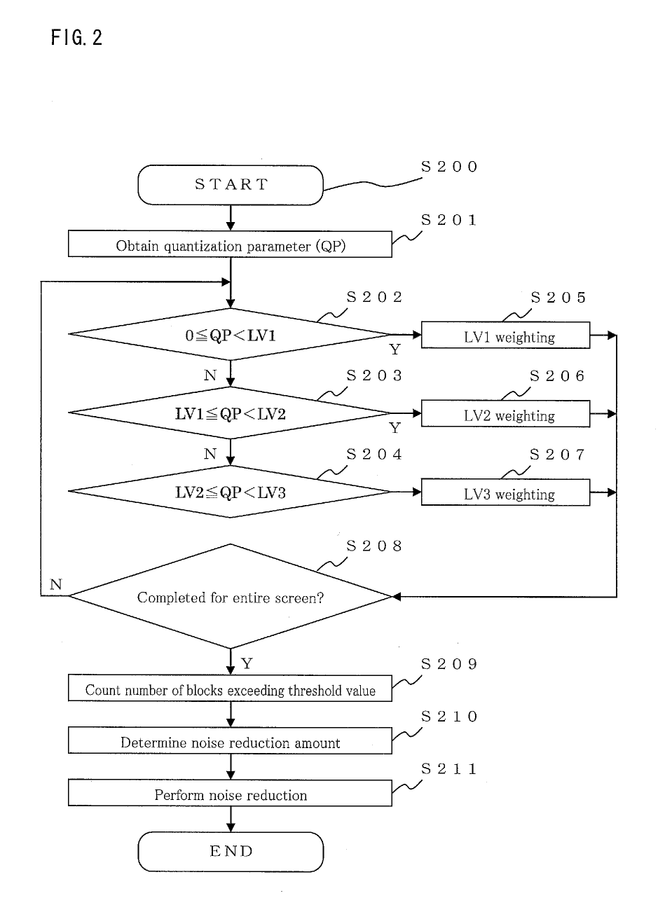

FIG. 2 is a flow chart of an operation of the video processing device according to Embodiment 2. The following describes each of the steps of FIG. 2.

(Step S200)

The flow of the operation gets started when the picture obtaining section 100 obtains a video signal. The decoding process section 120 decodes the video signal obtained by the picture obtaining section 110.

(Step S201)

As described in Embodiment 1, the quantization parameter obtaining section 130 obtains quantization parameters of each separate video block that is obtained in the process of decoding.

(Steps S202 to S204)

The noise amount calculating section 150 classifies the values of the quantization parameters of each separate video block obtained by the quantization parameter obtaining section 130 into a plurality of levels according to their magnitude. The example shown here is one where the values of the quantization parameters are classified into three levels. However, the present invention is not limited to such an example. The noise amount calculating section 150 determines which of the three levels the values of the quantization parameters belong to.

(Steps S205 to S207)

According to the levels to which the values of the quantization parameters belong, the noise amount calculating section 150 multiplies each of the quantization parameters by a predetermined weighting coefficient. While Embodiment 1 uses the value of a quantization parameter as it is, Embodiment 2 uses a value obtained by multiplying the value of a quantization parameter by a weighting coefficient. This makes it possible to more finely adjust the process of calculation of a noise amount, for example, by adjusting the weighting coefficient.

(Steps S205 to S207: Supplementary Explanation 1)

The weighting coefficient in this step does not necessarily need to be common to all of the blocks. For example, such adjustments can be made that weighting coefficients at each separate level are set smaller as a whole for blocks considered to be low in importance and LV2 to 3 are set higher for blocks considered to be high in importance than the other blocks.

(Steps S205 to S207: Supplementary Explanation 2)

The value of the weighting coefficient needs only be stored in advance in a storage device such as the storage section 140 and appropriately read out when needed.

(Step S208)

The noise amount calculating section 150 determines whether or not these steps haven been completed for the blocks of the screen as a whole. If not, the noise amount calculating section 150 returns to step S202 to repeat the same process. If yes, the noise amount calculating section 150 proceeds to step S209.

(Steps S209 to S211)

As in Embodiment 1, the noise amount calculating section 150 counts the number of blocks whose quantization parameters take on values exceeding the threshold value and calculates the amount of noise in the picture on the basis of a result of the counting. A difference from Embodiment 1 is that the present embodiment compares a quantization parameter with the threshold value after multiplying the quantization parameter by a weighting coefficient. The process in the noise reduction process section 160 of the present embodiment is identical to that of Embodiment 1.

### Embodiment 2

### Summary

According to Embodiment 2, as described above, the noise amount calculating section 150 classifies quantization parameters into levels and assigns weighting coefficients to each separate level. The noise amount calculating section 150 calculates the amount of noise in the picture by summing up results obtained by multiplying each separate quantization parameter by the weighting coefficients. This makes it possible to adjust the weighting coefficients in addition to the threshold value stored in the storage section 140, thus making it possible to more finely adjust the process of calculation of a noise amount.

For example, besides the aforementioned method of adjusting the weighting coefficients according to the importance of each separate block, a method of adjusting the weighting coefficients according to the type of picture or the like may be employed. It should be noted that the adjustment of the threshold value and the weighting coefficients may be dynamically performed every time a picture is inputted, or a plurality of combinational patterns that are predicted in advance may be stored in the storage section 140 and any of them may be applied when a picture is inputted.

### Embodiment 3

In Embodiments 1 and 2, the number of blocks whose quantization parameters take on values exceeding the threshold value are counted and the count value was adopted as the amount of noise in the picture. As another modification, the number of blocks whose quantization parameters exceed the threshold value are counted and a value obtained by dividing the count value by the total number of blocks, i.e. the percentage of the blocks whose quantization parameters are great, may be defined as a noise amount.

Further, also in such a case as in Embodiment 2 where a quantization parameter is multiplied by a weighting coefficient, a value obtained by dividing the finally obtained counting result by the total number of blocks, i.e. the percentage of blocks whose quantization parameters after weighting are great, may be defined as the amount of noise in the picture.

### Embodiment 4

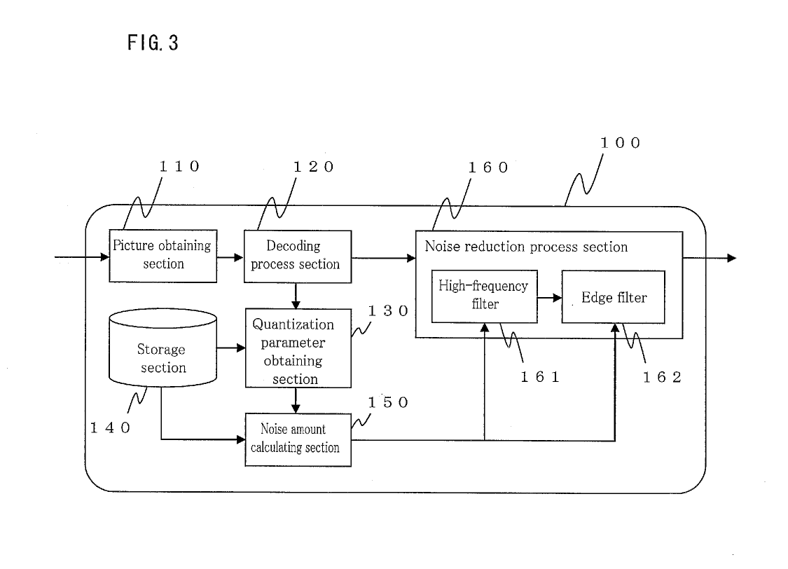

FIG. 3 is a functional block diagram of a video processing device 100 according to Embodiment 4 of the present invention. In each of the configurations described in Embodiments 1 to 3, the video processing device 100 according to Embodiment 4 of the present invention further includes a high-frequency filter 161 and an edge filter 162 as internal functions of the noise reduction process section 160. As for the other components, Embodiment 4 is identical to Embodiments 1 to 3.

The high-frequency filter 161 is a filter that eliminates a high-frequency component from a video signal decoded by the decoding process section 120. The high-frequency filter 161 performs a process of eliminating a high-frequency component from the entire screen of a video signal decoded by the decoding process section 120. It should be noted the high-frequency filter 161 is configured such that the amount of a high-frequency component that is eliminated (filter gain) can be changed.

The edge filter 162 is a filter that eliminates noise (edge noise) generated in a contoured part of a video signal decoded by the decoding process section 120. For example, the edge filter 162 eliminates mosquito noise or the like that is generated in an edge region of an image. The edge filter 162 performs a process of eliminating edge noise from the entire screen of a video signal decoded by the decoding process section 120. It should be noted the edge filter 162 is configured such that the amount of a high-frequency component that is eliminated (filter gain) can be changed.

In Embodiment 4, the noise amount calculating section 150 adjusts the noise reduction amount of the high-frequency filter 161 and the noise reduction amount of the edge filter 162 on the basis of the noise amount thus calculated. Specifically, the noise amount calculating section 150 increases the noise reduction amount of each filter when the amount of noise in the picture is larger, thus reducing noise after decoding.

In Embodiment 4, since noise is reduced by the noise filters, it is only necessary to adjust the filter gains to adjust the noise reduction amounts. In a case where noise is reduced by this method, the noise reduction amounts are adjusted in accordance with the method.

### Embodiment 4

### Summary

According to Embodiment 4, as described above, the noise amount calculating section 150 adjusts the filter gain of each noise filter on the basis of the noise amount thus calculated. This makes it possible to adjust the noise correction process amount in accordance with the noise amount thus calculated.

### Embodiment 5

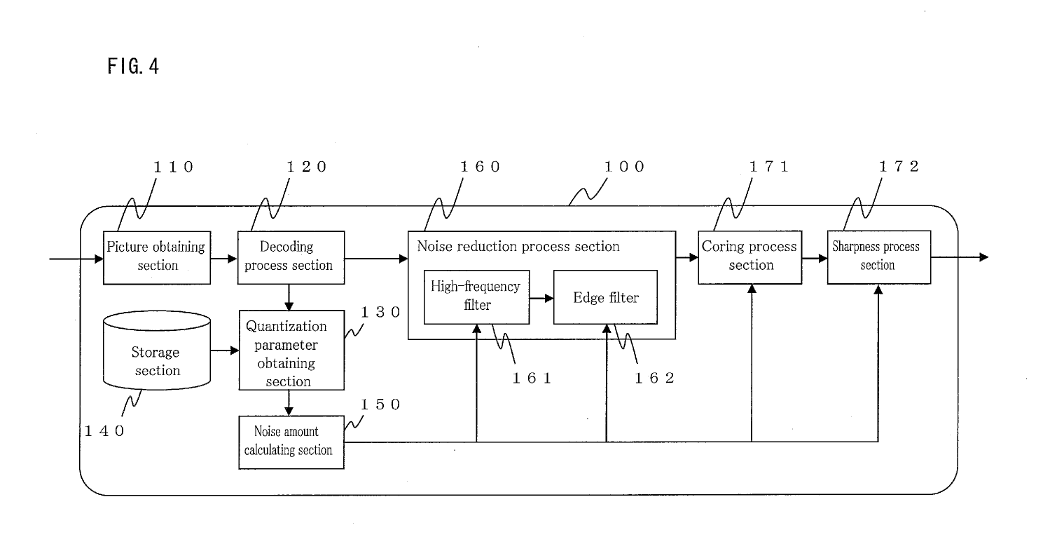

FIG. 4 is a functional block diagram of a video processing device 100 according to Embodiment 5 of the present invention. In addition to the components described in Embodiments 1 to 4, the video processing device 100 according to Embodiment 5 further include a coring process section 171 and a sharpness process section 172. As for the components, Embodiment 5 is identical to Embodiments 1 to 4.

Although the example shown in FIG. 4 is one where the coring process section 171 and the sharpness process section 172 are provided in addition to the components described in Embodiment 4, the coring process section 171 and the sharpness process section 172 may be provided under the configuration of another embodiment.

The coring process section 171 performs a process of eliminating a minute high-frequency component from the entire screen of a picture subjected to a noise reduction process by the noise reduction process section 160. This is intended to remove a high-frequency component in advance so that the sharpness process section 172, described next, does not enhance high-frequency noise. In particular, block noise that is generated in a boundary portion of a video block may not be sufficiently eliminated by the high-frequency filter 161. By the coring process section 171 eliminating block noise in advance, the influence of enhancement of block noise by the sharpness process section 172, if any, can be curbed.

The sharpness process section 172 performs a contour enhancement process on the entire screen of a picture subjected to a noise reduction process by the noise reduction process section 160. Since the contour enhancement process has an effect of amplifying a high-frequency component, the contour enhancement process is performed after the coring process section 171 has eliminated a minute high-frequency component.

### Embodiment 5

### Summary

According to Embodiment 5, as described above, after a process of reducing high-frequency noise is performed in accordance with a result of calculation by the noise amount calculating section 150, a contour enhancement process is performed by the sharpness process section 172, whereby a sharp picture can be obtained while noise is eliminated.

Further, according to Embodiment 5, minute high-frequency noise such as block noise is eliminated by the coring process section 171, whereby the effect of contour enhancement can be effectively exhibited by suppressing the adverse effect of the sharpness process section 172.

### Embodiment 6

Embodiments 4 and 5 assume that the object to be processed by the high-frequency filter 161, the edge filter 162, the coring process section 171, and the sharpness process section 172 is the entire screen of a picture. However, the object to be processed by each of these components may be limited to some of the blocks of a picture. For example, the process of each of the components may be performed only on blocks in which the values of the quantization, parameters (or the values of the quantization parameters after weighting) exceed the threshold value.

This makes it possible to perform a noise reduction process on a block in which the noise amount is large and sharpen an image whose clearness decreased along with the noise reduction process. Further, an advantage over Embodiments 4 and 5 is that the processing load can be reduced by limiting blocks that are to be processed.

It should be noted that the balance between a particular block and an adjacent block may be disrupted when a noise reduction process and a sharpening process are performed only on the particular block. This possibility may be avoided, for example, by performing a similar noise reduction process and a similar sharpening process on a surrounding region including a block in which the noise amount is large. This makes it possible to keep the balance with another block while reducing the processing load.

### Embodiment 7

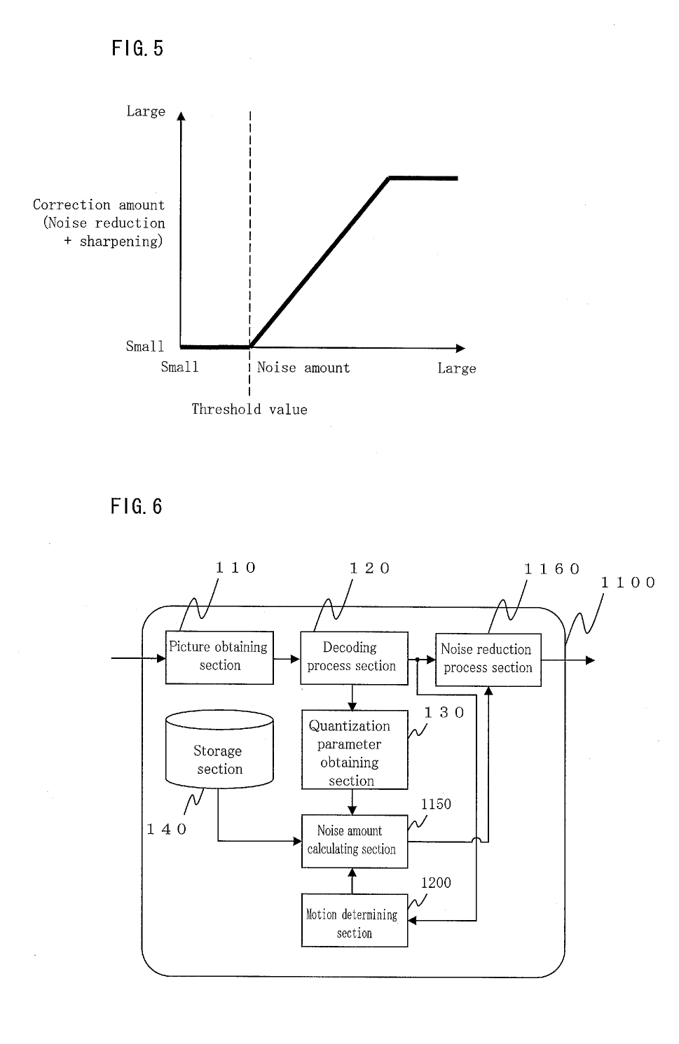

FIG. 5 is a diagram conceptually showing a relationship between the amount of a correction that a video processing device 100 according to the present invention makes to a picture and the amount of noise in the picture.

In the present invention, the amount of noise in the picture is calculated on the basis of blocks whose quantization parameters take on values exceeding the threshold value; therefore, as long as the values of the quantization parameters do not exceed the threshold value, it cannot be determined that there is noise. That is, until the noise amount reaches the threshold value, the amount of correction to the picture does not increase but stays substantially constant.

Once the noise amount exceeds the threshold value, the noise reduction amount in the noise reduction process section 160 is increased when the noise amount increases. Therefore, there is a proportional relationship between the noise amount and the correction amount.

The processing characteristics of the video processing device 100 can be adjusted by adjusting the threshold value and the proportionality coefficient between the noise amount and the correction amount in FIG. 5. Further, a similar effect can also be brought about by adjusting the weighting coefficient described in Embodiment 2.

In addition, the characteristics along the vertical axis in FIG. 5 can be adjusted by adjusting the noise reduction amount in the noise reduction process section 160 and the amount of processing in the coring process section 171 and the sharpness process section 172.

### Embodiment 8

In each of the embodiments described herein, possible examples of sources from which the picture obtaining section 110 obtains video signals are as follows:

(Example 1 of Video Signal Source) The picture obtaining section 110 obtains a video signal from an analog video broadcast wave.

(Example 2 of Video Signal Source) The picture obtaining section 110 obtains a video signal from a digital video broadcast wave.

(Example 3 of Video Signal Source) The picture obtaining section 110 obtains a video signal recorded in a storage medium such as Blu-ray (registered trademark) disk, a DVD (Digital Versatile Disk: registered trademark) or an HDD.

(Example 4 of Video Signal Source) The picture obtaining section 110 obtains a video signal from a broadcast wave such as an IP broadcast wave or a CATV broadcast wave.

(Example 5 of Video Signal Source) The picture obtaining section 110 obtains a video signal from an external device such as an external video recording device or an external picture obtaining device.

### Embodiment 9

A configuration in which noise reduction parameters for a noise reduction process are changed on the basis of quantization codes and results of motion determination is described below with reference to FIGS. 6 through 12.

FIG. 6 is a block diagram showing a configuration of a video processing device 1100 according to the present embodiment. As shown in FIG. 6, the video processing device 1100 according to the present embodiment includes a motion determining section 1200 in addition to the components shown in FIG. 1.

It should be noted that the configuration of the video processing device 1100 according to the present embodiment is not limited to that shown in FIG. 6, but may be a configuration in which the motion determining section 1200 is incorporated into the configuration shown in FIG. 3 or 4. Further, the present embodiment can be used in combination with any of the embodiments described above.

(Motion Determining Section 1200)

The motion determining section 1200 according to the present embodiment performs motion determination of each processing unit constituting a target frame which, of the frames constituting a picture supplied from the decoding process section 120, is a decoded frame serving as a target of motion determination, by comparing the target frame with another decoded frame. It should be noted here that the processing units of motion determination may be of the same size as or a different size from the aforementioned blocks. Further, the another frame may be a frame that is adjacent to the target frame, or may be a frame that is away from the target frame by a predetermined number of frames.

The motion determining section 1200 performs motion determination for each processing unit and determines, for each processing unit, whether or not the processing unit is a processing unit having a motion. More specifically, the motion determining section 1200 performs motion determination by performing the following process.

(Step S1001)

The motion determining section 1200 performs motion determination by comparing pixel values of a processing unit in a target frame with pixel values of another frame.

(Step S1002)

Then, the motion determining section 1200 compares a result of motion detection obtained in step S1001 with a threshold value stored in the storage section 140 and determines that a block exhibiting a motion that is larger than the threshold value is a “moving block” and a block not doing so is a “motionless block”.

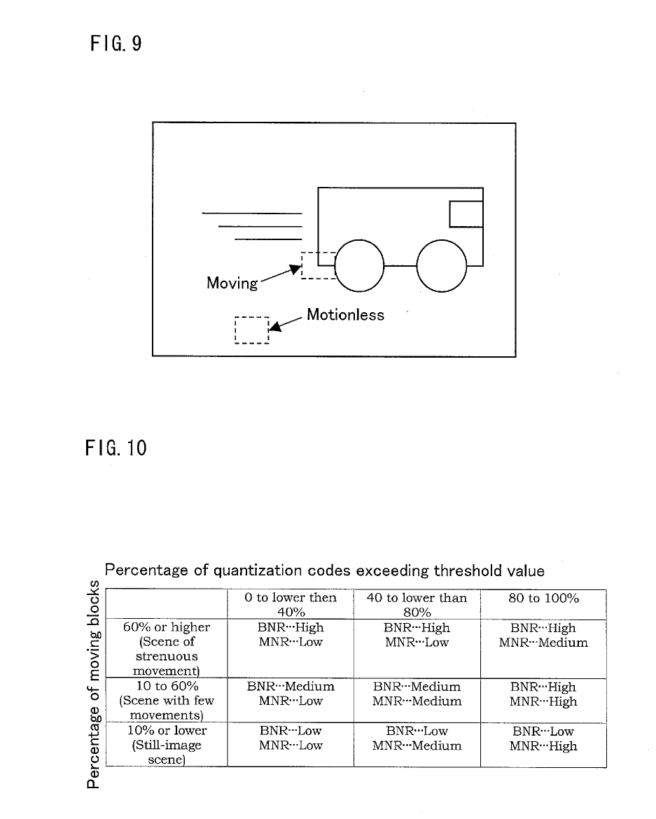

FIG. 9 shows an example of a “moving” block and an example of a “motionless” block as determined in this step. As shown in FIG. 9, a block including at least part of a moving object (vehicle) is determined as a “moving block” and a block not including a moving object is determined as a “motionless block”.

(Step S1003)

The process from steps S1001 to S1002 is performed on all of the blocks included in the target frame.

The motion determining section 1200 supplies a noise amount calculating section 1150 with a result of motion detection for each block as obtained through this process.

(Noise Reduction Process Section 1160)

A noise reduction process section 1160 applies any of the following noise reduction processes to the target frame in accordance with an instruction from the noise amount calculating section 1150 described below. Further, the noise reduction process section 1160 switches, in accordance with an instruction from the noise amount calculating section 1150, the intensity of the noise reduction process that is applied to the target frame.

3D block noise reduction process

2D block noise reduction process

3D mosquito noise reduction process

2D mosquito noise reduction process

It should be noted here that the 3D block noise reduction process and the 3D mosquito noise reduction process are each a process that is performed with reference to a target frame and one or more other frames. In the following, the 3D block noise reduction process and the 3D mosquito noise reduction process are sometimes called “3D noise reduction process” for descriptive purposes.

Specifically, the 3D noise reduction process is a process for generating an image after noise reduction by calculating, for each pixel, the average of a target region in a target frame containing noise and a target region(s) in one or more reference frames temporally positioned before or after the target frame as a starting point, as shown in (a) of FIG. 8.

For application of a more intense 3D noise reduction process, the number of reference frames is increased, and for application of a less intense 3D noise reduction process, the number of reference frames is reduced.

Increasing the number of frames that are referred to increases the effectiveness of noise reduction, but has an aspect of easily causing an afterimage in a scene of strenuous movement. Reducing the number of frames that are referred to hardly causes an afterimage even in a scene of strenuous movement, but has an aspect of decreasing the effectiveness of noise reduction.

It should be noted that the averaging procedure in the 3D noise reduction process may be one that is performed with a weighting coefficient set so that an image after noise reduction is of higher image quality.

Alternatively, the 3D noise reduction process may be a process for comparing a target region in a target frame with a target region(s) in one or more reference frames temporally positioned before or after the target frame as a starting point, determining an instantaneously changing portion as noise, and reducing the noise.

On the other hand, the 2D block noise reduction process and the 2D mosquito noise reduction process are each a process that is performed with reference to a target pixel in a target frame and reference pixels in the target frame which are included in a reference region surrounding the target pixel. In the following, the 2D block noise reduction process and the 2D mosquito noise reduction process are sometimes called “2D noise reduction process” for descriptive purposes.

Specifically, the 2D noise reduction process is a process for generating an image after noise reduction by calculating the average of a pixel value of a target pixel in a target frame and pixel values of reference pixels in the target frame which are included in a reference region surrounding the target pixel, as shown in (b) of FIG. 8.

For application of a more intense 2D noise reduction process, the size of the reference region is increased, and for application of a less intense 2D noise reduction process, the size of the reference region is reduced.

Increasing the size of the reference region increases the effectiveness of noise reduction, but has an aspect of easily causing a blur in a region other than the region in which the noise is occurring. Reducing the size of the reference region hardly causes such a blur, but has an aspect of decreasing the effectiveness of noise reduction.

It should be noted that the averaging procedure in the 2D noise reduction process may be one that is performed with a weighting coefficient set so that an image after noise reduction is of higher image quality.

Alternatively, the 2D noise reduction process may be a process for comparing a target pixel in a target frame and reference pixels in the target frame which are included in a reference region surrounding the target pixel, determining the occurrence of noise in the target pixel in a case where the target pixel is greatly different in color or luminance from the reference pixels, and reducing the noise.

(Noise Amount Calculating Section 1150)

Next, the noise amount calculating section 1150 according to the present embodiment is described. The noise amount calculating section 1150 according to the present embodiment serves both as a noise reduction process selecting unit and an intensity determining unit. The noise amount calculating section 1150 estimates the amount of noise in the picture using the quantization codes obtained by the quantization parameter obtaining section 130, the result of motion determination by the motion determining section 1200, and the threshold value stored in the storage section 140. Further, the noise amount calculating section 1150 changes, on the basis of the noise amount thus estimated, the type and intensity of a noise reduction process that is performed by the noise reduction process section 1160.

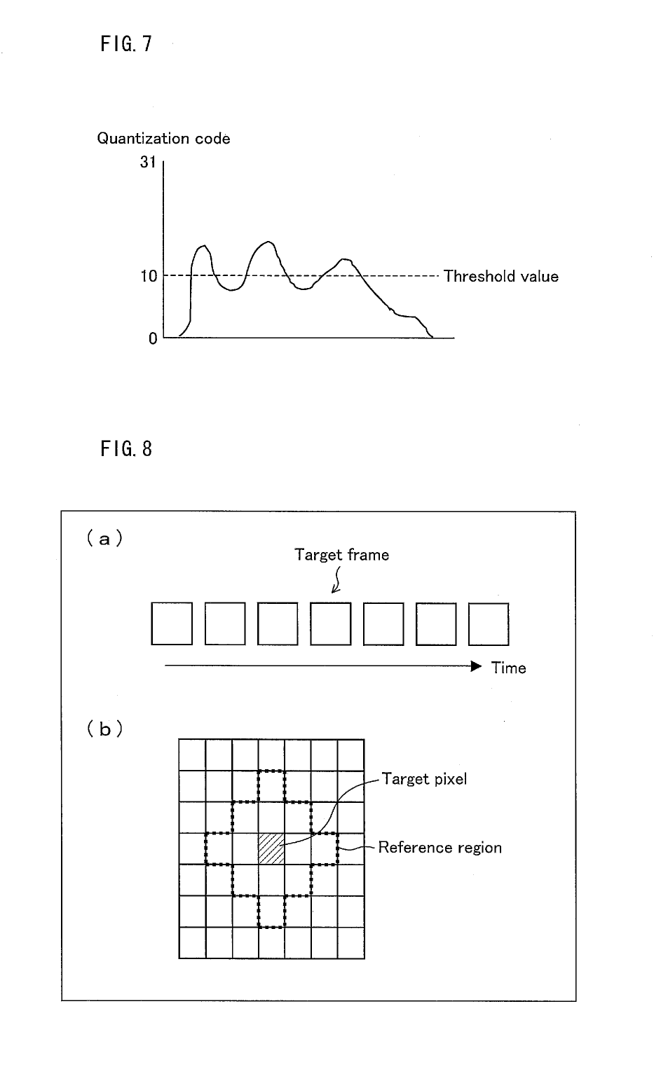

FIG. 7 is a diagram showing examples of quantization codes for each separate pixel. The horizontal axis represents each separate pixel (more specifically, pixel numbers assigned to each separate pixel) included in a target frame, and the vertical axis represents examples of the values of quantization codes for each separate pixel.

The noise amount calculating section 1150 calculates the percentage of the number of pixels in a target frame whose quantization codes exceed a predetermined threshold value (in the example shown in FIG. 7, threshold value=10) with respect to the total number of pixels in the target frame.

Further, the noise amount calculating section 1150 calculates the percentage of the number of blocks in a target frame which are determined as “moving” with respect to the total number of blocks in the target frame.

On the basis of these calculation results, the noise amount calculating section 1150 changes the type and intensity of a noise reduction process that the noise reduction process section 1160 applies to the target frame.

FIG. 10 is table showing an example of a relationship between the percentage of blocks determined as “moving”, the percentage of quantization codes exceeding the threshold value, and intensities of each, separate noise reduction process as set by the noise reduction process section 1150. In FIG. 10, the word “BNR” refers to a block noise reduction process, and the word “MNR” refers to a mosquito noise reduction process.

As shown in FIG. 10, the noise amount calculating section 1150 sets the intensity of a block noise reduction process higher when the number of blocks determined as “moving” is larger.

Further, as shown in FIG. 10, the noise amount calculating section 1150 sets the intensity of a mosquito noise reduction process higher when the number of blocks whose quantization codes exceed a predetermined threshold value is larger.

Further, the noise amount calculating section 1150 may instruct the noise reduction process section 1160 to omit a noise reduction process set to “LOW”.

Further, the noise amount calculating section 1150 can be configured to select a 2D noise reduction process in a case where the percentage of blocks determined as “moving” is smaller, and to select a 3D noise reduction process in a case where the percentage of blocks determined as “moving” is larger.

Further, the noise amount calculating section 1150 can be configured to reduce the number of reference frames in a case where the percentage of blocks determined as “moving” is larger, and to increase the number of reference frames in a case where the percentage of blocks determined as “moving” is smaller.

Further, the noise amount calculating section 1150 may be configured to identify a noise generation pattern in a target region set on a target frame, and to change, on the basis of a result of the identification, the type and intensity of a noise reduction process that is applied to the target region by the noise reduction process section 1160.

For example, the noise amount calculating section 1150 can be configured to detect an average color or luminance in each block, to estimate that there is block noise in the target frame when the color or luminance varies from block to block, and to increase the intensity of a block noise reduction process that is applied to a block boundary.

Further, the noise amount calculating section 1150 may be configured to determine, as mosquito noise, noise detected, if any, in the vicinity of a region (e.g. an edge of an image) where there is a great change in color or luminance, and to reduce the mosquito noise by calculating the average of pixel values in a region not including the edge.

Such a configuration makes it possible to perform a finer noise reduction process.

It should be noted that each of the threshold values mentioned above can be determined in advance so that a picture that the video processing device 1100 outputs is of higher image quality.

### Embodiment 10

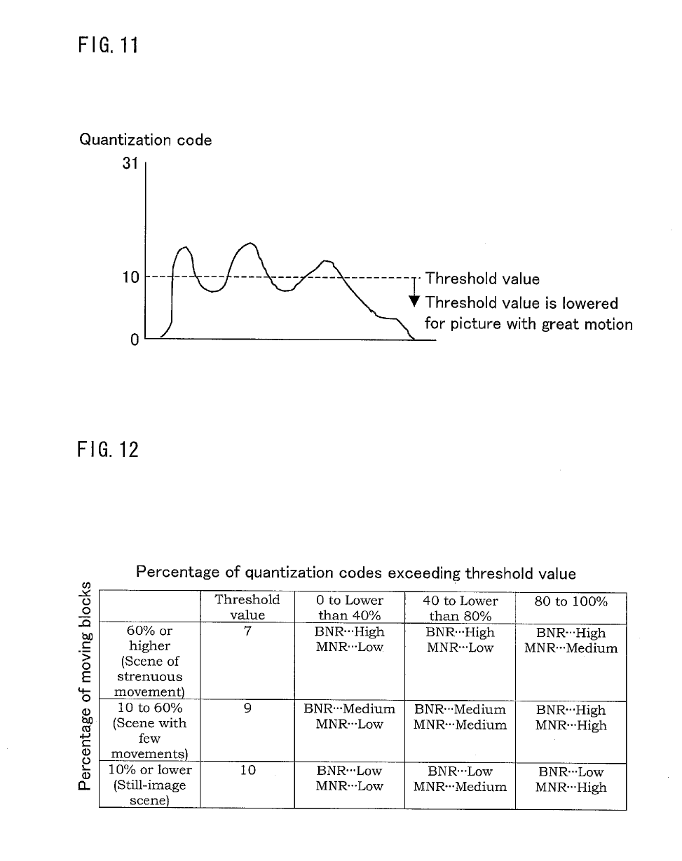

A modification of Embodiment 9 is described with reference to FIGS. 11 and 12.

In addition to the configurations described above, the noise amount calculating section 1150 according to the present modification is configured to set a threshold value for quantization codes smaller when the blocks determined as “moving” is larger.

FIG. 11 is a diagram showing examples of quantization codes for each separate pixel, together with a threshold value as set by the noise amount calculating section 1150 according to the present modification.

In FIG. 12, the noise amount calculating section 1150 sets a threshold value for quantization codes smaller when the number blocks determined as “moving” is larger.

In most systems of encoding, quantization codes are set at the encoding side in view of the required compression ratio and the like. For example, in a case where the original picture contains “glittering noise”, the resulting picture per se may contain much noise even if the compression ratio is set low, i.e. even if the quantization codes are set small.

Meanwhile, such a picture tends to be determined by motion determination as having many “moving” blocks.

The present modification sets a threshold value for quantization codes smaller when there are more “moving” blocks, thus making it possible to suitably reduce the aforementioned “glittering noise”.

### Embodiment 11

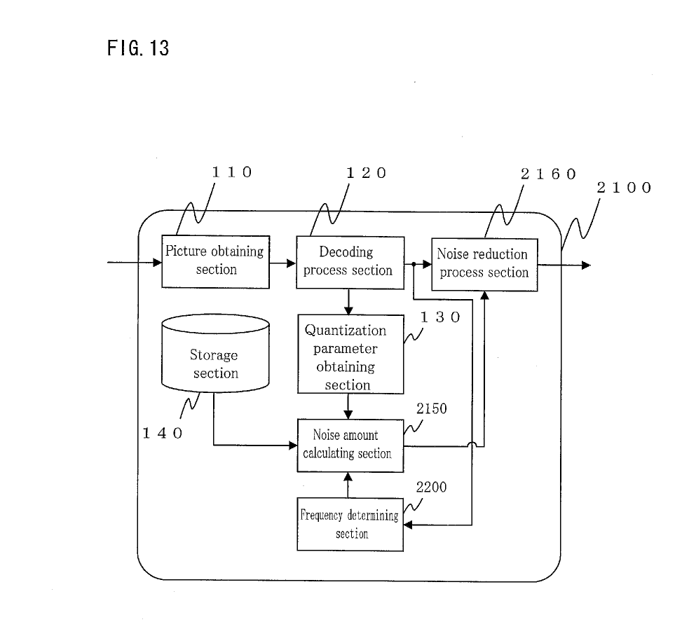

A video processing device 2100 is described with reference to FIGS. 13 through 16. The video processing device 2100 is configured to set a mosquito noise reduction parameter on the basis of quantization codes of each separate block constituting a target frame and the frequency characteristics of each separate block constituting the target frame or edge information of pixels and subject the target frame to a mosquito noise reduction process using the mosquito noise reduction parameter.

FIG. 13 is a block diagram showing a configuration of the video processing device 2100 according to the present embodiment. The video processing device 2100 shown in FIG. 13 differs from the video processing device shown in FIG. 1 in that the video processing device 2100 includes a frequency determining section 2200.

FIG. 14 is a set of schematic views for explaining mosquito noise, and FIG. 8 is a set of schematic views for explaining a 3D noise reduction process and a 2D noise reduction process in an aspect of a noise reduction process according to the present embodiment.

FIG. 7, which is a diagram for explaining the video processing device according to the present embodiment, is a diagram showing examples of quantization codes of blocks constituting a target block and an example of a threshold value.

(Frequency Determining Section 2200)

The frequency determining section 220, which serves as a frequency determining unit, calculates noise reduction parameters on the basis of frequency characteristics.

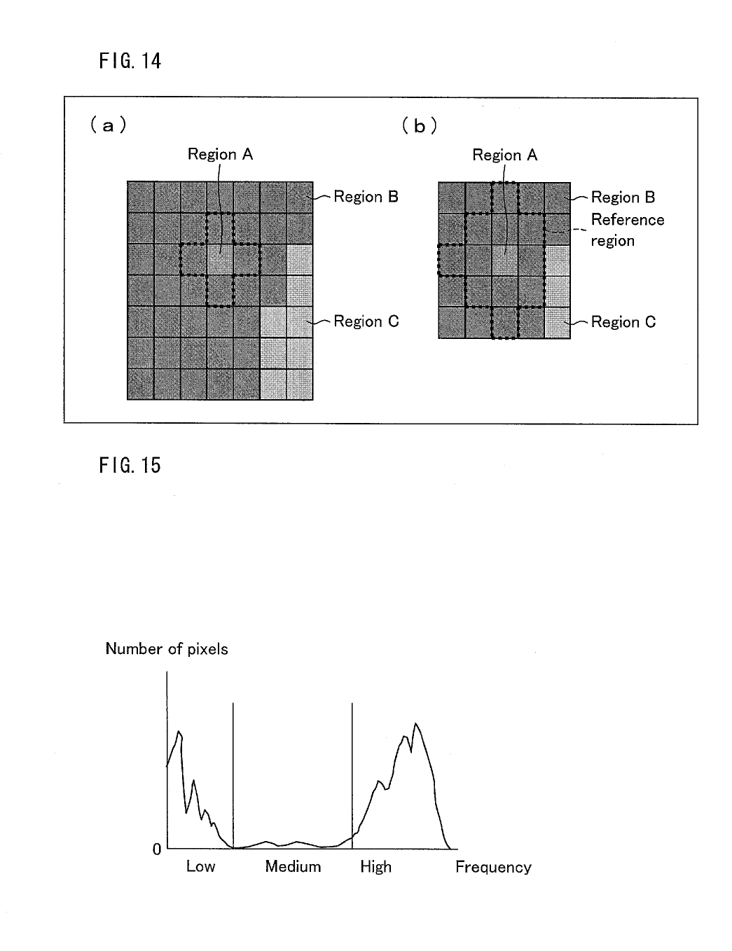

More specifically, the frequency determining section 2200 obtains, from the decoding process section 120, frequency components of each separate block constituting a target frame (see FIG. 13). Then, the frequency determining section 2200 derives a histogram of frequency components on the basis of the frequency components. A histogram of frequency components as shown in FIG. 15 is an example of a histogram of frequency components as derived by the frequency determining section 2200. This histogram of frequency components reflects the frequency characteristics of a target frame.

The frequency determining section 2200 supplies the histogram of frequency components thus derived to a noise amount calculating section 2150 serving as a setting unit.

(Edge Information Deriving Section)

It should be noted that instead of including the frequency determining section 2200, the video processing device 2100 may include an edge information deriving section serving an edge information deriving unit. The edge information deriving section performs an edge information extraction process on pixel values supplied to each separate pixel constituting the target frame and derives edge information in the target frame. The edge information deriving section supplies the edge information to a noise amount calculating section 2150.

As the edge information extraction process used here, a known method for edge information extraction can be applied. A specific example of an edge information extraction process is described below. The edge information deriving section calculates, as a luminance difference, the difference between the luminance of a pixel included in a target frame and the luminance of a pixel located next to the pixel. Similarly, the edge information deriving section calculates such luminance differences for all of the pixels constituting the target frame. Then, the edge information deriving section derives a distribution of the luminance differences as an edge histogram. The edge histogram is a form of edge information. That is, edge information that the edge information deriving section derives is not limited to an edge histogram.

Another example of an edge information extraction process is edge detection using a Sobel filter. By the edge information deriving section applying a Sobel filter to a target frame, edge components contained in the target frame is detected. The edge information deriving section may derive an edge histogram of the target frame on the basis of the edge components contained in the target frame.

(Noise Reduction Process Section 2160)

In accordance with an instruction from the noise amount calculating section 2150 described below, a noise reduction process section 2160 applies, to the target frame, any of the following noise reduction processes that includes at least a mosquito noise reduction process. Further, the noise reduction process section 2160 switches, in accordance with an instruction from the noise amount calculating section 2150, the intensity of the noise reduction process that is applied to the target frame.

3D mosquito noise reduction process

2D mosquito noise reduction process

3D block noise reduction process

2D block noise reduction process

(Mosquito Noise Reduction Process)

The noise reduction process section 2160 performs a mosquito noise reduction process as a type of color noise reduction process as mentioned above. Mosquito noise is schematically explained here with reference to (a) of FIG. 14. Mosquito noise has a tendency to occur in such an edge region in a target frame where there is a great change in color or luminance. In (a) of FIG. 14, the region B indicates a low-luminance region and the region C indicates a high-luminance region. Mosquito noise tends to occur near a boundary between the regions B and C where there is a great change in luminance. The region A indicates a region in which mosquito noise is occurring. The region A is supposed to be a low-luminance region like the region B, the occurrence of mosquito noise causes the region A to be higher in luminance than the region B and lower in luminance than the region C.

It should be noted that the aforementioned edge region can be rephrased as being formed by a block which, of blocks constituting a target frame, has a high-frequency component. Therefore, mosquito noise can also be said to tend to occur in a block having a high-frequency component and blocks therearound. As a result of this, when the percentage of blocks that have high-frequency components to block constituting a target frame is high, there is a high possibility that much mosquito noise is contained in the target frame. Further, when a picture represented by a target frame contains a large number of edge regions, there is a high possibility that mosquito noise is much mosquito noise is contained in the target frame.

Mosquito noise reduction processes are categorized into a 3D mosquito noise reduction process and a 2D mosquito noise reduction process as will be mentioned later.

(Block Noise Reduction Process)

Block noise is, in general, rectangular noise that occurs when a picture is encoded at a high compression ratio. Block noise is called as such because the size of the noise is the same as the size of a block in encoding. Block noise reduction processes are categorized into a 3D block noise reduction process and a 2D block noise reduction process as will be mentioned later.

(3D Noise Reduction Process)

It should be noted here that the 3D block noise reduction process and the 3D mosquito noise reduction process are each a process that is performed with reference to a target frame and one or more other frames. In the following, the 3D block noise reduction process and the 3D mosquito noise reduction process are sometimes called “3D noise reduction process” for descriptive purposes.

Specifically, the 3D noise reduction process is a process for generating an image after noise reduction by calculating, for each pixel, the average of a target region in a target frame containing noise and a target region(s) in one or more reference frames temporally positioned before or after the target frame as a starting point, as shown in (a) of FIG. 8.

For application of a more intense 3D noise reduction process, the number of reference frames is increased, and for application of a less intense 3D noise reduction process, the number of reference frames is reduced.

Increasing the number of frames that are referred to increases the effectiveness of noise reduction, but has an aspect of easily causing an afterimage in a scene of strenuous movement. Reducing the number of frames that are referred to hardly causes an afterimage even in a scene of strenuous movement, but has an aspect of decreasing the effectiveness of noise reduction.

It should be noted that the averaging procedure in the 3D noise reduction process may be one that is performed with a weighting coefficient set so that an image after noise reduction is of higher image quality.

Alternatively, the 3D noise reduction process may be a process for comparing a target region in a target frame with a target region(s) in one or more reference frames temporally positioned before or after the target frame as a starting point, determining an instantaneously changing portion as noise, and reducing the noise.

(2D Noise Reduction Process)

On the other hand, the 2D block noise reduction process and the 2D mosquito noise reduction process are each a process that is performed with reference to a target pixel in a target frame and reference pixels in the target frame which are included in a reference region surrounding the target pixel. In the following, the 2D block noise reduction process and the 2D mosquito noise reduction process are sometimes called “2D noise reduction process” for descriptive purposes.

Specifically, the 2D noise reduction process is a process for generating an image after noise reduction by calculating the average of a pixel value of a target pixel in a target frame and pixel values of reference pixels in the target frame which are included in a reference region surrounding the target pixel, as shown in (b) of FIG. 8.

For application of a more intense 2D noise reduction process, the size of the reference region is increased, and for application of a less intense 2D noise reduction process, the size of the reference region is reduced.

Increasing the size of the reference region increases the effectiveness of noise reduction, but has an aspect of easily causing a blur in a region other than the region in which the noise is occurring. Reducing the size of the reference region hardly causes such a blur, but has an aspect of decreasing the effectiveness of noise reduction. Further, the 2D mosquito noise reduction process may be applied in a case where a region A in which mosquito noise is occurring and the high-luminance regions C are close to each other as shown in (b) of FIG. 14. In such a case, setting a reference region as shown in (b) of FIG. 14 makes it possible to prevent the high-luminance regions C from being included in the reference region. By thus setting the reference region, the mosquito noise reduction process can be more effectively executed.

It should be noted that the averaging procedure in the 2D noise reduction process may be one that is performed with a weighting coefficient set so that an image after noise reduction is of higher image quality.

Alternatively, the 2D noise reduction process may be a process for comparing a target pixel in a target frame and reference pixels in the target frame which are included in a reference region surrounding the target pixel, determining the occurrence of noise in the target pixel in a case where the target pixel is greatly different in color or luminance from the reference pixels, and reducing the noise.

(Noise Amount Calculating Section 2150)

The noise amount calculating section 2150, which is a setting unit, derives the mosquito noise reduction parameter on the basis of a histogram of frequency components as derived by the frequency determining section 2200 and the quantization codes of blocks constituting a target frame.

The derivation of mosquito noise parameters by the noise calculating section 2150 is described below with reference to FIGS. 7, 15, and 16.

FIG. 7 is a diagram showing examples of quantization codes for each separate pixel. The horizontal axis represents each separate pixel (more specifically, pixel numbers assigned to each separate pixel) included in a target frame, and the vertical axis represents examples of the values of quantization codes for each separate pixel.

The noise amount calculating section 2150 calculates the percentage of the number of pixels in a target frame whose quantization codes exceed a predetermined threshold value (in the example shown in FIG. 7, threshold value=10) with respect to the total number of pixels in the target frame.

FIG. 15 is a diagram showing an example of a histogram of frequency components as derived by the frequency determining section 2200. The two solid lines shown in FIG. 15 indicate a first frequency and a second frequency, respectively. The first frequency and the second frequency are both frequencies set in advance by the manufacturer. The first frequency and the second frequency may be stored in the storage section 140 at the stage of manufacturing of the video processing device 2100. According to the foregoing configuration, the noise amount calculating section 2150 obtains the first frequency and the second frequency with reference to the storage section 140. It should be noted that in the present embodiment, the first frequency is lower than the second frequency.

The noise amount calculating section 2150 divides the histogram of frequency components into three frequency components with the first and second frequencies as boundary values (see FIG. 15). The noise amount calculating section 2150 treats, as a first frequency component, a frequency domain whose frequencies are not higher than the first frequency. The first frequency component corresponds to a “low” frequency domain shown in FIG. 15. The noise amount calculating section 2150 treats, as a second frequency component, a frequency domain whose frequencies are higher than the first frequency and not higher than the second frequency. The second frequency component corresponds to a “medium” frequency domain shown in FIG. 15. The noise amount calculating section 2150 treats, as a third frequency component, a frequency domain whose frequencies are higher than the second frequency. The third frequency component corresponds to a “high” frequency domain shown in FIG. 15. As can be seen, the third frequency component of the frequency characteristics of blocks constituting a target frame can be rephrased as a high-frequency component, and the first frequency component thereof can be rephrased as a low-frequency component. Further, in the present embodiment, the second frequency component is expressed as a medium-frequency component.

On that basis, the noise amount calculating section 2150 calculates the percentage of the first frequency component to all of the frequency components and, similarly, calculates the percentage of the second frequency component to all of the frequency components and the percentage of the third frequency component to all of the frequency components.

It should be noted that the first frequency and the second frequency are values that can be arbitrarily set by the manufacturer. The manufacturer needs only adjust the values of the first and second frequencies as appropriate so that a picture after noise reduction process that is outputted by the noise reduction process section 2160 has desired image quality.

(Derivation of the Mosquito Noise Reduction Parameter)

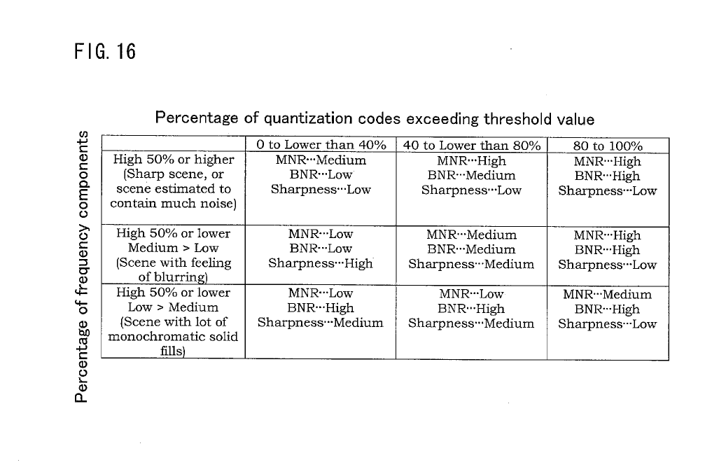

Then, the noise amount calculating section 2150 sets the mosquito noise reduction parameter on the basis of the first frequency component, the second frequency component, and the third frequency component, as well as the percentage of the number of pixels in a target frame whose quantization codes exceed a predetermined threshold value with respect to the total number of pixels in the target frame. A process by which the noise amount calculating section 2150 sets the mosquito noise reduction parameter is described below with reference to FIG. 16. In the following, the “percentage of the number of pixels in a target frame whose quantization codes exceed a predetermined threshold value with respect to the total number of pixels in the target frame” is simply expressed as “percentage of quantization codes exceeding the threshold value”.

FIG. 16 is a diagram showing intensities of each separate noise reduction process that are designated by the percentage of blocks in a target frame whose quantization codes exceed a threshold value with respect to all of the blocks constituting the target frame and the percentage of frequency components constituting the target frame. In FIG. 16, the words “MNR”, “BNR”, and “SHARPNESS” represent the mosquito noise reduction parameter, the block noise reduction parameter, and the sharpness process parameter, respectively.

When the noise amount calculating section 2150 sets a higher mosquito noise reduction parameter, the noise reduction process section 2160 performs a high-intensity noise reduction process on the target frame. That is, in a case where the noise reduction process section 2160 obtains a “high” mosquito noise reduction parameter, the noise reduction process section 2160 performs a “high-intensity” noise reduction process on the target frame. In a case where the noise reduction process section 2160 obtains a “medium-intensity” mosquito noise reduction parameter, the noise reduction process section 2160 performs a “medium-intensity” noise reduction process on the target frame. In a case where the noise reduction process section 2160 obtains a “low” mosquito noise reduction parameter, the noise reduction process section 2160 performs a “low-intensity” noise reduction process on the target frame.

(Case where the Proportion of High-Frequency Components is High)

The following describes the magnitude of a mosquito noise reduction parameter that the noise amount calculating section 2150 sets in a case where blocks constituting a target frame have many frequency components. In the present embodiment, the case where the percentage of high-frequency components is high is defined as a case where the percentage of high-frequency components is 50% or higher. The percentage at which the percentage of high-frequency components is determined to be high or not is not limited to 50%, but may be adjusted as appropriate by the manufacturer at any percentage so that a picture after noise reduction process has desired image quality.

In a case where blocks constituting a target frame have many frequency components, there is a high possibility (i) that an object contained in a picture represented by the target frame has a sharp contour or (ii) that the picture represented by the target frame contains much noise. In the case where the object has a sharp contour, mosquito noise is easily generated near a region forming the contour of the object. Therefore, there is a high possibility, whether (i) or (ii), that the target frame contains much mosquito noise.

Therefore, even in a case where the percentage of quantization codes exceeding the threshold value is as low as 0 to lower than 40%, the noise amount calculating section 2150 sets the mosquito noise reduction parameter to “MEDIUM” (see the first row of FIG. 16). Further, since the picture is encoded and decoded at a higher compression ratio when the percentage of quantization codes exceeding the threshold value is higher, there is a high possibility that there is an increase in the incidence of mosquito noise. Therefore, as shown in FIG. 16, the noise amount calculating section 2150 sets a higher mosquito noise reduction parameter when the percentage of quantization codes exceeding the threshold value is higher.

(Case where the Proportion of High-Frequency Components is not High)

In the present embodiment, a case where the percentage of high-frequency components is lower than 50% is also expressed as a case where the percentage of high-frequency components is not high. As shown in FIG. 16, there are two cases where the percentage of high-frequency components is not high. One of the cases is a case where, as shown in the second row of FIG. 16, the percentage of medium-frequency components is higher than the percentage of low-frequency components. The picture represented by the target frame in this case can be expressed as a scene with a feeling of blurring. Since the picture does not contain many edge regions, the amount of mosquito noise that is contained in the picture is small, provided the percentage of quantization codes exceeding the threshold value is low. Therefore, the noise amount calculating section 2150 sets the mosquito noise reduction parameter to “LOW”. It should be noted that the noise amount calculating section 2150 sets a higher mosquito noise reduction parameter when the percentage of quantization codes exceeding the threshold value is higher.

The other case is a case where, as shown in the third row of FIG. 16, the percentage of low-frequency components is higher than the percentage of medium-frequency components. The picture represented by the target frame in this case can be expressed as a scene with a lot of monochromatic solid fills. That is, the picture contains much fewer edge regions than does a scene with a feeling of blurring. Since there is a low possibility that mosquito noise is generated in such a picture, the noise amount calculating section 2150 sets the mosquito noise reduction parameter to “LOW”, provided that the percentage of quantization codes exceeding the threshold value is low. Further, the noise amount calculating section 2150 sets a higher mosquito noise reduction parameter when the percentage of quantization codes exceeding the threshold value is higher. However, the degree to which the noise amount calculating section 2150 sets a higher mosquito noise reduction parameter is smaller than in the case of a scene with a feeling of blurring. Therefore, even in a case where the percentage of quantization codes exceeding the threshold value is 80 to 100%, the noise amount calculating section 2150 sets the mosquito noise reduction parameter to “MEDIUM”.

By the noise amount calculating section 2150 thus setting the mosquito noise reduction parameter as appropriate and the noise reduction process section 2160 thus performing a mosquito noise reduction process on the basis of the mosquito noise reduction parameter, the image quality of the picture represented by the target frame can be effectively improved.

In the present embodiment, as shown in FIG. 16, the noise reduction parameter that the noise amount calculating section 2150 sets is not limited to the mosquito noise reduction parameter. The noise amount calculating section 2150 may be configured to set the block noise reduction parameter and the sharpness process parameter as shown in FIG. 16 on the basis of the percentage of quantization codes exceeding a threshold value and the percentage of high-frequency components. By the noise amount calculating section 2150 setting the block noise reduction parameter and the sharpness process parameter as appropriate in addition to the mosquito noise reduction parameter and the noise reduction process section 2160 performing noise reduction processes on the basis of the parameters respectively, the image quality of the picture represented by the target frame can be further improved.

It should be noted that the noise amount calculating section 2150 may instruct the noise reduction process section 2160 to omit a noise reduction process set to “LOW”.

Further, when the noise reduction process section 2160 performs a mosquito noise reduction process and a block noise reduction process, the noise reduction processes may each be a 2D noise reduction process or a 3D noise reduction process.

Further, the noise amount calculating section 2150 may be configured to identify a noise generation pattern in a target region set on a target frame, and to change, on the basis of a result of the identification, the type and intensity of a noise reduction process that is applied to the target region by the noise reduction process section 2160.

For example, the noise amount calculating section 2150 can be configured to detect an average color or luminance in each block, to estimate that there is block noise in the target frame when the color or luminance varies from block to block, and to increase the intensity of a block noise reduction process that is applied to a block boundary.

Further, the noise amount calculating section 2150 may be configured to determine, as mosquito noise, noise detected, if any, in the vicinity of a region (e.g. an edge of an image) where there is a great change in color or luminance, and to reduce the mosquito noise by calculating the average of pixel values in a region not including the edge.

Such a configuration makes it possible to perform a finer noise reduction process.

It should be noted that each of the threshold values mentioned above can be determined in advance so that a picture that the video processing device 2100 outputs is of higher image quality.

(Setting of the Mosquito Noise Reduction Parameter on the Basis of Edge Information)

In a case where the video processing device 2100 includes an edge information deriving section instead of the frequency determining section 2200, the noise amount calculating section 2150 obtains an edge histogram that is a form of edge information. As mentioned above, the edge histogram represents, according to luminance differences among pixels constituting a target frame, a distribution of the luminance differences. The frequency components of the blocks constituting the target frame and the luminance differences among the pixels constituting the target frame both reflect the amount of an edge region that is included in a predetermined region. That is, a region in the histogram where there is a large luminance difference corresponds to a region of high-frequency components in the histogram of frequency components. Moreover, a region in the histogram where there is a small luminance difference corresponds to a region of low-frequency components in the histogram of frequency components. Furthermore, a region in the histogram where there is a medium luminance difference corresponds to a region of medium-frequency components in the histogram of frequency components.

Therefore, the noise amount calculating section 2150 can set the mosquito parameter noise as appropriate by using an edge histogram instead of a histogram of frequency components and by using two predetermined luminance differences for dividing luminance differences into three domains.

Further, the noise amount calculating section 2150 may be configured to use one predetermined luminance difference to determine a region in the histogram where there is a large luminance difference. That is, the noise amount calculating section 2150 may be configured to calculate, with respect to all of the pixels constituting a target frame, the percentage of pixels constituting a region where there is a large luminance difference as determined by the predetermined luminance difference. In this case, the noise amount calculating section 2150 can set the mosquito noise reduction parameter on the basis of the percentage. The noise amount calculating section 2150 sets a higher mosquito noise reduction parameter when the percentage of pixels constituting the region where there is a large luminance difference is higher.

### Embodiment 12

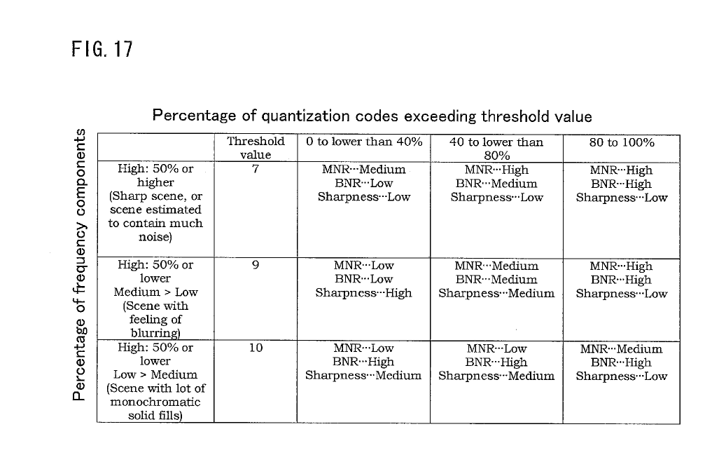

A modification of Embodiment 11 is described with reference to FIGS. 11 and 17.

In addition to the configurations described above, the noise amount calculating section 2150 according to the present modification is configured to set a threshold value for quantization codes smaller when the percentage of high-frequency components is higher, and to set the threshold value for quantization codes larger when the percentage of low-frequency components is higher.

FIG. 11 is a diagram showing examples of quantization codes for each separate pixel, together with a threshold value as set by the noise amount calculating section 2150 according to the present modification.

As shown in FIG. 17, the noise amount calculating section 2150 sets a threshold value for quantization codes smaller when the percentage of high-frequency components is higher, and sets the threshold value for quantization codes larger when the percentage of low-frequency components is higher.

In most systems of encoding, quantization codes are set at the encoding side in view of the required compression ratio and the like. For example, in a case where the original picture contains “glittering noise”, the resulting picture per se may contain much noise even if the compression ratio is set low, i.e. even if the quantization codes are set small.

Meanwhile, in a case where much noise is contained in such a picture per se, the noise amount calculating section 2150 determines that the percentage of high-frequency components in the target frame representing the picture is high. Therefore, the noise amount calculating section 2150 can suitably reduce the aforementioned “glittering noise”.

### Embodiment 13

The following describes, with reference to FIGS. 7, 8, 14, 18, and 19, a configuration in which noise reduction parameters for a noise reduction process are changed on the basis of (i) quantization codes constituting a target frame, (ii) the number of pixels which, of pixels constituting the target frame, display a color containing a primary color component in a rate higher than a predetermined percentage, and (iii) the number of pixels included in a region formed by a series of pixels displaying an identical color containing the primary color component.

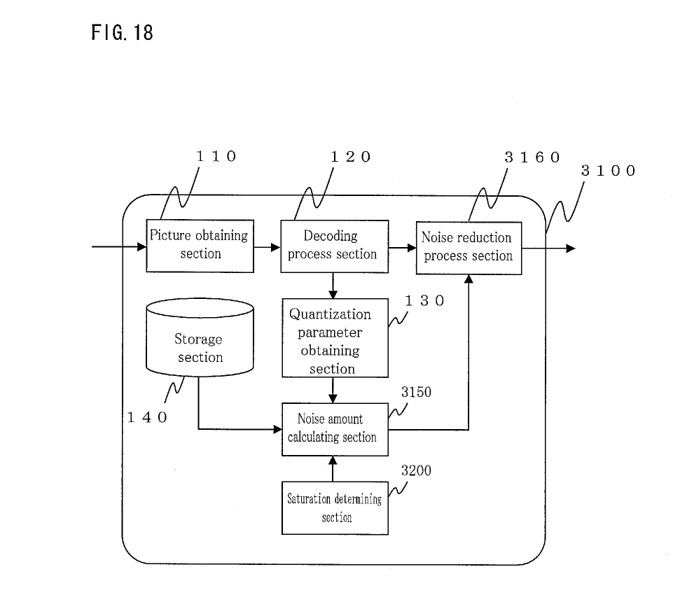

FIG. 18 is a block diagram showing a configuration of a video processing device 3100 according to the present embodiment. As shown in FIG. 18, the video processing device 3100 according to the present embodiment includes a saturation determining section 3200 in addition to the components shown in FIG. 1.

It should be noted that the configuration of the video processing device 3100 according to the present embodiment is not limited to that shown in FIG. 18, but may be a configuration in which the saturation determining section 3200 is incorporated into the configuration shown in FIG. 3 or 4. Further, the present embodiment can be used in combination with any of the embodiments described above.

(Saturation Determining Section 3200)

The saturation determining section 3200 according to the present embodiment determines whether or not pixels (hereinafter referred to also as “target pixels”) included in a decoded target frame which, of the frames constituting a picture supplied from the decoding process section 120, serves as a target of saturation determination are primary color pixels. There is no limit on how to determine whether or not the pixels included in the target frame are primary color pixels, and it is possible to use any well-known method for determining primary color pixels.

For example, a pixel that is supplied with an RGB signal containing R, G, and B signals any one of which has a finite tone and the other two of which have a tone of 0 may be determined as a primary color pixel.

Further, another example of how to determine a primary color pixel may be achieved by calculating the percentage of each of R, G, and B signals contained in an RGB signal that is supplied to a pixel with respect to the whole RGB signal. This percentage is expressed as the “rate of a primary color component”. Then, in a case where the rate of a primary color component in any one of the colors of the RGB signal that is supplied to the pixel is high, the pixel may be determined as a primary color pixel. The following describes a method for determining a primary color pixel using the rate of a primary color component.

(Step S1001)

When a signal corresponding to a target pixel that is supplied from the decoding process section 120 is an RGB signal, the saturation determining section 3200 detects signal intensities r, g, and b as primary color components. The signal intensities r, g, and b are the signal intensities of colors of the RGB signal, respectively.

(Step S1002)

On the basis of r, g, and b thus detected, the saturation determining section 3200 calculates the rate of each of the primary color components in the target pixel. The rate of a red component rrate, the rate of a green component grate, and the rate of a blue component brate are for example defined by Eq. (1) to Eq. (3), respectively, as follows:

rrate=r/(r+g+b) (1),

grate=g/(r+g+b) (2), and

brate=b/(r+g+b) (3).

(Step S1003)

The saturation determining section 3200 makes a comparison of magnitude relationship between each of the rates rrate, grate, and brate and a predetermined threshold value Cth for determination of a primary color pixel. In a case where the rate of any one of the color components is higher than the predetermined threshold value Cth, the saturation determination section 3200 determines that the pixel is a primary color pixel, and integrates the pixel as a primary color pixel. On the other hand, in a case where the rates of all of the color components are not higher than the predetermined threshold value Cth, the saturation determination section 3200 determines that the pixel is not a primary color pixel.

(Step S1004)

After having determined for all of the pixels included in the target frame whether or not they are primary color pixels, the saturation determining section 3200 supplies the after-mentioned noise amount calculating section 3150 with the number of primary color pixels included in the target frame and the RGB signals that are supplied to the respective primary color pixels.

Signals corresponding to each separate pixel that are supplied from the decoding process section 120 are not limited to RGB signals. In a case where a signal supplied from the decoding process section 120 is for example a YPbPr signal, the saturation determining section 3200 may convert the YPbPr signal into an RGB signal and detect r, g, and b in the resulting RGB signal as primary color components. Further, Cth may be set at any value by the manufacturer. By the manufacturer setting Cth high, the discriminant criterion for the noise amount calculating section 3150 to determine primary color pixels is raised.

(Noise Reduction Process Section 3160)

A noise reduction process section 3160 according to Embodiment 13 applies any of the following noise reduction processes to the target frame in accordance with an instruction from the noise amount calculating section 3150 described below. Further, the noise reduction process section 3160 switches, in accordance with an instruction from the noise amount calculating section 3150, the intensity of the noise reduction process that is applied to the target frame.

Color noise reduction process

3D block noise reduction process

2D block noise reduction process

3D mosquito noise reduction process

2D mosquito noise reduction process

Sharpness process

It should be noted as mentioned above, the noise reduction processes in the present embodiment may include the sharpness process.

(Color Noise Reduction Process)

Color noise is noise that is generated, for example, by a dark current in an imaging element that takes a picture. Color noise has the following features:
It has a primary color or a color close to a primary color.
Monochromatic color noise is confined to a very narrow region.

As such, color noise is easily recognized by a user, as it has a primary color or a color close to a primary color. A color noise reduction process can be executed by converting an RGB signal representing a primary color or a color close to a primary color that is supplied to a pixel forming color noise into an RGB signal representing a color close to an achromatic color.

For example, let it be assumed that an RGB signal represented a color close to red, which is one of the primary colors, is supplied to a pixel forming color noise. In the RGB signal, only rrate is high and grate and brate are low. Accordingly, the noise reduction process section 3160 lowers only the color gain of red with respect to the RGB signal. This causes the color represented by the RGB signal that is supplied to the pixel forming the color noise to be converted from red to an achromatic color to become hardly recognizable by the user. This color noise reduction process is not limited to a case where the color of color noise is red or a color close to red, but is also effective in a case where the color of color noise is green or a color close to green and in a case where the color of color noise is blue or a color close to blue.

The noise reduction process section 3160 performs a color gain reduction process as a type of color noise reduction process.

In a case where the after-mentioned noise amount calculating section 3150 serving as an intensity determining unit applies a color noise reduction process of a high intensity, the noise reduction process section 3160 needs only be controlled to greatly lower the aforementioned color gain. On the other hand, in a case where the after-mentioned noise amount calculating section 3150 serving as an intensity determining unit applies a color noise reduction process of a low intensity, the noise reduction process section 3160 needs only be controlled to slightly lower the aforementioned color gain.

(Mosquito Noise Reduction Process)

The noise reduction process section 3160 performs a mosquito noise reduction process as a type of color noise reduction process. Mosquito noise has a tendency to occur in such an edge region in a target frame where there is a great change in color or luminance. Mosquito noise is schematically explained here with reference to (a) of FIG. 14. In (a) of FIG. 14, the region B indicates a low-luminance region and the region C indicates a high-luminance region. Mosquito noise tends to occur near a boundary between the regions B and C where there is a great change in luminance. The region A indicates a region in which mosquito noise is occurring. The region A is supposed to be a low-luminance region like the region B, the occurrence of mosquito noise causes the region A to be higher in luminance than the region B and lower in luminance than the region C.

Mosquito noise reduction processes are categorized into a 3D mosquito noise reduction process and a 2D mosquito noise reduction process as will be mentioned later.

(Block Noise Reduction Process)

Block noise is, in general, rectangular noise that occurs when a picture is encoded at a high compression ratio. Block noise is called as such because the size of the noise is the same as the size of a block in encoding. Block noise reduction processes are categorized into a 3D block noise reduction process and a 2D block noise reduction process as will be mentioned later.

(3D Noise Reduction Process)

It should be noted here that the 3D block noise reduction process and the 3D mosquito noise reduction process are each a process that is performed with reference to a target frame and one or more other frames. In the following, the 3D block noise reduction process and the 3D mosquito noise reduction process are sometimes called “3D noise reduction process” for descriptive purposes.

Specifically, the 3D noise reduction process is a process for generating an image after noise reduction by calculating, for each pixel, the average of a target region in a target frame containing noise and a target region(s) in one or more reference frames temporally positioned before or after the target frame as a starting point, as shown in (a) of FIG. 8.

For application of a more intense 3D noise reduction process, the number of reference frames is increased, and for application of a less intense 3D noise reduction process, the number of reference frames is reduced.

Increasing the number of frames that are referred to increases the effectiveness of noise reduction, but has an aspect of easily causing an afterimage in a scene of strenuous movement. Reducing the number of frames that are referred to hardly causes an afterimage even in a scene of strenuous movement, but has an aspect of decreasing the effectiveness of noise reduction.

It should be noted that the averaging procedure in the 3D noise reduction process may be one that is performed with a weighting coefficient set so that an image after noise reduction is of higher image quality.

Alternatively, the 3D noise reduction process may be a process for comparing a target region in a target frame with a target region(s) in one or more reference frames temporally positioned before or after the target frame as a starting point, determining an instantaneously changing portion as noise, and reducing the noise.

(2D Noise Reduction Process)

On the other hand, the 2D block noise reduction process and the 2D mosquito noise reduction process are each a process that is performed with reference to a target pixel in a target frame and reference pixels in the target frame which are included in a reference region surrounding the target pixel. In the following, the 2D block noise reduction process and the 2D mosquito noise reduction process are sometimes called “2D noise reduction process” for descriptive purposes.

Specifically, the 2D noise reduction process is a process for generating an image after noise reduction by calculating the average of a pixel value of a target pixel in a target frame and pixel values of reference pixels in the target frame which are included in a reference region surrounding the target pixel, as shown in (b) of FIG. 8.

For application of a more intense 2D noise reduction process, the size of the reference region is increased, and for application of a less intense 2D noise reduction process, the size of the reference region is reduced.

Increasing the size of the reference region increases the effectiveness of noise reduction, but has an aspect of easily causing a blur in a region other than the region in which the noise is occurring. Reducing the size of the reference region hardly causes such a blur, but has an aspect of decreasing the effectiveness of noise reduction. Further, the 2D mosquito noise reduction process may be applied in a case where a region A in which mosquito noise is occurring and the high-luminance regions C are close to each other as shown in (b) of FIG. 14. In such a case, setting a reference region as shown in (b) of FIG. 14 makes it possible to prevent the high-luminance regions C from being included in the reference region. By thus setting the reference region, the mosquito noise reduction process can be more effectively executed.

It should be noted that the averaging procedure in the 2D noise reduction process may be one that is performed with a weighting coefficient set so that an image after noise reduction is of higher image quality.

Alternatively, the 2D noise reduction process may be a process for comparing a target pixel in a target frame and reference pixels in the target frame which are included in a reference region surrounding the target pixel, determining the occurrence of noise in the target pixel in a case where the target pixel is greatly different in color or luminance from the reference pixels, and reducing the noise.

(Noise Amount Calculating Section 3150)

The following describes the noise amount calculating section 3150, which serves both as a noise reduction process selecting unit and an intensity determining unit. The noise amount calculating section 3150 according to the present embodiment estimates the type and amount of noise in the picture using the quantization codes obtained by the quantization parameter obtaining section 130, the information concerning primary color pixels as determined by the saturation determining section 3200, and a plurality of threshold values stored in the storage section 140. In estimating the type and amount of noise in the picture, the noise amount calculating section 3150 uses, in addition to a threshold value Qth for determining quantization codes, a threshold value Nth for determining the number of primary color pixels included in a target frame and a threshold value Dth for determining the number of primary color pixels included in an area formed by the primary color pixels.

Further, the noise amount calculating section 3150 changes, on the basis of the type and amount of noise thus estimated, the type and intensity of a noise reduction process that is performed by the noise reduction process section 3160.

(Determination of Color Noise)

A process for specifying color noise as executed by the noise amount calculating section 3150 is described below.

The noise amount calculating section 3150 determines whether or not the size of an area formed by pixels of each of the primary colors is larger or smaller than the predetermined threshold value Dth. In a case where the size of a region formed by a series of primary color pixels is larger, this region is highly likely to be a pattern such as a telop or a computer graphic (CG) artificially embedded in the picture. Therefore, the noise amount calculating section 3150 determines that a large-sized region of the region formed by a series of primary color pixels is not color noise. On the other hand, in a case where the size of a region formed by a series of primary color pixels is smaller, this region is highly likely to be color noise, not a pattern artificially embedded in the picture. Accordingly, the noise amount calculating section 3150 determines that a small-sized region of the region formed by a series of primary color pixels is color noise.

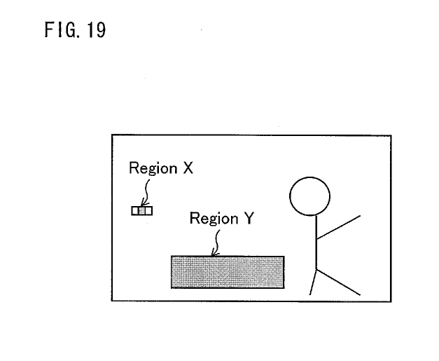

Specifically, the noise amount calculating section 3150 specifies an area formed by primary color pixels adjacent to each other, and derives the number Num of primary color pixels included in the area. The number Num can also be considered as a parameter representing the area formed by primary color pixels adjacent to each other. On that basis, the noise amount calculating section 3150 compares Num with Dth. In a case where Num>Dth, the noise amount calculating section 3150 determines that the area formed by primary color pixel is large. In a case where Num≦Dth, the noise amount calculating section 3150 determines that the area formed by primary color pixel is small. It should be noted that the predetermined threshold value Dth is not limited, but may be set at any value by the manufacturer. For example, Dth may be equal to 4. Regions X and Y shown in FIG. 19 indicate areas formed by primary color pixels. If Num=4 in the region X, for example, the noise amount calculating section 3150 determines that the region X is color noise. Meanwhile, if Num=200 in the region Y, for example, the noise amount calculating section 3150 determines that the region Y is not color noise.

It should be noted that the example shown here is one where the number of primary color pixels included in an area formed by primary color pixels is used to determine whether the area is large or small. However, the noise amount calculating section 3150 may be configured to, by making a comparison with a predetermined threshold value for determining an area, determine whether an area formed by primary color pixels is large or small. Further, the method for deriving an area is not limited, but may be a conventionally-known method.

Further, the noise amount calculating section 3150 derives, on the basis of information supplied from the saturation determining section 3200, the number Nf of primary color pixels included in a target frame. The noise amount calculating section 3150 compares Nf with the predetermined threshold value Nth. In a case where Nf>Nth, the noise amount calculating section 3150 determines that the number of primary color pixels included in the target frame is large. In a case where Nf≦Nth, the noise amount calculating section 3150 determines that the number of primary color pixels included in the target frame is small. It should be noted that the predetermined threshold value Nth is not limited, but may be set at any value by the manufacturer.

The following describes an example of a process that the noise amount calculating section 3150 executes.

(Step S1101)

The noise amount calculating section 3150 determines whether or not a pixel most adjacent to a primary color is a primary color pixel.

(Step S1102)

In a case where the most adjacent pixel is a primary color pixel, the noise amount calculating section 3150 determines whether or not a pixel further adjacent to the most adjacent pixel is a primary color pixel. By thus sequentially determining, for each pixel adjacent to a primary color pixel, whether or not the pixel is a primary color pixel, the noise amount calculating section 3150 specifies an area formed by the primary color pixels.

(Step S1103)

On that basis, the noise amount calculating section 3150 derives the number Num of primary color pixels included in the area.

(Step S1104)

The noise amount calculating section 3150 makes a comparison of magnitude relationship between Num and Nth for each region formed by a series of pixels of each of the primary colors. If the result of a comparison of magnitude relationship Num and Nth for a region is Num≦Dth, the noise amount calculating section 3150 determines that the region is small in size, i.e. is color noise. If Num>Dth, the noise amount calculating section 3150 determines that the region is large in size, i.e. is not color noise.

(Step S1105)

The noise amount calculating section compares the number Nf of primary color pixels included in a target frame with the predetermined threshold value Nth. In a case where Nf>Nth, the noise amount calculating section determines that the number of primary color pixels included in the target frame is large. On the other hand, in a case where Nf≦Nth, the noise amount calculating section determines that the number of primary color pixels included in the target frame is small.

It should be noted that Dth and Nth in the aforementioned process may be set at any value by the manufacturer. By the manufacturer setting Dth low, the discriminant criterion for the noise amount calculating section 3150 to determine that an area formed by primary color pixels is color noise is raised. By the manufacturer setting. Nth low, the discriminant criterion for the noise amount calculating section 3150 to determine that the size of a region is small in size is raised. These predetermined percentages are stored, for example, in the storage section 140 at the stage of manufacturing of the video processing device 3100. The noise amount calculating section 3150 needs only obtain the predetermined percentages with reference to the storage section 140.

(Noise Type and Noise Amount)

FIG. 7 is a diagram showing examples of quantization codes for each separate pixel. The horizontal axis represents each separate pixel (more specifically, pixel numbers assigned to each separate pixel) included in a target frame, and the vertical axis represents examples of the values of quantization codes for each separate pixel.

The noise amount calculating section 3150 calculates the percentage of the number of pixels in a target frame whose quantization codes exceed a predetermined threshold value Qth (in the example shown in FIG. 7, Qth=10) with respect to the total number of pixels in the target frame.

On the basis of the result of determination of color noise and the percentage of pixels whose quantization codes exceed Qth with respect to the total number of pixels, the noise amount calculating section 3150 changes the type and intensity of a noise reduction process that is performed by the noise reduction process section 3160.

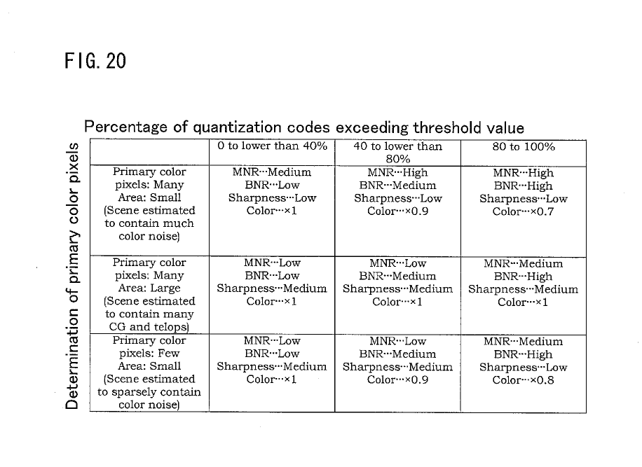

FIG. 20 is a diagram showing a relationship between the size of the number of primary color pixels included in a target pixel, the size of an area formed by primary color pixels adjacent to each other, the percentage of quantization codes exceeding a threshold value, and intensities of each separate noise reduction process that are set by the noise amount calculating section 3150. In FIG. 20, the words “BNR”, “MNR”, “SHARPNESS”, and “COLOR” represent the block noise reduction process, the mosquito noise reduction process, the sharpness process, and the color noise reduction process, respectively. In the present embodiment, the color noise reduction process encompasses a mosquito noise reduction process and a color gain reduction process for reducing the gain of a primary color determined as color noise.

It should be noted that in the color gain reduction process, which is a form of the color noise reduction process, “×1” means that a video signal supplied from the decoding process section 120 is multiplied by 1. That is, “×1” means that the color change is not changed, and that the intensity of the color noise reduction process is very low or that the color noise reduction process is not executed. Meanwhile, in the color noise reduction process, “×0.7” for example means that a video signal supplied from the decoding process section 120 is multiplied by 0.7. That is, the color gain become 0.7 times as high, and the color displayed by the corresponding pixel is converted from a color close to a primary color toward an achromatic color. A smaller value of multiplication in the color noise reduction process means a higher intensity of the color noise reduction process.

Further, as shown in FIG. 20, the noise amount calculating section 3150 sets the intensity of a block noise reduction process higher when the number of blocks having quantization codes exceeding Qth is larger.

Further, the noise amount calculating section 3150 may instruct the noise reduction process section 3160 to omit a noise reduction process set to “low”.

As shown in the second row of FIG. 20, in a case where the number of primary color pixels included in a target frame is large and the area of a region formed by a series of primary color pixels is large, the noise amount calculating section 3150 estimates that many patterns (telops and CG) are artificially embedded in the target frame. Therefore, the noise amount calculating section 3150 sets the intensity of the color noise reduction process very low or omits the color noise reduction process, regardless of the percentage of pixels whose quantization codes exceed Qth with respect to the total number of pixels. That is, the noise amount calculating section 3150 supplies “×1” to the noise reduction process section 3160.

Further, as shown in the first row of FIG. 20, in a case where the number of primary color pixels included in a target frame is large and the area of a region formed by a series of primary color pixel is small, the noise amount calculating section 3150 estimates that much color noise is contained in the target frame. Therefore, the noise amount calculating section 3150 sets the intensity of the color noise reduction process at “×1”, “×0.9”, or “×0.7” in accordance with the percentage of pixels whose quantization codes exceed Qth with respect to the total number of pixels, and then supplies it to the noise reduction process section 3160.

Further, as shown in the third row of FIG. 20, in a case where the number of primary color pixels included in a target frame is small and the area of a region formed by a series primary color pixel is small, the noise amount calculating section 3150 estimates that color noise is sparsely contained in the target frame. Therefore, the noise amount calculating section 3150 sets the intensity of the color noise reduction process at “×1”, “×0.9”, or “×0.8” in accordance with the percentage of pixels whose quantization codes exceed Qth with respect to the total number of pixels, and then supplies it to the noise reduction process section 3160.

Since each area formed by color noise is small as mentioned above, the display quality is very unlikely to be affected even if a primary color is converted into a color close to an achromatic color by reducing the color gain. Therefore, the color noise reduction process according to the present embodiment makes it possible to reduce color noise without giving the user a feeling of strangeness.

Further, the noise amount calculating section 3150 may be configured to identify a noise generation pattern in a target region set on a target frame, and to change, on the basis of a result of the identification, the type and intensity of a noise reduction process that is applied to the target region by the noise reduction process section 3160.

For example, the noise amount calculating section 3150 can be configured to detect an average color or luminance in each block, to estimate that there is block noise in the target frame when the color or luminance varies from block to block, and to increase the intensity of a block noise reduction process that is applied to a block boundary.

Further, the noise amount calculating section 3150 may be configured to determine, as mosquito noise, noise detected, if any, in the vicinity of a region (e.g. an edge of an image) where there is a great change in color or luminance, and to reduce the mosquito noise by calculating the average of pixel values in a region not including the edge. Such a configuration makes it possible to perform a finer noise reduction process.

It should be noted that each of the threshold values mentioned above can be determined in advance so that a picture that the video processing device 3100 outputs is of higher image quality.

### Embodiment 14

The following describes, with reference to FIGS. 7, 8, 10 through 12, 21, and 22, a configuration in which noise reduction parameters for a noise reduction process are changed on the basis of quantization codes and motion vector information.

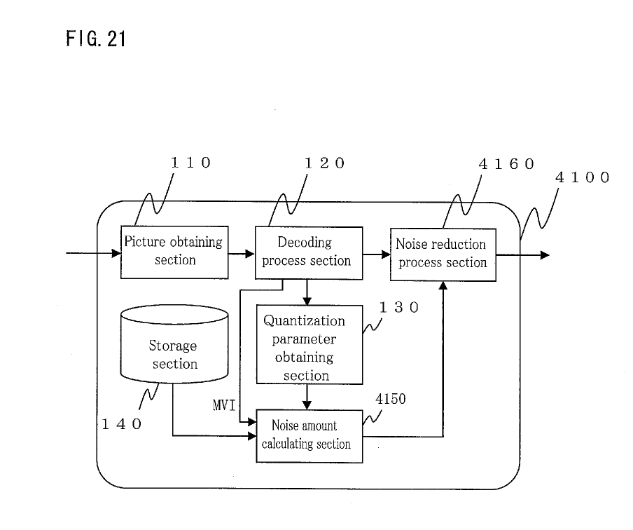

FIG. 21 is a block diagram showing a configuration of a video processing device 4100 according to the present embodiment. As shown in FIG. 21, the video processing device 4100 according to the present embodiment has substantially the same configuration as that shown in FIG. 1, but differs in that a noise amount calculating section 4150 obtains motion vector information (denoted as “MVI” in FIG. 21) from the decoding process section 120.

It should be noted that the configuration of video processing device 4100 according to the present embodiment is not limited to that shown in FIG. 21; however, in the configuration shown in FIG. 3 or 4, the noise amount calculating section 4150 may be configured to obtain motion vector information MVI from the decoding process section 120.

(Motion Vector Information)

Motion vector information is decoded from a video signal by the decoding process section 120, and is assigned to each separate block. Motion vector information contains motion components of each separate block.

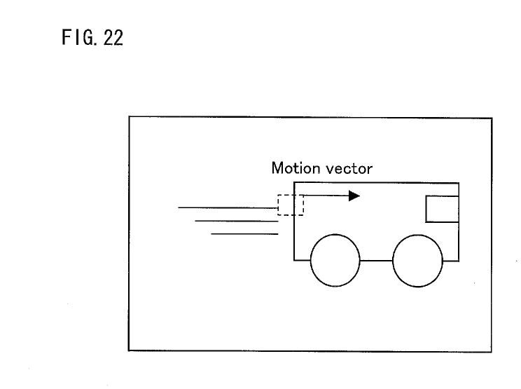

FIG. 22 shows a motion vector assigned to a block including an object moving rightward in a target frame.

(Noise Reduction Process Section 4160)

A noise reduction process section 4160 applies any of the following noise reduction processes to the target frame in accordance with an instruction from the noise amount calculating section 4150 described below. Further, the noise reduction process section 4160 switches, in accordance with an instruction from the noise amount calculating section 4150, the intensity of the noise reduction process that is applied to the target frame.

3D block noise reduction process

2D block noise reduction process

3D mosquito noise reduction process

2D mosquito noise reduction process

It should be noted here that the 3D block noise reduction process and the 3D mosquito noise reduction process are each a process that is performed with reference to a target frame and one or more other frames. In the following, the 3D block noise reduction process and the 3D mosquito noise reduction process are sometimes called “3D noise reduction process” for descriptive purposes.

Specifically, the 3D noise reduction process is a process for generating an image after noise reduction by calculating, for each pixel, the average of a target region in a target frame containing noise and a target region(s) in one or more reference frames temporally positioned before or after the target frame as a starting point, as shown in (a) of FIG. 8.

For application of a more intense 3D noise reduction process, the number of reference frames is increased, and for application of a less intense 3D noise reduction process, the number of reference frames is reduced.

Increasing the number of frames that are referred to increases the effectiveness of noise reduction, but has an aspect of easily causing an afterimage in a scene of strenuous movement. Reducing the number of frames that are referred to hardly causes an afterimage even in a scene of strenuous movement, but has an aspect of decreasing the effectiveness of noise reduction.

It should be noted that the averaging procedure in the 3D noise reduction process may be one that is performed with a weighting coefficient set so that an image after noise reduction is of higher image quality.

Alternatively, the 3D noise reduction process may be a process for comparing a target region in a target frame with a target region(s) in one or more reference frames temporally positioned before or after the target frame as a starting point, determining an instantaneously changing portion as noise, and reducing the noise.

On the other hand, the 2D block noise reduction process and the 2D mosquito noise reduction process are each a process that is performed with reference to a target pixel in a target frame and reference pixels in the target frame which are included in a reference region surrounding the target pixel. In the following, the 2D block noise reduction process and the 2D mosquito noise reduction process are sometimes called “2D noise reduction process” for descriptive purposes.

Specifically, the 2D noise reduction process is a process for generating an image after noise reduction by calculating the average of a pixel value of a target pixel in a target frame and pixel values of reference pixels in the target frame which are included in a reference region surrounding the target pixel, as shown in (b) of FIG. 8.

For application of a more intense 2D noise reduction process, the size of the reference region is increased, and for application of a less intense 2D noise reduction process, the size of the reference region is reduced.

Increasing the size of the reference region increases the effectiveness of noise reduction, but has an aspect of easily causing a blur in a region other than the region in which the noise is occurring. Reducing the size of the reference region hardly causes such a blur, but has an aspect of decreasing the effectiveness of noise reduction.

It should be noted that the averaging procedure in the 2D noise reduction process may be one that is performed with a weighting coefficient set so that an image after noise reduction is of higher image quality.

Alternatively, the 2D noise reduction process may be a process for comparing a target pixel in a target frame and reference pixels in the target frame which are included in a reference region surrounding the target pixel, determining the occurrence of noise in the target pixel in a case where the target pixel is greatly different in color or luminance from the reference pixels, and reducing the noise.

(Noise Amount Calculating Section 4150)

Next, the noise amount calculating section 4150 according to the present embodiment is described. The noise amount calculating section 4150 according to the present embodiment serves as a setting unit. The noise amount calculating section 4150 estimates the amount of noise in the picture using the quantization codes obtained by the quantization parameter obtaining section 130, motion vector information, and the threshold value stored in the storage section 140. Further, the noise amount calculating section 4150 changes, on the basis of the noise amount thus estimated, the type and intensity of a noise reduction process that is performed by the noise reduction process section 4160.

The noise amount calculating section 4150 compares, with a predetermined threshold value, the size of a motion vector assigned to each of the blocks constituting a target frame. In a case where the motion vector is larger than the threshold value, the noise amount calculating section 4150 determines that the block is a “moving block”. In a case where the motion vector is smaller than the threshold value, the noise amount calculating section 4150 determines that the block is a “motionless block”.

FIG. 7 is a diagram showing examples of quantization codes for each separate pixel. The horizontal axis represents each separate pixel (more specifically, pixel numbers assigned to each separate pixel) included in a target frame, and the vertical axis represents examples of the values of quantization codes for each separate pixel.

The noise amount calculating section 4150 calculates the percentage of the number of pixels in a target frame whose quantization codes exceed a predetermined threshold value (in the example shown in FIG. 7, threshold value=10) with respect to the total number of pixels in the target frame.

Further, the noise amount calculating section 4150 calculates the percentage of the number of blocks in a target frame which are determined as “moving” with respect to the total number of blocks in the target frame.

On the basis of these calculation results, the noise amount calculating section 4150 changes the type and intensity of a noise reduction process that the noise reduction process section 4160 applies to the target frame.

FIG. 10 is table showing an example of a relationship between the percentage of blocks determined as “moving”, the percentage of quantization codes exceeding the threshold value, and intensities of each separate noise reduction process as set by the noise reduction process section 4150. In FIG. 10, the word “BNR” refers to a block noise reduction process, and the word “MNR” refers to a mosquito noise reduction process.

As shown in FIG. 10, the noise amount calculating section 4150 sets the intensity of a block noise reduction process higher when the number of blocks determined as “moving” is larger.

Further, as shown in FIG. 10, the noise amount calculating section 4150 sets the intensity of a mosquito noise reduction process higher when the number of blocks whose quantization codes exceed a predetermined threshold value is larger.

Further, the noise amount calculating section 4150 may instruct the noise reduction process section 4160 to omit a noise reduction process set to “low”.

Further, the noise amount calculating section 4150 can be configured to select a 2D noise reduction process in a case where the percentage of blocks determined as “moving” is smaller, and to select a 3D noise reduction process in a case where the percentage of blocks determined as “moving” is larger.

Further, the noise amount calculating section 4150 can be configured to reduce the number of reference frames in a case where the percentage of blocks determined as “moving” is larger, and to increase the number of reference frames in a case where the percentage of blocks determined as “moving” is smaller.

Further, the noise amount calculating section 4150 may be configured to identify a noise generation pattern in a target region set on a target frame, and to change, on the basis of a result of the identification, the type and intensity of a noise reduction process that is applied to the target region by the noise reduction process section 4160.

For example, the noise amount calculating section 4150 can be configured to detect an average color or luminance in each block, to estimate that there is block noise in the target frame when the color or luminance varies from block to block, and to increase the intensity of a block noise reduction process that is applied to a block boundary.

Further, the noise amount calculating section 4150 may be configured to determine, as mosquito noise, noise detected, if any, in the vicinity of a region (e.g. an edge of an image) where there is a great change in color or luminance, and to reduce the mosquito noise by calculating the average of pixel values in a region not including the edge.

Such a configuration makes it possible to perform a finer noise reduction process.

It should be noted that each of the threshold values mentioned above can be determined in advance so that a picture that the video processing device 4100 outputs is of higher image quality.

### Embodiment 15

A modification of Embodiment 14 is described with reference to FIGS. 11 and 12.

In addition to the configurations described above, the noise amount calculating section 4150 according to the present modification is configured to set a threshold value for quantization codes smaller when the number of blocks determined as “moving” is larger.

FIG. 11 is a diagram showing examples of quantization codes for each separate pixel, together with a threshold value as set by the noise amount calculating section 4150 according to the present modification.

In FIG. 12, the noise amount calculating section 4150 sets a threshold value for quantization codes smaller when the number of blocks determined as “moving” is larger.

In most systems of encoding, quantization codes are set at the encoding side in view of the required compression ratio and the like. For example, in a case where the original picture contains “glittering noise”, the resulting picture per se may contain much noise even if the compression ratio is set low, i.e. even if the quantization codes are set small.

Meanwhile, such a picture tends to be determined by motion determination as having many “moving” blocks.

The present modification sets a threshold value for quantization codes smaller when there are more “moving” blocks, thus making it possible to suitably reduce the aforementioned “glittering noise”.

### Embodiment 16

Although the foregoing description assumes that the noise amount calculating section 4150 obtains motion vector information from the decoding process section 120, Embodiment 14 is not limited to this.

For example, in a configuration in which the video processing device 4100 is used in combination with a frame rate adjusting unit (FRC: Frame Rate Controller) for double speed driving, the noise amount calculating section 4150 may be configured to obtain motion vector information from the FRC. Specific examples of such a configuration include a television receiver that performs double-speed driving, etc.

Since the FRC calculates a motion vector for each block to generate a complementary block, the noise amount calculating section 4150 can obtain these motion vectors from the FRC to perform the aforementioned noise reduction process.

### Embodiment 17

The following describes, with reference to FIGS. 7, 23, and 24, a configuration in which the respective quantization code values of blocks constituting a target frame are obtained, in which noise reduction parameters in the target frame are calculated on the basis of the respective quantization code value, and in which noise reduction process intensities in a predetermined range are set to have a positive correlation with the noise reduction parameters within a predetermined range. It should be noted that the noise reduction parameters are hereinafter referred to as “NR discriminant values” and the noise reduction process intensities are hereinafter referred to also as “NR gains”.

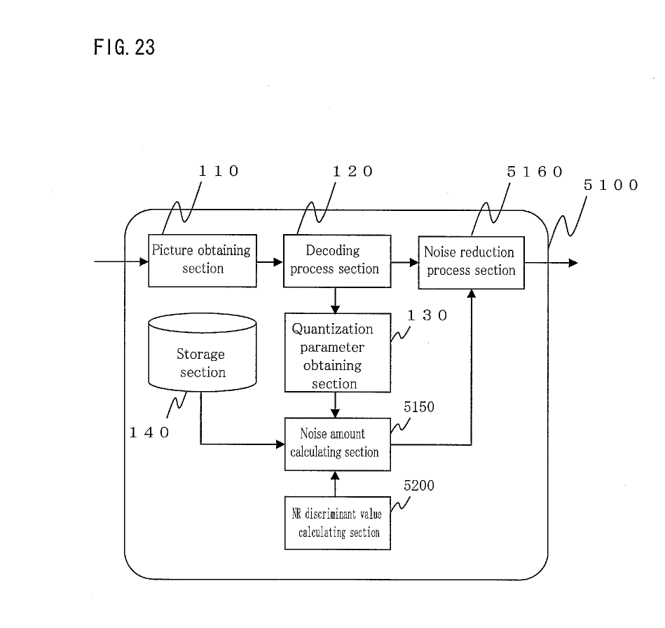

FIG. 23 is a block diagram showing a configuration of a video processing device 5100 according to the present embodiment. As shown in FIG. 23, the video processing device 5100 according to the present embodiment differs from the video processing device according to Embodiment 1 in that it includes an NR discriminant value calculating section 5200.

FIG. 7 is a diagram showing examples of quantization codes for each separate pixel. The horizontal axis represents each separate pixel (more specifically, pixel numbers assigned to each separate pixel) included in a target frame, and the vertical axis represents examples of the values of quantization codes for each separate pixel.

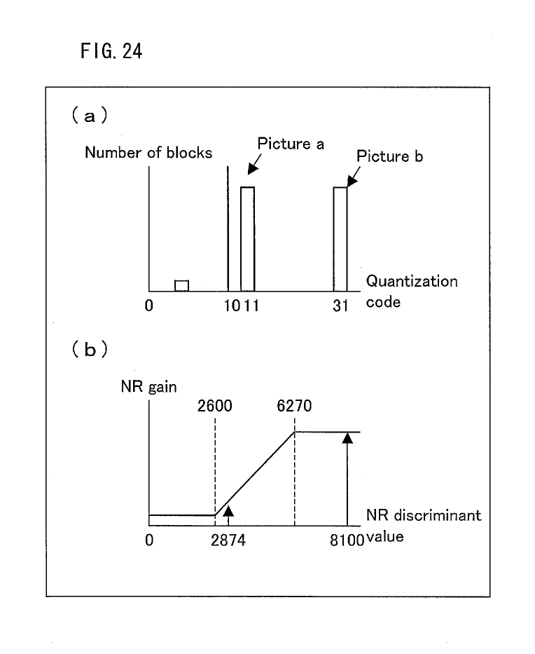

FIG. 24 is a set of diagrams (a) and (b) for explaining a noise reduction process that the video processing device 5100 performs. (a) of FIG. 24 shows a histogram of quantization code values of each separate block constituting a target frame. (b) of FIG. 24 shows a correlation between a noise reduction parameter and a noise reduction process intensity.

(NR Discriminant Value Calculating Section 5200)

The NR discriminant value calculating section 5200 shown in FIG. 23 calculates an NR discriminant value in a target frame on the basis of quantization code values respectively assigned to blocks included in the target frame.

More specifically, the NR discriminant value calculating section 5200 calculates an NR discriminant value in a target frame by obtaining a weighted sum by weighting each quantization code value included in the target frame with the number of blocks having the quantization code value. The present embodiment is described assuming that a possible range of quantization code values is integers of 0 to 31. The aforementioned process is mathematically expressed as follows:

NRP={BN(0)×0+BN(1)×1+BN(2)×2+ . . . +BN(30)×30+BN(31)×31}/31 (1)

where NRP denotes the NR discriminant value and BN(n) denotes the number of blocks having a quantization code value n included in the target frame. That is, each term in Exp. (1) represents the number of blocks having a quantization code value and the product obtained by multiplying the number by that quantization code value. Furthermore, by obtaining a sum for each quantization code value, the NR discriminant value calculating section 5200 calculates an NR discriminant value in the target frame.

(a) of FIG. 24 is an image schematically representing a result of the counting. As such, (a) of FIG. 24 does not strictly show a histogram of quantization code values in a single target frame, but shows a histogram of quantization code values in different target frames, namely a picture a and a picture b. Specifically, all of the blocks constituting the picture a have a quantization code value of 11. Meanwhile, all of the blocks constituting the picture b have a quantization code value of 31.

In a case where the target frame is constituted by 1920×1080 pixels and all of the block sizes are 16×16, the number, of blocks included in the target frame is 8100. Therefore, the picture a is constituted by 8100 blocks having a quantization code value of 11. Meanwhile, the picture b is constituted by 8100 blocks having a quantization code value of 31. The NR discriminant value calculating section 5200 calculates 8100×11/31=2874 as the NR discriminant value of the picture a, and calculates 8100×31/31=8100 as the NR discriminant value of the picture b.

The NR discriminant value calculating section 5200 supplies an NR discriminant value thus calculated in each target frame to the noise amount calculating section 5150.

(Noise Reduction Process Section 5160)

A noise reduction process section 5160 applies any of the following noise reduction processes to the target frame in accordance with an instruction from the noise amount calculating section 5150 described below. Further, the noise reduction process section 5160 switches, in accordance with an instruction from the noise amount calculating section 5150, the intensity of the noise reduction process that is applied to the target frame.

3D block noise reduction process

2D block noise reduction process

3D mosquito noise reduction process

2D mosquito noise reduction process

It should be noted here that the 3D block noise reduction process and the 3D mosquito noise reduction process are each a process that is performed with reference to a target frame and one or more other frames. In the following, the 3D block noise reduction process and the 3D mosquito noise reduction process are sometimes called “3D noise reduction process” for descriptive purposes.

Specifically, the 3D noise reduction process is a process for generating an image after noise reduction by calculating, for each pixel, the average of a target region in a target frame containing noise and a target region(s) in one or more reference frames temporally positioned before or after the target frame as a starting point.

For application of a more intense 3D noise reduction process, the number of reference frames is increased, and for application of a less intense 3D noise reduction process, the number of reference frames is reduced.

Increasing the number of frames that are referred to increases the effectiveness of noise reduction, but has an aspect of easily causing an afterimage in a scene of strenuous movement. Reducing the number of frames that are referred to hardly causes an afterimage even in a scene of strenuous movement, but has an aspect of decreasing the effectiveness of noise reduction.

It should be noted that the averaging procedure in the 3D noise reduction process may be one that is performed with a weighting coefficient set so that an image after noise reduction is of higher image quality.

Alternatively, the 3D noise reduction process may be a process for comparing a target region in a target frame with a target region(s) in one or more reference frames temporally positioned before or after the target frame as a starting point, determining an instantaneously changing portion as noise, and reducing the noise.

On the other hand, the 2D block noise reduction process and the 2D mosquito noise reduction process are each a process that is performed with reference to a target pixel in a target frame and reference pixels in the target frame which are included in a reference region surrounding the target pixel. In the following, the 2D block noise reduction process and the 2D mosquito noise reduction process are sometimes called “2D noise reduction process” for descriptive purposes.

Specifically, the 2D noise reduction process is a process for generating an image after noise reduction by calculating the average of a pixel value of a target pixel in a target frame and pixel values of reference pixels in the target frame which are included in a reference region surrounding the target pixel.

For application of a more intense 2D noise reduction process, the size of the reference region is increased, and for application of a less intense 2D noise reduction process, the size of the reference region is reduced.

Increasing the size of the reference region increases the effectiveness of noise reduction, but has an aspect of easily causing a blur in a region other than the region in which the noise is occurring. Reducing the size of the reference region hardly causes such a blur, but has an aspect of decreasing the effectiveness of noise reduction.

It should be noted that the averaging procedure in the 2D noise reduction process may be one that is performed with a weighting coefficient set so that an image after noise reduction is of higher image quality.

Alternatively, the 2D noise reduction process may be a process for comparing a target pixel in a target frame and reference pixels in the target frame which are included in a reference region surrounding the target pixel, determining the occurrence of noise in the target pixel in a case where the target pixel is greatly different in color or luminance from the reference pixels, and reducing the noise.

(Noise Amount Calculating Section 5150)

Next, the noise amount calculating section 5150 according to the present embodiment is described. The noise amount calculating section 5150 according to the present embodiment serves as a setting unit. The noise amount calculating section 5150 derives NR gains (noise reduction process intensities) corresponding to the NR discriminant values calculated by the NR discriminant value calculating section 5200. Further, the noise amount calculating section 5150 changes, on the basis of the NR gains thus derived, the type and intensity of a noise reduction process that is performed by the noise reduction process section 5160.

(b) of FIG. 24 is a diagram showing a correlation between an NR discriminant value and an NR gain. The noise amount calculating section 5150 derive a corresponding NR gain from an NR discriminant value on the basis of the correlation. The manufacturer may causes a function of NR discriminant values representing NR gains to be stored as the correlation in the storage section 140, or may causes a look-up table (LUT) associating the NR gains and the NR discriminant values with each other to be stored as the correlation in the storage section 140. The correlation is not limited to the function or the LUT, but needs only be configured be able to associate the NR gains and the NR discriminant values with each other.

As shown in (b) of FIG. 24, the correlation is set up so that there is a positive correlation between the NR discriminant values and the NR gains in a predetermined range of NR discriminant values (a range of 2600 to 6270 in (b) of FIG. 24). In (a) of FIG. 24, the positive correlation is a linear function. Meanwhile, the NR gains do not depend on the NR discriminant values in ranges of NR discriminant values out of the predetermined range (a range of 0 to 2600 and a range of 6270 to 8200 in (b) of FIG. 24). That is, in the range of NR discriminant values of 0 to 2600, the NR gains always take on a lower-limit value in the predetermined region. Further, in the range of NR discriminant values of 6270 to 8100, the NR gains always take on an upper-limit value in the predetermined region.

The predetermined range in the present embodiment is constituted by a case where all of the blocks constituting a target frame have a quantization code value of 10 and a case where all of the blocks have a quantization code value of 24. In a case where all of the blocks have a quantization code value of 10, the NR discriminant value is about 2600. Meanwhile, in a case where all of the blocks have a quantization code value of 24, the NR discriminant value is about 6270. The inventors found that with a quantization code value of 10 or less, deterioration in the picture due to encoding and decoding is such that the user cannot recognize it. Therefore, in the present embodiment, the lower limit of the predetermined range of NR discriminant values is 2600. Further, the inventors also found that with a quantization code value 24 or greater, deterioration in the picture due to encoding and decoding is so great that it is preferable to execute a noise reduction process at as high an intensity as possible. Therefore, in the present embodiment, the upper limit of the predetermined range of NR discriminant values is 6270. It should be noted that the predetermined range is not limited to the aforementioned range, but can be set as appropriate by the manufacturer according to the mode of noise reduction process to be executed.

The noise amount calculating section 5150 derives NR gains on the basis of the correlation from the NR discriminant values calculated by the NR discriminant value calculating section 5200. Since the correlation is configured to be continuous in the whole range of NR discriminant values (range of 0 to 8100), the noise amount calculating section 5150 can derive an NR gain suitable for each of the NR discriminant values. Since the correlation is configured to be continuous, there is no sharp difference between any one of NR gains calculated by the noise amount calculating section 5150 and another at a certain NR discriminant value. This makes it possible to execute an effective noise reduction process without causing the user viewing the picture to be aware of the noise reduction process.

It should be noted that the correlation in the predetermined range is not limited to a linear function. The correlation may be configured using a higher-dimensional function, provided there is a positive correlation between the NR discriminant values and the NR gains.

In the case of determination of an NR gain according to whether or not a quantization code value of a block constituting a target frame is greater than a predetermined single threshold value, there is a large change in NR gain at the predetermined threshold. This causes an abrupt change in noise reduction process intensity at the threshold value, thus giving the user a feeling of strangeness. The noise amount calculating section 5150 according to the present embodiment derives NR gains by using a correlation configured to be continuous as mentioned above, thus making it possible to perform a finer noise reduction process.

On the basis of the NR gains thus derived, the noise amount calculating section 5150 derives the type and intensity of a noise reduction process that the noise reduction process section 5160 applies to the target frame. As the noise reduction process that the noise reduction process section 5160 applies to the target frame, a conventionally-known method of noise reduction process can be used. For example, a block noise reduction process or a mosquito noise reduction process may be used as mentioned above. Alternatively, a combination of noise reduction processes may be used.

For example, the noise amount calculating section 5150 can be configured to detect an average color or luminance in each block, to estimate that there is block noise in the target frame when the color or luminance varies from block to block, and to increase the intensity of a block noise reduction process that is applied to a block boundary.

Further, the noise amount calculating section 5150 may be configured to determine, as mosquito noise, noise detected, if any, in the vicinity of a region (e.g. an edge of an image) where there is a great change in color or luminance, and to reduce the mosquito noise by calculating the average of pixel values in a region not including the edge.

Such a configuration makes it possible to perform a finer noise reduction process.

It should be noted that each of the threshold values mentioned above can be determined in advance so that a picture that the video processing device 5100 outputs is of higher image quality.

### Embodiment 18

The following describes, with reference to FIGS. 7, 8, 14, and 25 through 27, a video processing device 6100 including: a setting unit configured to set an offset of a noise reduction parameter on the basis of quantization codes of each separate block constituting an I picture contained in video data; a changing unit configured to change the offset in accordance with a first interval that is a frame interval between I pictures; and a noise reducing unit configured to subject the video data to a noise reduction process using the noise reduction parameter including the offset changed by the changing unit.

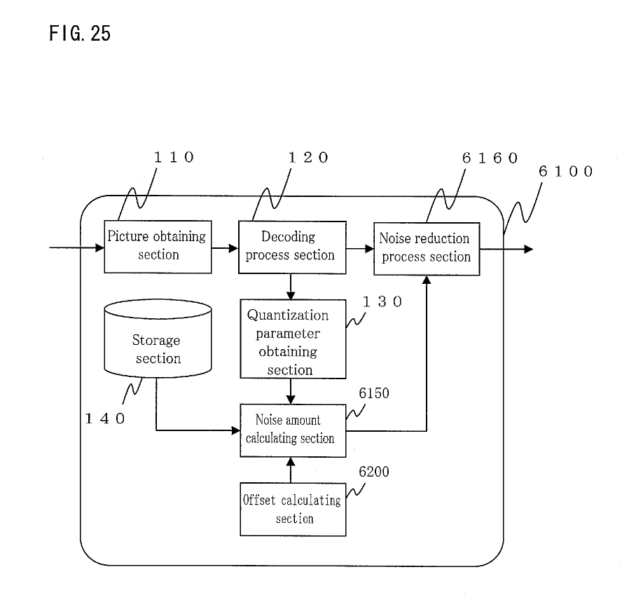

FIG. 25 is a block diagram showing a video processing device 6100 according to the present embodiment. The video processing device 6100 shown in FIG. 25 differs from the video processing device shown in FIG. 1 in that the video processing device 6100 includes an offset calculating section 6200.

FIG. 14 is a set of schematic views for explaining mosquito noise, and FIG. 8 is a set of schematic views for explaining a 3D noise reduction process and a 2D noise reduction process in an aspect of a noise reduction process according to the present embodiment.

FIG. 7, which is a diagram for explaining the video processing device according to the present embodiment, is a diagram showing examples of quantization codes of blocks constituting a target block and an example of a threshold value.

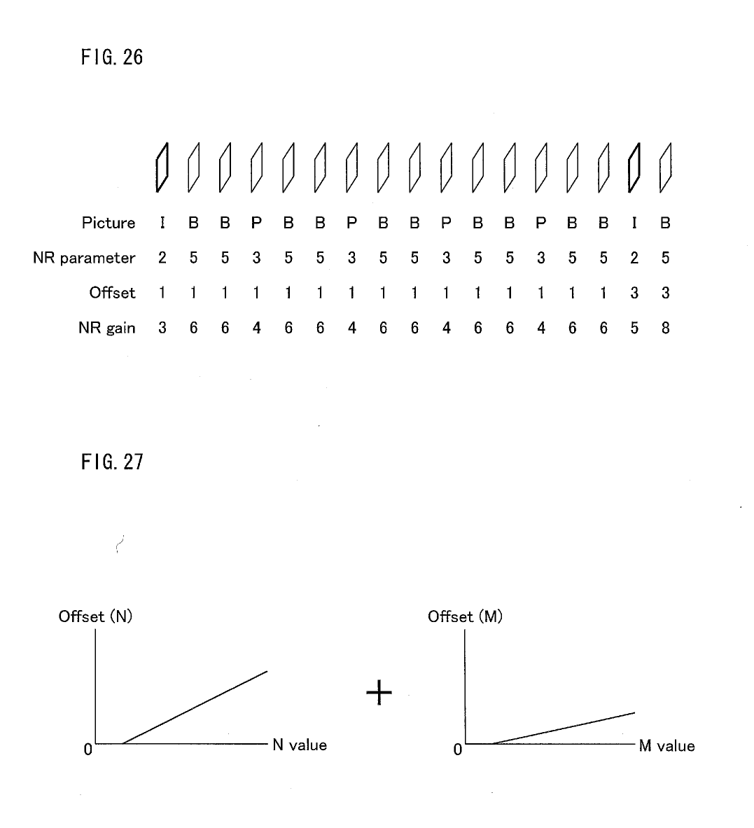

FIG. 26, which is a diagram for explaining a video processing device according to an embodiment of the present invention, is a diagram showing a plurality of pictures contained in video data, an NR parameter in each of the pictures, an offset in each of the pictures, and an NR gain in each of the pictures.

FIG. 27, which is a diagram for explaining a video processing device according to an embodiment of the present invention, is a diagram schematically showing an offset (N) and an offset (M).

(Offset Calculating Section 6200)

An offset calculating section 6200 is a changing unit by which an offset set by a noise amount calculating section 6150 serving as a setting unit is changed on the basis of a frame interval between I pictures and a frame interval between P pictures separately. In the following, an offset set by the noise amount calculating section 6150 is expressed as “offset (i)” or “OFFSET (i)”, and an offset changed by the offset calculating section 6200 is expressed as “offset (f)” or “OFFSET (f)”. The noise amount calculating section 6150 and the offset (i) will be described later. In the following, the offset calculating section 6200, which is the point of the present embodiment, is described with reference to FIGS. 26 and 27.

FIG. 26, which is a diagram for explaining a video processing device according to an embodiment of the present invention, is a diagram showing a plurality of pictures contained in video data, an NR parameter in each of the pictures, an offset in each of the pictures, and an NR gain in each of the pictures. The video data is constituted by a series of GOPs (Groups Of Pictures) each constituted by a single I picture, a plurality of P pictures, and a plurality of B pictures. In the video data shown in FIG. 26, a single GOP is constituted by twelve pictures “I, B, B, P, B, B, P, B, B, P, B, B, P, B, B”.

In the present embodiment, the interval between an I picture included in a GOP and an I picture included in a GOP adjacent to the GOP is defined as a frame interval between I picture. Further, in the following, a frame interval between I pictures is denoted as N. In the present embodiment, as shown in FIG. 26, the frame interval between I picture is such that N=15. In the case where N=1, all of the pictures constituting the video data are I pictures. N can take on a value in the range of integers of 1≦N.

Meanwhile, in the present embodiment, the frame interval between those of a plurality of P pictures included in a single GOP which are closest to each other is defined as a frame interval between P pictures. Further, in the following, a frame interval between P pictures is denoted as M. It is preferable that M be a divisor of N. In the present embodiment, M is a divisor of N, specifically M=3. As in the case of N, M can take on a value in the range of integers of 1≦M.

The aforementioned N and M are embedded in most of the video data encoded by any system of encoding. Therefore, the offset calculating section 6200 can easily obtain M and N, for example, from the decoding process section 120.

It should be noted that the NR parameters shown in FIG. 26 are parameters indicating intensities of noise reduction process as set by the noise amount calculating section 6150 with respect to I pictures, P pictures, and B pictures separately. The NR parameters will be described later.

(Changing of an Offset)

As mentioned above, the offset calculating section 6200 obtains an offset (i) from the noise amount calculating section 6150. The noise amount calculating section 6150 sets an offset (i) on the basis of a quantization code of each separate block constituting an I picture. The offset calculating section 6200 derives an offset (N) by which the offset (i) is changed in accordance with N and an offset (M) by which the offset (i) is changed in accordance with M. The following describes the offset (N) and the offset (M) with reference to FIG. 27.

FIG. 27, which is a diagram for explaining a video processing device according to an embodiment of the present invention, is a diagram schematically showing an offset (N) and an offset (M).

(Offset (N))

In the present embodiment, the offset (N) has a positive correlation with N. The correlation between the offset (N) and N may be a linear function as shown in FIG. 27, or may be a quadratic function, a logarithmic function, or the like. In other words, the correlation needs only be positive, and is not limited in any other respect. Further, the correlation is not limited to such a function as that shown in FIG. 27, but may be a look-up table associating the offset (N) and N with each other so that there is a positive correlation therebetween. It should be noted that the present embodiment is described assuming that the correlation is a linear function shown in FIG. 27.

A liner function representing a correlation between the offset (N) and N is shown in Formula (1). It should be noted that the offset (N) is hereinafter denoted also as OFFSET (N).

OFFSET(N)=an×N+bn (1)

where an is the first coefficient representing a slope and bn is the y-intercept. The slope of the linear function of Formula (1) is limited to the range of 0<an. It should be noted that in the diagram showing the offset (N) in FIG. 27, the value of −(bn/an), which is the x-intercept, is not particularly limited. For example, even if N=1, but when the offset calculating section 6200 derives an offset (N) that is greater than 0, it is only necessary to make a configuration in which the x-intercept falls within the range of −(bn/an)<1. In so doing, the liner function may be such that the x-intercept is negative, in other words, the y-intercept is positive. For another example, such a situation can be assumed that it is not necessary to change the offset (i) in the range of 1≦N≦10. In such a case, when the x-intercept in Formula (1) falls within the range of 10<−(bn/an)≦11 and when the offset (N) that the offset calculating section 6200 derives according to Formula (1) is negative, the offset calculating section 6200 needs only be configured to derive (N)=0. According to this configuration, when N falls within the range of 1≦N≦10, the offset calculating section 6200 derives (N)=0. Thus, in the linear function represented by Formula (1), the x-intercept −(bn/an) and the y-intercept bn are not particularly limited, but may be set as appropriate so that the offset (N) that the offset calculating section 6200 derives takes on an appropriate value.

(Offset (M))

In the present embodiment, as in the case of the correlation between the offset (N) and N, the offset (M) has a positive correlation with M. As with the correlation between the offset (N) and N, the correlation between the offset (M) and M needs only be positive, and is not limited in any other respect. That is, the correlation between the offset (M) and M may be such a linear function as that shown in FIG. 27, or may be a quadratic function, a logarithmic function, or the like. Further, the correlation between the offset (M) and M may be represented by a look-up table. It should be noted that the present embodiment is described assuming that the correlation between the offset (M) and M is a linear function shown in FIG. 27.

A liner function representing a correlation between the offset (M) and M is shown in Formula (2). It should be noted that the offset (M) is hereinafter denoted also as OFFSET (M).

OFFSET(M)=am×M+bm (2)

where am is the second coefficient representing a slope and bm is the y-intercept. The slope of the linear function of Formula (2) is limited to the range of 0<am. Meanwhile, the x-intercept −(bm/am) and the y-intercept bm are not particularly limited, but may be set as appropriate so that the offset (M) that the offset calculating section 6200 derives takes on an appropriate value.

The offset calculating section 6200 derives the offset (N) and the offset (M) in the manner described above. On that basis, the offset calculating section 6200 derives the offset (f), which a changed offset, by adding the offset (N) and the offset (M) to the offset (i) that the noise amount calculating section 6150 sets. The offset (f) can be expressed as in Formula (3). It should be noted that the offset (i) is also expressed as OFFSET (i) and the offset (f) is also expressed as OFFSET (f).

OFFSET(f)=OFFSET(i)+OFFSET(N)+OFFSET(M) (3)

The offset calculating section 6200 outputs the changed offset (f) thus derived to the noise amount calculating section 6150.

(Effects of N and M on Video Data)

Effects of N, which is the frame interval between I pictures, and M, which is the frame interval between P pictures, on the image quality of video data are explained on the basis of the findings that the inventors obtained.

The inventors studied effects of N and M on the image quality of video data by encoding the video data and changing N and M as parameters in decoding the video data. In the result, the inventors found that it is N that greatly affects the image quality of video data when the video data is encoded and decoded. In other words, the effect of M on the image quality of video data is smaller than the effect of N on the image quality of the video data.

On the basis of these findings, it is preferable that the magnitude relationship between the slope an of Formula (1) representing the offset (N) and the slope am of Formula (2) representing the offset (M) be an>am. Substituting Formula (1) and Formula (2) in OFFSET(N) and OFFSET(M) of Formula (3) gives Formula (4).

OFFSET(f)=OFFSET(i)+an×N+am×M+bn+bm (4)

where N>M and an>am. Therefore, OFFSET(f) depends greatly on the second term an×N of Formula (4).

The slope an of Formula (1) and the slope am of Formula (2) can also be expressed as weighting coefficients for N and M in the derivation of the offset (f), which is a changed offset.

(Modification of the Offset Calculating Section 6200)

An offset calculating section that is a modification of the offset calculating section 6200 is denoted as an offset calculating section a. The offset calculating section a derives the offset (f) by deriving the offset (N) on the basis of N and adding the offset (N) to the offset (i). According to the findings that the inventors obtained, it is N that mainly affects the image quality of video data when the video data is encoded and decoded. Since the effect of M on the image quality of video data is secondary, the offset calculating section a may be configured to derive the offset (f) on the basis of N.

(Noise Reduction Process Section 6160)

In accordance with an instruction from the noise amount calculating section 6150 described below, a noise reduction process section 6160 applies, to the target picture, any of the following noise reduction processes that includes at least a noise reduction process. Further, the noise reduction process section 6160 switches, in accordance with an instruction from the noise amount calculating section 6150, the intensity of the noise reduction process that is applied to the target picture.

3D mosquito noise reduction process

2D mosquito noise reduction process

3D block noise reduction process

2D block noise reduction process

(Mosquito Noise Reduction Process)

The noise reduction process section 6160 performs a mosquito noise reduction process as a type of color noise reduction process as mentioned above. Mosquito noise is schematically explained here with reference to (a) of FIG. 14. Mosquito noise has a tendency to occur in such an edge region in a target picture where there is a great change in color or luminance. In (a) of FIG. 14, the region B indicates a low-luminance region and the region C indicates a high-luminance region. Mosquito noise tends to occur near a boundary between the regions B and C where there is a great change in luminance. The region A indicates a region in which mosquito noise is occurring. The region A is supposed to be a low-luminance region like the region B, the occurrence of mosquito noise causes the region A to be higher in luminance than the region B and lower in luminance than the region C.

It should be noted that the aforementioned edge region can be rephrased as being formed by a block which, of blocks constituting a target picture, has a high-frequency component. Therefore, mosquito noise can also be said to tend to occur in a block having a high-frequency component and blocks therearound. As a result of this, when the percentage of blocks that have high-frequency components to block constituting a target picture is high, there is a high possibility that much mosquito noise is contained in the target picture. Further, when a picture represented by a target picture contains a large number of edge regions, there is a high possibility that mosquito noise is much mosquito noise is contained in the target picture.

Mosquito noise reduction processes are categorized into a 3D mosquito noise reduction process and a 2D mosquito noise reduction process as will be mentioned later.

(Block Noise Reduction Process)

Block noise is, in general, rectangular noise that occurs when a picture is encoded at a high compression ratio. Block noise is called as such because the size of the noise is the same as the size of a block in encoding. Block noise reduction processes are categorized into a 3D block noise reduction process and a 2D block noise reduction process as will be mentioned later.

(3D Noise Reduction Process)

It should be noted here that the 3D block noise reduction process and the 3D mosquito noise reduction process are each a process that is performed with reference to a target picture and one or more other pictures. In the following, the 3D block noise reduction process and the 3D mosquito noise reduction process are sometimes called “3D noise reduction process” for descriptive purposes.

Specifically, the 3D noise reduction process is a process for generating an image after noise reduction by calculating, for each pixel, the average of a target region in a target picture containing noise and a target region(s) in one or more reference pictures temporally positioned before or after the target picture as a starting point, as shown in (a) of FIG. 8.

For application of a more intense 3D noise reduction process, the number of reference pictures is increased, and for application of a less intense 3D noise reduction process, the number of reference pictures is reduced.

Increasing the number of pictures that are referred to increases the effectiveness of noise reduction, but has an aspect of easily causing an afterimage in a scene of strenuous movement. Reducing the number of pictures that are referred to hardly causes an afterimage even in a scene of strenuous movement, but has an aspect of decreasing the effectiveness of noise reduction.

It should be noted that the averaging procedure in the 3D noise reduction process may be one that is performed with a weighting coefficient set so that an image after noise reduction is of higher image quality.

Alternatively, the 3D noise reduction process may be a process for comparing a target region in a target picture with a target region(s) in one or more reference pictures temporally positioned before or after the target picture as a starting point, determining an instantaneously changing portion as noise, and reducing the noise.

(2D Noise Reduction Process)

On the other hand, the 2D block noise reduction process and the 2D mosquito noise reduction process are each a process that is performed with reference to a target pixel in a target picture and reference pixels in the target picture which are included in a reference region surrounding the target pixel. In the following, the 2D block noise reduction process and the 2D mosquito noise reduction process are sometimes called “2D noise reduction process” for descriptive purposes.

Specifically, the 2D noise reduction process is a process for generating an image after noise reduction by calculating the average of a pixel value of a target pixel in a target picture and pixel values of reference pixels in the target picture which are included in a reference region surrounding the target pixel, as shown in (b) of FIG. 8.

For application of a more intense 2D noise reduction process, the size of the reference region is increased, and for application of a less intense 2D noise reduction process, the size of the reference region is reduced.

Increasing the size of the reference region increases the effectiveness of noise reduction, but has an aspect of easily causing a blur in a region other than the region in which the noise is occurring. Reducing the size of the reference region hardly causes such a blur, but has an aspect of decreasing the effectiveness of noise reduction. Further, the 2D mosquito noise reduction process may be applied in a case where a region A in which mosquito noise is occurring and the high-luminance regions C are close to each other as shown in (b) of FIG. 14. In such a case, setting a reference region as shown in (b) of FIG. 14 makes it possible to prevent the high-luminance regions C from being included in the reference region. By thus setting the reference region, the mosquito noise reduction process can be more effectively executed.

It should be noted that the averaging procedure in the 2D noise reduction process may be one that is performed with a weighting coefficient set so that an image after noise reduction is of higher image quality.

Alternatively, the 2D noise reduction process may be a process for comparing a target pixel in a target picture and reference pixels in the target frame which are included in a reference region surrounding the target pixel, determining the occurrence of noise in the target pixel in a case where the target pixel is greatly different in color or luminance from the reference pixels, and reducing the noise.

(Noise Amount Calculating Section 6150)

Next, the noise amount calculating section 6150 according to Embodiment 18 is described with reference to FIG. 26. The noise amount calculating section 6150 is a setting unit.

(NR Parameter)

The noise amount calculating section 6150 according to the present embodiment assigns NR parameters as shown in FIG. 26 to each of the I, P, and B pictures contained in video data. In the present embodiment, NRI denotes an NR parameter of an I picture, NRP denotes an NR parameter for a P picture, and NRB denotes an NR parameter for a B picture. The noise amount calculating section 6150 assigns NRI=2 to an I picture, assigns NRP=3 to a P picture, and assigns NRB=5 to a B picture. Although the values of NRI, NRP, and NRB are not limited to those mentioned above, it is preferable that the magnitude relationship between the NR parameters be NRI<NRP<NRB.

An I picture is a picture that can be decoded without reference to another picture. A P picture is picture that can be decoded with reference to another one picture. A B picture is a picture that can be decoded with reference to another two pictures. It can be inferred from this that an I picture is lowest, a P picture second lowest, and a B picture highest in the possibility of noise being generated when the picture is encoded and decoded. Therefore, as mentioned above, it is preferable that the magnitude relationship between the NR parameters be NRI<NRP<NRB.

(Offset (i))

FIG. 7 is a diagram showing examples of quantization codes for each separate pixel. The horizontal axis represents each separate pixel (more specifically, pixel numbers assigned to each separate pixel) included in an I picture serving as a target, and the vertical axis represents examples of the values of quantization codes for each separate pixel.

The noise amount calculating section 6150 calculates the percentage of the number of pixels in a target frame whose quantization codes exceed a predetermined threshold value (in the example shown in FIG. 7, threshold value=10) with respect to the total number of pixels in the I picture.

The noise amount calculating section 6150, which is a setting unit, sets the offset (i), which is an offset of the NR parameter, on the basis of the percentage of blocks whose calculated quantization codes exceed a predetermined threshold value. From a large number of blocks having quantization codes exceeding a threshold value (i.e. from a high percentage of blocks, of blocks constituting an I picture serving as a target, whose calculated quantization codes exceed a predetermined threshold value), it is estimated that the compression ratio at which the I picture is encoded is high. Moreover, a picture compressed at a high compression ratio is estimated to be more likely to contain noise than a picture compressed at a low compression ratio. Therefore, it is preferable that the noise amount calculating section 6150 be configured to set the offset (i) larger when the number of blocks having quantization codes exceeding a threshold value is larger.

The noise amount calculating section 6150 supplies the offset (i) thus set to the offset calculating section 6200.

(Calculation of NR Gain)

After supplying the offset (i) to the offset calculating section 6200, the noise amount calculating section 6150 obtains the changed offset (f) from the offset calculating section 6200. The offset shown in FIG. 26 indicates the offset (f).

By adding the NR parameter of each picture and the offset (f), the noise amount calculating section 6150 calculates an NR gain as a parameter for determining the intensity of a noise reduction process. On the basis of the NR gain, the noise amount calculating section 6150 changes the type and intensity of a noise reduction process that is performed by the noise reduction process section 6160.

According to the foregoing configuration, the noise amount calculating section 6150 sets the initial offset on the basis of quantization codes of each separate block constituting an I picture contained in video data. Further, the offset calculating section 6200 changes the initial offset in accordance with the frame interval between I pictures. Therefore, the video processing device makes it possible to perform an effective noise reduction process while suppressing cost increases.

Further, according to the foregoing configuration, the offset calculating section 6200 changes the offset (N) so that its value is larger when the frame interval N between I pictures is larger. That is, when N is larger, the noise reduction process section 6160 performs a more intense noise reduction process on the picture. This makes it possible to perform an appropriate noise reduction process in accordance with the changes in N.

Further, according to the foregoing configuration, the offset calculating section 6200 further changes the offset (M) so that its value is larger when the frame interval M between P pictures is larger. That is, when M is larger, the noise reduction process section 6160 performs a more intense noise reduction process on the picture. This makes it possible to perform an appropriate noise reduction process by taking into account the changes in M in addition to the changes in N.

Further, according to the foregoing configuration, the offset calculating section 6200 derives the offset (N) based on N by deriving the product of an and N. Further, the offset calculating section 6200 derives the offset (M) based on M by deriving the product of am and M. Furthermore, the offset calculating section 6200 derives the offset (f) on the basis of the sum of the offset (N) based on N and the offset (M) based on P.

Here, an is greater than am. The configuration is based on the inventors' findings that N is more important than M as a factor that causes deterioration in the image quality of a picture (generates noise). The foregoing configuration makes it possible to perform a noise reduction process on a picture according to the degree of deterioration in the image quality of the picture due to N and M.

Further, according to the foregoing configuration, the noise amount calculating section 6150 sets the offset larger when the number of blocks which, of the blocks constituting the I picture, have quantization codes exceeding the threshold value is larger. This makes it possible to perform a more intense noise reduction process when the compression ratio at which the picture is compressed is higher.

Further, the noise amount calculating section 6150 may be configured to identify a noise generation pattern in a target region set on a target picture, and to change, on the basis of a result of the identification, the type and intensity of a noise reduction process that is applied to the target region by the noise reduction process section 6160.

For example, the noise amount calculating section 6150 can be configured to detect an average color or luminance in each block, to estimate that there is block noise in the target picture when the color or luminance varies from block to block, and to increase the intensity of a block noise reduction process that is applied to a block boundary.

Further, the noise amount calculating section 6150 may be configured to determine, as mosquito noise, noise detected, if any, in the vicinity of a region (e.g. an edge of an image) where there is a great change in color or luminance, and to reduce the mosquito noise by calculating the average of pixel values in a region not including the edge.

Such a configuration makes it possible to perform a finer noise reduction process.

It should be noted that each of the threshold values mentioned above can be determined in advance so that a picture that the video processing device 6100 outputs is of higher image quality.

### Embodiment 19

Processes of the functional sections of the video processing devices 1100, 2100, 3100, 4100, 5100, and 6100 described in the respective embodiments described herein may be realized by storing a program for realizing the processes in a computer-readable storage medium and causing a computer system to read and execute the program stored in the storage medium. As used herein, the term “computer system” encompasses hardware such as an OS (Operating System) and peripherals.

Further, the program may be one for realizing some of the aforementioned functions, or may be one that can realize the aforementioned functions in combination with a program already stored in the computer system.

Further, the “storage medium” containing the program refers to portable media such as a flexible disk, a magnet-optical disk, ROM (Read Only Memory), and CD-ROM; storage devices such as a hard disk contained in a computer system; and the like. Furthermore, the “storage medium” containing the program also encompasses one that dynamically retains a program for a short period of time, such as a communication line in the case of transmission of a program via a network (e.g. the Internet) or a telecommunications line (e.g. a telephone line), and one which retains a program for a certain period of time, such as a volatile memory inside of a computer system serving as a server or a client in that case.

### SUMMARY

A video processing device according to a first aspect of the present invention is a video processing device for reducing noise in a picture obtained by decoding a video signal, the video processing device including: a noise reduction process selecting unit configured to, on a basis of quantization codes of each separate block constituting a target frame and results of motion determination of each separate block constituting the target frame, select at least one noise reduction process that is applied to the target frame from among a plurality of noise reduction processes having different characteristics from each other; and a noise reducing unit configured to apply the noise reduction process selected by the noise reduction process selecting unit to the target frame.

As used herein, the term “quantization code” means a parameter that defines the roughness of quantization by which a picture is encoded. Quantization codes are embedded in most of the video data encoded by any system of encoding. This makes it possible to easily obtain quantization codes without needing a special configuration. This suppresses cost increases. Further, in the foregoing configuration, a noise reduction process is selected on the basis of quantization codes and results of motion determination. This makes it possible to perform a more effective noise reduction process than in a configuration in which only quantization codes are referred to.

Further, a noise reduction process is selected from among a plurality of noise reduction processes having different characteristics from each other. This makes it possible to perform an effective noise reduction process even in a case where there is noise of various characteristics generated in a video signal.

In this way, the foregoing configuration makes it possible to perform an effective noise reduction process while suppressing cost increases.

In the first aspect, a video processing device according to a second aspect of the present invention is preferably configured to further include an intensity changing unit configured to, on a basis of the quantization codes of each separate block constituting the target frame and the results of motion determination of each separate block constituting the target frame, change an intensity of the noise reduction process selected by the noise reduction processing selecting unit.

In the foregoing configuration, an intensity of the noise reduction process selected by the noise reduction processing selecting unit is changed on the basis of the quantization codes of each separate block constituting the target frame and the results of motion determination of each separate block constituting the target frame. This makes it possible to perform a more effective noise reduction process.

Further, in the second aspect, a video processing device according to a third aspect of the present invention is preferably configured such that: the plurality of noise reduction processes include a block noise reduction process; and the intensity changing unit increases an intensity of the block noise reduction process when a number of blocks determined as moving is larger.

The inventors found that a picture having a great motion tend to contain more block noise.

In the foregoing configuration, the intensity of the block noise reduction process is increased when the number of blocks determined as moving is larger. This makes it possible to perform a more effective noise reduction process according to a motion of a picture.

Further, in the third aspect, a video processing device according to a fourth aspect of the present invention is preferably configured such that: the block noise reduction process is a process that is performed with reference to the target frame and one or more other frames; and the intensity changing unit increases a number of the other frames that are referred to, when the number of blocks determined as moving is larger.

According to the foregoing configuration, in the block noise reduction process that is performed with reference to the target frame and one or more other frames, the number of the other frames that are referred to is increased when the number of blocks determined as moving is larger. This makes it possible to perform a more effective noise reduction process.

Further, in the third aspect, a video processing device according to a fifth aspect of the present invention is preferably configured such that: the block noise reduction process is a process that is performed with reference to a target pixel on the target frame and pixels included in a reference region surrounding the target pixel; and the intensity changing unit sets the reference region wider when the number of blocks determined as moving is larger.

According to the foregoing configuration, in the block noise reduction process that is performed with reference to a target pixel on the target frame and pixels included in a reference region surrounding the target pixel; the reference region is set wider when the number of blocks determined as moving is larger. This makes it possible to perform a more effective noise reduction process.

Further, in any one of the second to fifth aspects, a video processing device according to a sixth aspect of the present invention is preferably configured such that: the plurality of noise reduction processes include a mosquito noise reduction process; and the intensity changing unit increases an intensity of the mosquito noise reduction process when a number of blocks having quantization codes exceeding a predetermined threshold value is larger.

The inventors found that more mosquito noise is contained when the number of blocks having great quantization codes is larger.

In the foregoing configuration, the intensity of the mosquito noise reduction process is increased when the number of blocks having quantization codes exceeding a predetermined threshold value is larger. This makes it possible to perform a more effective noise reduction process.

Further, in the sixth aspect, a video processing device according to a seventh aspect of the present invention is preferably configured such that: the mosquito noise reduction process is a process that is performed with reference to the target frame and one or more other frames; and the intensity changing unit increases a number of the other frames that are referred to, when the number of blocks having quantization codes exceeding the predetermined threshold value is larger.

According to the foregoing configuration, in the mosquito noise reduction process that is performed with reference to the target frame and one or more other frames, the number of the other frames that are referred to is increased when the number of blocks having quantization codes exceeding the predetermined threshold value is larger. This makes it possible to perform a more effective noise reduction process.

Further, in the sixth aspect, a video processing device according to an eighth aspect of the present invention is preferably configured such that: the mosquito noise reduction process is a process that is performed with reference to a target pixel on the target frame and pixels included in a reference region surrounding the target pixel; and the intensity changing unit sets the reference region wider when the number of blocks having quantization codes exceeding the predetermined threshold value is larger.

According to the foregoing configuration, in the mosquito noise reduction process that is performed with reference to a target pixel on the target frame and pixels included in a reference region surrounding the target pixel, the reference region is set wider when the number of blocks having quantization codes exceeding the predetermined threshold value is larger. This makes it possible to perform a more effective noise reduction process.

Further, in any one of the sixth to eighth aspects, a video processing device according to a ninth aspect of the present invention is preferably configured such that the intensity changing unit makes the predetermined threshold value smaller when the number of blocks determined as moving is larger.

The inventors found that in a case where the original picture contains “glittering noise”, the resulting picture per se may contain much noise even if the compression ratio is set low, i.e. even if the quantization codes are set small, and that such a picture tends to be determined by motion determination as including many “moving” blocks.

In the foregoing configuration, the predetermined threshold value is made smaller when the number of blocks determined as moving is larger. This makes it possible to suitably reduce such “glittering noise”.

Further, in the any one of the first to ninth aspects, a video processing device according to a tenth aspect of the present invention is preferably configured such that the noise reduction process selecting unit identifies a noise generation pattern in a target region set on the target frame and selects at least one noise reduction process that is applied to the target region from among the plurality of noise reduction processes on a basis of a result of the identification.

In the foregoing configuration, a noise generation pattern in a target region set on the target frame is identified, and at least one noise reduction process that is applied to the target region is selected from among the plurality of noise reduction processes on the basis of a result of the identification. This makes it possible to perform a finer noise reduction process.

Further, a video processing method according to an eleventh aspect of the present invention is a video processing method for reducing noise in a picture obtained by decoding a video signal, the video processing method including: a noise reduction process selecting step of, on a basis of quantization codes of each separate block constituting a target frame and results of motion determination of each separate block constituting the target frame, selecting at least one noise reduction process that is applied to the target frame from among a plurality of noise reduction processes having different characteristics from each other; and a noise reducing step of applying the noise reduction process selected in the noise reduction process selecting step to the target frame.

The video processing method thus configured brings about effects that are similar to those which are brought about by the aforementioned video processing device.

A video processing device according to a twelfth aspect of the present invention is a video processing device for reducing noise in a picture obtained by decoding a video signal, the video processing device including: a setting unit configured to set a mosquito noise reduction parameter on a basis of quantization codes of each separate block constituting a target frame and either frequency characteristics or edge information of each separate block constituting the target frame; and a noise reducing unit configured to subject the target frame to a mosquito noise reduction process using the mosquito noise reduction parameter set by the setting unit.

As used herein, the term “quantization code” means a parameter that defines the roughness of quantization by which a picture is encoded. Quantization codes are embedded in most of the video data encoded by any system of encoding. This makes it possible to easily obtain quantization codes without needing a special configuration. This suppresses cost increases.

Further, in the foregoing configuration, the setting unit sets a mosquito noise reduction parameter on the basis of the quantization codes and the frequency characteristics or the edge information. Furthermore, the noise reducing unit subjects the target frame to a mosquito noise reduction process using the mosquito noise reduction parameter.

According to the inventors' findings, the generation of mosquito noise correlates with the frequency characteristics and the edge information. Specifically, the frequency characteristics contain information concerning the steepness of a change in luminance, and the edge information contains information concerning the steepness of a change in chromaticity. It should be noted that the steepness of a change in luminance and the steepness of a change in chromaticity both correlate with the generation of mosquito noise. For this reason, the foregoing configuration makes it possible to effectively reduce mosquito noise.

Further, in the twelfth aspect, a video processing device according to a thirteenth aspect of the present invention is preferably configured to further include a frequency determining unit configured to derive a histogram of frequency components in the target frame as the frequency characteristics on a basis of frequency components of each separate block constituting the target frame, wherein the setting unit derives, from the histogram of frequency components, a first frequency component whose frequency is lower than a predetermined first frequency, a second frequency component whose frequency is higher than the first frequency and lower than a predetermined second frequency, and a third frequency component whose frequency is higher than the predetermined second frequency, and sets the mosquito noise reduction parameter larger when a percentage of the third frequency component with respect to all of the frequency components is higher.

A high percentage of the third frequency component with respect to all of the frequency components can be rephrased as a high percentage of a high-frequency component with respect to all of the frequency components. A high percentage of a high-frequency component in each separate block constituting the target frame indicates that the picture represented by the target frame is a clear picture or a picture containing much noise. Therefore, by the setting unit setting the mosquito noise reduction parameter larger when the percentage of a high-frequency component is higher, the noise reducing unit is allowed to perform an effective mosquito noise reduction process on the target frame.

Further, in the thirteenth aspect, a video processing device according to a fourteenth aspect of the present invention is preferably configured such that the setting unit sets the mosquito noise reduction parameter smaller when, in the histogram of frequency component, a percentage of the first frequency component with respect to all of the frequency components is higher.

A high percentage of the first frequency component with respect to all of the frequency components can be rephrased as a high percentage of a low-frequency component with respect to all of the frequency components. When the percentage of a low-frequency component in each separate block constituting the target frame is high, there is a high possibility that the picture represented by the target frame is a picture with few changes in luminance and chromaticity. Since the possibility of mosquito noise being generated in such a picture is low, the setting unit sets the mosquito noise reduction parameter smaller when the percentage of a low-frequency component is higher. This prevents the noise reducing unit from performing an excessive noise reduction process on a picture that is unlikely to suffer from mosquito noise, thus preventing deterioration in image quality of the picture represented by the target frame.

Further, in the thirteenth or fourteenth aspect, a video processing device according to a fifteenth aspect of the present invention is preferably configured such that the setting unit sets the mosquito noise reduction parameter larger when a number of blocks having quantization codes exceeding a predetermined threshold value is larger.

The term “quantization code” means a parameter that reflects the compression ratio at which a picture is encoded and decoded. When the quantization code takes on a larger value, the picture is encoded and decoded at a higher compression ratio, so that the possibility of mosquito noise being generated becomes higher. In the foregoing configuration, the setting unit sets the mosquito noise reduction parameter larger when a number of blocks having quantization codes exceeding a predetermined threshold value is larger. This allows the noise reducing unit to perform an effective mosquito noise reduction process on the target frame.

Further, in the twelfth aspect, a video processing device according to a sixteenth aspect of the present invention is preferably configured to further include an edge information deriving unit configured to perform an edge information extraction process on pixel values of the pixels constituting the target frame, and for deriving an edge histogram in the target frame as the edge information, wherein the setting unit derives, from the edge histogram, a percentage of a number of pixels whose luminance difference is greater than a predetermined luminance difference with respect to a total number of pixels constituting the target frame, and sets the mosquito noise reduction parameter larger when the percentage is higher.

The percentage of the number of pixels whose luminance difference is greater than a predetermined luminance difference with respect to the total number of pixels constituting the target frame is a parameter that reflects the multitude of edge regions included in the target frame. In the foregoing configuration, since the setting unit sets the mosquito noise reduction parameter larger when the percentage is higher, the noise reducing unit can perform an effective mosquito noise reduction process on the target frame.

Further, in any one of the thirteenth to fifteenth aspects, a video processing device according to a seventeenth aspect of the present invention is preferably configured such that the setting unit makes the predetermined threshold value smaller when a percentage of the third frequency component is higher.

In a case where the original picture contains “glittering noise”, the resulting picture per se may contain much noise even if the compression ratio is set low, i.e. even if the quantization codes are set small. The inventors found that such a picture tends to be determined by frequency determination as having a high percentage of the third frequency component, i.e. a high percentage of a high-frequency component. In the foregoing configuration, the predetermined threshold value is made smaller when the percentage of a high-frequency component is higher. This makes it possible to suitably reduce such “glittering noise”.

Further, a video processing method according to an eighteenth aspect of the present invention is a video processing method for reducing noise in a picture obtained by decoding a video signal, the video processing method including: a setting step of setting a mosquito noise reduction parameter on a basis of quantization codes of each separate block constituting a target frame, as well as frequency characteristics of each separate block constituting the target frame or edge information of each separate pixels constituting the target frame; and a noise reducing step of subjecting the target frame to a mosquito noise reduction process using the mosquito noise reduction parameter set in the setting step.

The video processing method thus configured brings about effects that are similar to those which are brought about by the aforementioned video processing device.

Further, a video processing device according to a nineteenth aspect of the present invention is a video processing device for reducing noise in a picture obtained by decoding a video signal, the video processing device including: an intensity determining unit configured to determine an intensity of a color noise reduction process on a basis of quantization codes of each separate block constituting a target frame, a number of primary color pixels included in the target frame, and an area formed by primary pixels adjacent to each other; and a noise reducing unit configured to apply a color noise reduction process having an intensity determined by the intensity determining unit to the target frame.

The inventors found that color noise can be more effectively reduced by setting the intensity of a color noise reduction process on the basis of the number of primary color pixels included in the target frame and an area formed by primary pixels adjacent to each other.

In the foregoing configuration, the intensity determining unit determines an intensity of a color noise reduction process on a basis of quantization codes of each separate block constituting a target frame, a number of primary color pixels included in the target frame, and an area formed by primary pixels adjacent to each other, and the noise reducing unit applies a color noise reduction process having an intensity determined by the intensity determining unit to the target frame. This makes it possible to achieve an effective color noise reduction process.

Further, in the foregoing configuration, the intensity of the color noise reduction process is determined further in accordance with quantization codes. This makes a more effective color noise reduction process possible.

As used herein, the term “quantization code” means a parameter that defines the roughness of quantization by which a picture is encoded. Quantization codes are embedded in most of the video data encoded by any system of encoding. This makes it possible to easily obtain quantization codes without needing a special configuration. This suppresses cost increases.

In this way, the foregoing configuration makes it possible to perform an effective color noise reduction process while suppressing cost increases.

Further, in the nineteenth aspect, a video processing device according to a twentieth aspect of the present invention is preferably configured such that: the color noise reduction process includes a mosquito noise reduction process; and the intensity determining unit makes an intensity of the mosquito noise reduction process higher when the number of primary color pixels included in the target frame is larger and when the area formed by primary pixels adjacent to each other is smaller.

Since color noise is generated, for example, by a dark current, for example, in an imaging element that takes a picture, it generally has a primary color or a color close to a primary color, and each area formed by color noise is small. When the number of primary color pixels included in the target frame is larger and when the area formed by primary pixels adjacent to each other is smaller, it means that the target frame contains much color noise. By executing a mosquito noise reduction process on such a target frame at a high intensity, color noise can be processed to be hardly seen by the user. Therefore, the foregoing configuration makes it possible to effectively reduce color noise.

Further, in the twentieth aspect, a video processing device according to a twenty-first aspect of the present invention is preferably configured such that the intensity determining unit makes an intensity of the mosquito noise reduction process higher when a number of blocks having quantization codes exceeding a predetermined threshold value is larger.

A large number of blocks having quantization codes exceeding a predetermined threshold value means a larger number of blocks encoded at a high compression ratio. The color of color noise is a primary color or a color close to a primary color. The color of a pixel forming color noise and the color of a pixel adjacent thereto greatly differ in luminance or chromaticity from each other. Mosquito noise is easily generated in an edge region where there is a great difference in luminance or chromaticity. That is, it can be said that mosquito noise is easily generated when a picture containing color noise is encoded at a high compression ratio. In the foregoing configuration, the intensity of the mosquito noise reduction process is made higher when the number of blocks having quantization codes exceeding a predetermined threshold value is larger. This makes it possible to effectively reduce color noise and mosquito noise caused by color noise.

Further, in any one of the nineteenth to twenty-first aspects, a video processing device according to a twenty-second aspect of the present invention is preferably configured such that: the color noise reduction process includes a color gain reduction process of reducing a gain of a primary color determined as noise; and in a case where a number of blocks having quantization codes exceeding a predetermined threshold value exceeds a predetermined percentage, the intensity determining unit makes an intensity of the color gain reduction process higher when the area formed by primary pixels adjacent to each other is smaller.

As an aspect of the color noise reduction process, a color gain reduction process of reducing a gain of a primary color determined as noise is included. As mentioned above, the color of color noise is a primary color or a color close to a primary color. By reducing a gain of the primary color, the color of color noise is converted from a primary color or a color close to a primary color into a color close to an achromatic color. A reduction in gain of a primary color makes color noise hardly seen by the user. The foregoing configuration makes it possible to effectively reduce color noise.

Further, a video processing method according to a twenty-third aspect of the present invention is a video processing method for reducing noise in a picture obtained by decoding a video signal, the video processing method including: an intensity determining step of determining an intensity of a color noise reduction process on a basis of quantization codes of each separate block constituting a target frame, a number of primary color pixels included in the target frame, and an area formed by primary pixels adjacent to each other; and a noise reducing step of applying a color noise reduction process having an intensity determined by the intensity determining unit to the target frame.

The video processing method thus configured brings about effects that are similar to those which are brought about by the aforementioned video processing device.

Further, a video processing device according to a twenty-fourth aspect of the present invention is a video processing device for reducing noise in a picture obtained by decoding a video signal, the video processing device including: a noise reduction process selecting unit configured to, on a basis of quantization codes of each separate block constituting a target frame and motion vector information of each separate block constituting the target frame, select at least one noise reduction process that is applied to the target frame from among a plurality of noise reduction processes having different characteristics from each other; and a noise reducing unit configured to apply the noise reduction process selected by the noise reduction process selecting unit to the target frame.

As used herein, the term “quantization code” means a parameter that defines the roughness of quantization by which a picture is encoded. Quantization codes are embedded in most of the video data encoded by any system of encoding. This makes it possible to easily obtain quantization codes without needing a special configuration. Further, no motion detection circuit is necessary in the configuration in which motion vector information is referred to. This suppresses cost increases. Further, in the foregoing configuration, a noise reduction process is selected on the basis of quantization codes and motion vector information. This makes it possible to perform an effective noise reduction process.

Further, a noise reduction process is selected from among a plurality of noise reduction processes having different characteristics from each other. This makes it possible to perform an effective noise reduction process even in a case where there is noise of various characteristics generated in a video signal.

In this way, the foregoing configuration makes it possible to perform an effective noise reduction process while suppressing cost increases.

Further, in the twenty-fourth aspect, a video processing device according to a twenty-fifth aspect of the present invention is preferably configured to further include an intensity changing unit configured to, on a basis of the quantization codes of each separate block constituting the target frame and the motion vector information of each separate block constituting the target frame, change an intensity of the noise reduction process selected by the noise reduction processing selecting unit.

In the foregoing configuration, an intensity of the noise reduction process selected by the noise reduction processing selecting unit is changed on the basis of the quantization codes of each separate block constituting the target frame and the motion vector information of each separate block constituting the target frame. This makes it possible to perform a more effective noise reduction process.

Further, in the twenty-fifth aspect, a video processing device according to a twenty-sixth aspect of the present invention is preferably configured such that: the plurality of noise reduction processes include a block noise reduction process; and the intensity changing unit increases an intensity of the block noise reduction process when a number of blocks determined as moving is larger.

The inventors found that a picture having a great motion tend to contain more block noise.

In the foregoing configuration, the intensity of the block noise reduction process is increased when the number of blocks determined as moving is larger. This makes it possible to perform a more effective noise reduction process according to a motion of a picture.

Further, in the twenty-sixth aspect, a video processing device according to a twenty-seventh aspect of the present invention is preferably configured such that: the block noise reduction process is a process that is performed with reference to the target frame and one or more other frames; and the intensity changing unit increases a number of the other frames that are referred to, when the number of blocks determined as moving is larger.

According to the foregoing configuration, in the block noise reduction process that is performed with reference to the target frame and one or more other frames, the number of the other frames that are referred to is increased when the number of blocks determined as moving is larger. This makes it possible to perform a more effective noise reduction process.

Further, in the twenty-sixth aspect, a video processing device according to a twenty-eighth aspect of the present invention is preferably configured such that: the block noise reduction process is a process that is performed with reference to a target pixel on the target frame and pixels included in a reference region surrounding the target pixel; and the intensity changing unit sets the reference region wider when the number of blocks determined as moving is larger.

According to the foregoing configuration, in the block noise reduction process that is performed with reference to a target pixel on the target frame and pixels included in a reference region surrounding the target pixel; the reference region is set wider when the number of blocks determined as moving is larger. This makes it possible to perform a more effective noise reduction process.

Further, in any one of the twenty-fifth to twenty-eighth aspects, a video processing device according to a twenty-ninth aspect of the present invention is preferably configured such that: the plurality of noise reduction processes include a mosquito noise reduction process; and the intensity changing unit increases an intensity of the mosquito noise reduction process when a number of blocks having quantization codes exceeding a predetermined threshold value is larger.

The inventors found that more mosquito noise is contained when the number of blocks having great quantization codes is larger.

In the foregoing configuration, the intensity of the mosquito noise reduction process is increased when the number of blocks having quantization codes exceeding a predetermined threshold value is larger. This makes it possible to perform a more effective noise reduction process.

Further, in the twenty-ninth aspect, a video processing device according to a thirtieth aspect of the present invention is preferably configured such that: the mosquito noise reduction process is a process that is performed with reference to the target frame and one or more other frames; and the intensity changing unit increases a number of the other frames that are referred to, when the number of blocks having quantization codes exceeding the predetermined threshold value is larger.

According to the foregoing configuration, in the mosquito noise reduction process that is performed with reference to the target frame and one or more other frames, the number of the other frames that are referred to is increased when the number of blocks having quantization codes exceeding the predetermined threshold value is larger. This makes it possible to perform a more effective noise reduction process.

Further, in the twenty-ninth aspect, a video processing device according to a thirty-first aspect of the present invention is preferably configured such that: the mosquito noise reduction process is a process that is performed with reference to a target pixel on the target frame and pixels included in a reference region surrounding the target pixel; and the intensity changing unit sets the reference region wider when the number of blocks having quantization codes exceeding the predetermined threshold value is larger.

According to the foregoing configuration, in the mosquito noise reduction process that is performed with reference to a target pixel on the target frame and pixels included in a reference region surrounding the target pixel, the reference region is set wider when the number of blocks having quantization codes exceeding the predetermined threshold value is larger. This makes it possible to perform a more effective noise reduction process.

Further, in any one of the twenty-ninth to thirty-first aspects, a video processing device according to a thirty-second aspect of the present invention is preferably configured such that the intensity changing unit makes the predetermined threshold value smaller when the number of blocks determined as moving is larger.

The inventors found that in a case where the original picture contains “glittering noise”, the resulting picture per se may contain much noise even if the compression ratio is set low, i.e. even if the quantization codes are set small, and that such a picture tends to be determined by motion determination as including many “moving” blocks.

In the foregoing configuration, the predetermined threshold value is made smaller when the number of blocks determined as moving is larger. This makes it possible to suitably reduce such “glittering noise”.

Further, in any one of the twenty-fourth to thirty-second aspects, a video processing device according to a thirty-third aspect of the present invention is preferably configured such that the noise reduction process selecting unit identifies a noise generation pattern in a target region set on the target frame and selects at least one noise reduction process that is applied to the target region from among the plurality of noise reduction processes on a basis of a result of the identification.

In the foregoing configuration, a noise generation pattern in a target region set on the target frame is identified, and at least one noise reduction process that is applied to the target region is selected from among the plurality of noise reduction processes on the basis of a result of the identification. This makes it possible to perform a finer noise reduction process.

Further, a video processing method according to a thirty-fourth aspect of the present invention is a video processing method for reducing noise in a picture obtained by decoding a video signal, the video processing method including: a noise reduction process selecting step of, on a basis of quantization codes of each separate block constituting a target frame and motion vector information of each separate block constituting the target frame, selecting at least one noise reduction process that is applied to the target frame from among a plurality of noise reduction processes having different characteristics from each other; and a noise reducing step of applying the noise reduction process selected in the noise reduction process selecting step to the target frame.

The video processing method thus configured brings about effects that are similar to those which are brought about by the aforementioned video processing device.

Further, a video processing device according to a thirty-fifth aspect of the present invention is a video processing device for reducing noise in a picture obtained by decoding a video signal, the video processing device including: a setting unit configured to obtain quantization code values of each separate block constituting a target frame, for calculating a noise reduction parameter in the target frame on a basis of each of the quantization code values, and for setting a noise reduction process intensity within a predetermined range to have a positive correlation with the noise reduction parameter within a predetermined range; and a noise reducing unit configured to subject the target frame to a noise reduction process using the noise reduction process intensity set by the setting unit.

In the foregoing configuration, the noise reduction parameter is a continuous parameter that is calculated on the basis of the quantization code values of each separate block constituting the target frame. Moreover, in a predetermined range, the noise reduction process intensity is a continuous parameter that has a positive correlation with the noise reduction parameter. This allows the setting unit to set a continuous noise reduction process intensity on the basis of the quantization codes values of each separate block constituting the target frame, and allows the noise reducing unit to perform a noise reduction process at a continuous intensity. Therefore, the video processing device according to an embodiment of the present invention can perform a noise reduction process on the target frame at a suitable intensity in accordance with the quantization code values of each separate block constituting the target frame.

Further, in the thirty-fifth aspect, a video processing device according to a thirty-sixth aspect of the present invention is preferably configured such that the setting unit calculates the noise reduction parameter by obtaining a weighted sum by weighting each quantization code value included in the target frame with a number of blocks having the quantization code value.

In the foregoing configuration, the setting unit can calculate the noise reduction parameter suitable to the target frame on the basis of the quantization codes values of each separate block included in the target frame. Therefore, the video processing device according to an embodiment of the present invention can perform a noise reduction process on the target frame at a suitable intensity in accordance with the quantization code values of each separate block constituting the target frame.

Further, in the thirty-fifth or thirty-sixth aspect, a video processing device according to a thirty-seventh aspect of the present invention is preferably configured such that the positive correlation that the setting unit uses in setting the noise reduction process intensity is expressed by a linear function.

In the foregoing configuration, the setting unit can set the noise reduction process intensity and the noise reduction parameter to have a linear correlation with each other.

Further, in any one of the thirty-fifth to thirty-seventh aspects, a video processing device according to a thirty-eighth aspect of the present invention is preferably configured such that the noise reduction process intensity does not depend on the noise reduction parameter in a range of the noise reduction parameter from 0 to a lower limit of the predetermined range and in a range of the noise reduction parameter from an upper limit of the predetermined range to a maximum value of the noise reduction parameter.

In the foregoing configuration, in such a range that noise contained in the target frame depends on the noise reduction parameter, the noise reduction process intensity and the noise reduction parameter have a positive correlation with each other. Therefore, the setting unit can set the noise reduction process intensity suitably in accordance with the quantization codes values of each separate block included in the target frame.

Further, in any one of the thirty-fifth to thirty-eighth aspects, a video processing device according to a thirty-ninth aspect of the present invention is preferably configured such that the noise reduction process that the noise reducing unit performs include at least either a block noise reduction process or a mosquito noise reduction process.

Block noise and mosquito noise tend to occur with increased frequency depending on the compression ratio at which a picture is encoded and decoded. In the foregoing configuration, the noise reducing unit subjects the target frame to the noise reduction process including at least either a block noise reduction process or a mosquito noise reduction process. Therefore, the noise reducing unit can perform an effective noise reduction process.

Further, a video processing method according to a fortieth aspect of the present invention includes: a setting unit configured to obtain quantization code values of each separate block constituting a target frame, of calculating a noise reduction parameter in the target frame on a basis of each of the quantization code values, and of setting a noise reduction process intensity within a predetermined range to have a positive correlation with the noise reduction parameter within a predetermined range; and a noise reducing unit configured to subject the target frame to a noise reduction process using the noise reduction process intensity set by the setting unit.

The video processing method thus configured brings about effects that are similar to those which are brought about by the aforementioned video processing device.

Further, a video processing device according to a forty-first aspect of the present invention includes: a setting unit configured to set an offset of a noise reduction parameter on a basis of quantization codes of each separate block constituting an I picture contained in video data; a changing unit configured to change the offset in accordance with a frame interval between I pictures; and a noise reducing unit configured to subject the video data to a noise reduction process using the noise reduction parameter including the offset changed by the changing unit.

The inventors found that a frame interval between I pictures and a noise amount correlate with each other.

In the foregoing configuration, the setting unit sets the offset on the basis of quantization codes of each separate block constituting an I picture contained in video data, and the changing unit changes the offset in accordance with the frame interval between I pictures. Therefore, the video processing device can perform an effective noise reduction process.

As used herein, the term “quantization code” means a parameter that defines the roughness of quantization by which a picture is encoded. Further, the frame interval between I pictures is a parameter that an encoding device sets in encoding a picture. Quantization codes and the frame interval between I pictures embedded in most of the video data encoded by any system of encoding. This makes it possible to easily obtain quantization codes and the frame interval between I pictures without needing a special configuration.

Therefore, the foregoing configuration makes it possible to perform an effective noise reduction process while suppressing cost increases.

Further, in the forty-first aspect, a video processing device according to a forty-second aspect of the present invention is preferably configured such that the changing unit changes the offset to have a positive correlation with the frame interval between I pictures.

The inventors found that a frame interval between I pictures and a noise amount have a positive correlation with each other.

In the foregoing configuration, the changing unit changes the offset so that it takes on a greater value when the frame interval between I pictures is longer. That is, when the frame interval between I pictures is longer, the noise reducing unit performs a noise reduction process on the picture at a higher intensity. This makes it possible to perform an appropriate noise reduction process in accordance with changes in the frame interval between I pictures.

Further, in the forty-second aspect, a video processing device according to a forty-third aspect of the present invention is preferably configured such that the changing unit further changes the offset to have a positive correlation with a frame interval between P pictures contained in the video data.

The inventors found that a frame interval between P pictures and a noise amount have a positive correlation with each other.

In the foregoing configuration, the changing unit further changes the offset so that it takes on a greater value when the frame interval between P pictures is longer. That is, when the frame interval between P pictures is longer, the noise reducing unit performs a noise reduction process on the picture at a higher intensity. This makes it possible to perform an appropriate noise reduction process by taking into account the changes in the frame interval between P pictures in addition to the changes in the frame interval between I pictures.

Further, in the forty-third aspect, a video processing device according to a forty-fourth aspect of the present invention is preferably configured such that the changing unit derives the offset on a basis of a sum of (a) a product of a first coefficient and the frame interval between I pictures and (b) a product of a second coefficient and the frame interval between P pictures, the second coefficient being smaller than the first coefficient.

The changing unit derives a change in the offset based on the frame interval between I pictures by deriving (a) the product of the first coefficient and the frame interval between I pictures. Further, the changing unit derives a change in the offset based on the frame interval between P pictures by deriving (b) the product of the second coefficient and the frame interval between P pictures. Furthermore, the changing unit derives the offset on the basis of the sum of the change in the offset based on the frame interval between I and the change in the offset based on the frame interval between P.

Here, the first coefficient is greater than the second coefficient. The configuration is based on the inventors' findings that the frame interval between I is more important than the frame interval between P as a factor that causes deterioration in the image quality of a picture (generates noise). The foregoing configuration makes it possible to perform a noise reduction process on a picture according to the degree of deterioration in the image quality of the picture due to the frame interval between I and the frame interval between P.

Further, in any one the forty-first to forth-fourth aspects, a video processing device according to a forty-second aspect of the present invention is preferably configured such that the setting unit sets the offset larger when a number of blocks which, of blocks constituting the I picture, have quantization codes exceeding a predetermined threshold value is larger.

In the foregoing configuration, the setting unit sets the offset larger when a number of blocks which, of blocks constituting the I picture, have quantization codes exceeding a predetermined threshold value is larger. This makes it possible to perform a noise reduction process at a higher intensity when the compression ratio at which the picture is compressed is higher.

Further, a video processing device according to a forty-sixth aspect of the present invention includes: a setting step of setting an offset of a noise reduction parameter on a basis of quantization codes of each separate block constituting an I picture contained in video data; a changing step of changing, in accordance with a frame interval between I pictures, the offset set by the setting unit; and a noise reducing step of subjecting the video data to a noise reduction process using the noise reduction parameter including the offset changed by the changing unit.

The video processing method thus configured brings about effects that are similar to those which are brought about by the aforementioned video processing device.

Further, a television receiver including a video processing device according to any of the embodiments described above is also encompassed in the scope of the present invention.

Further, a program for causing a computer to operate as each of the units of a video processing device according to any of the embodiments described above and a computer-readable recording medium containing such a program are also encompassed in the scope of the present invention.

The present invention is not limited to the description of the embodiments above, but may be altered by a skilled person within the scope of the claims. An embodiment based on a proper combination of technical means disclosed in different embodiments is encompassed in the technical scope of the present invention. Furthermore, a new technical feature can be formed by a combination of technical means disclosed in different embodiments.

### INDUSTRIAL APPLICABILITY

The present invention is suitably applicable to a video processing device for reducing noise in pictures.

### REFERENCE SIGNS LIST

1100, 2100, 3100, 4100, 5100, 6100 Video processing device
110 Picture obtaining section
120 Decoding process section
130 Quantization parameter obtaining section
140 Storage section
1150, 3150, 4150 Noise amount calculating section (noise reduction processing selecting unit, intensity changing unit)
2150, 5150, 6150 Noise amount calculating section (setting unit)
1160, 2160, 3160, 4160, 5160, 6160 Noise reduction process section (noise reducing unit)
1200 Motion determining section
2200 Frequency determining section (frequency determining unit)
3200 Saturation determining section
5200 NR discriminant value calculating section
6200 Offset calculating section
161 High-frequency filter
162 Edge filter
171 Coring process section
172 Sharpness process section

1-49. (canceled)

50. A video processing device for reducing noise in a picture obtained by decoding a video signal, the video processing device comprising:
a noise reduction process selecting unit configured to, on a basis of quantization codes of each separate block constituting a target frame and results of motion determination of each separate block constituting the target frame, select at least one noise reduction process that is applied to the target frame from among a plurality of noise reduction processes having different characteristics from each other; and
a noise reducing unit configured to apply the noise reduction process selected by the noise reduction process selecting unit to the target frame,
the video processing device further comprising an intensity changing unit configured to, on a basis of the quantization codes of each separate block constituting the target frame and the results of motion determination of each separate block constituting the target frame, change an intensity of the noise reduction process selected by the noise reduction processing selecting unit, wherein:
the plurality of noise reduction processes include a block noise reduction process; and
the intensity changing unit increases an intensity of the block noise reduction process when a number of blocks determined as moving is larger.

51. The video processing device as set forth in claim 50, wherein:
the block noise reduction process is a process that is performed with reference to the target frame and one or more other frames; and
the intensity changing unit increases a number of the other frames that are referred to, when the number of blocks determined as moving is larger.

52. The video processing device as set forth in claim 50, wherein:
the block noise reduction process is a process that is performed with reference to a target pixel on the target frame and pixels included in a reference region surrounding the target pixel; and
the intensity changing unit sets the reference region wider when the number of blocks determined as moving is larger.

53. The video processing device as set forth in claim 50, wherein:
the plurality of noise reduction processes include a mosquito noise reduction process; and
the intensity changing unit increases an intensity of the mosquito noise reduction process when a number of blocks having quantization codes exceeding a predetermined threshold value is larger.

54. The video processing device as set forth in claim 53, wherein:
the mosquito noise reduction process is a process that is performed with reference to the target frame and one or more other frames; and
the intensity changing unit increases a number of the other frames that are referred to, when the number of blocks having quantization codes exceeding the predetermined threshold value is larger.

55. The video processing device as set forth in claim 53, wherein:
the mosquito noise reduction process is a process that is performed with reference to a target pixel on the target frame and pixels included in a reference region surrounding the target pixel; and
the intensity changing unit sets the reference region wider when the number of blocks having quantization codes exceeding the predetermined threshold value is larger.

56. The video processing device as set forth in claim 53, wherein the intensity changing unit makes the predetermined threshold value smaller when the number of blocks determined as moving is larger.

57. The video processing device as set forth in claim 50, wherein the noise reduction process selecting unit identifies a noise generation pattern in a target region set on the target frame and selects at least one noise reduction process that is applied to the target region from among the plurality of noise reduction processes on a basis of a result of the identification.

58. A video processing method for reducing noise in a picture obtained by decoding a video signal, the video processing method comprising:
a noise reduction process selecting step of, on a basis of quantization codes of each separate block constituting a target frame and results of motion determination of each separate block constituting the target frame, selecting at least one noise reduction process that is applied to the target frame from among a plurality of noise reduction processes having different characteristics from each other; and
a noise reducing step of applying the noise reduction process selected in the noise reduction process selecting step to the target frame,
the video processing method further comprising an intensity changing step of, on a basis of the quantization codes of each separate block constituting the target frame and the results of motion determination of each separate block constituting the target frame, changing an intensity of the noise reduction process selected in the noise reduction processing selecting step, wherein:
the plurality of noise reduction processes include a block noise reduction process; and
the intensity changing step increases an intensity of the block noise reduction process when a number of blocks determined as moving is larger.

59. A video processing device for reducing noise in a picture obtained by decoding a video signal, the video processing device comprising:
a setting unit configured to set a mosquito noise reduction parameter on a basis of quantization codes of each separate block constituting a target frame, as well as frequency characteristics of each separate block constituting the target frame or edge information of each separate pixels constituting the target frame; and
a noise reducing unit configured to subject the target frame to a mosquito noise reduction process using the mosquito noise reduction parameter set by the setting unit,
the video processing device further comprising a frequency determining unit configured to derive a histogram of frequency components in the target frame as the frequency characteristics on a basis of frequency components of each separate block constituting the target frame, wherein
the setting unit derives, from the histogram of frequency components, a first frequency component whose frequency is lower than a predetermined first frequency, a second frequency component whose frequency is higher than the first frequency and lower than a predetermined second frequency, and a third frequency component whose frequency is higher than the predetermined second frequency, and sets the mosquito noise reduction parameter larger when a percentage of the third frequency component with respect to all of the frequency components is higher.

60. The video processing device as set forth in claim 59, wherein the setting unit sets the mosquito noise reduction parameter smaller when, in the histogram of frequency component, a percentage of the first frequency component with respect to all of the frequency components is higher.

61. The video processing device as set forth in claim 59, wherein the setting unit sets the mosquito noise reduction parameter larger when a number of blocks having quantization codes exceeding a predetermined threshold value is larger.

62. The video processing device as set forth in claim 59, further comprising an edge information deriving unit configured to perform an edge information extraction process on pixel values of the pixels constituting the target frame, and to derive an edge histogram in the target frame as the edge information, wherein
the setting unit derives, from the edge histogram, a percentage of a number of pixels whose luminance difference is greater than a predetermined luminance difference with respect to a total number of pixels constituting the target frame, and sets the mosquito noise reduction parameter larger when the percentage is higher.

63. The video processing device as set forth in claim 61, wherein the setting unit makes the predetermined threshold value smaller when a percentage of the third frequency component is higher.

64. A video processing method for reducing noise in a picture obtained by decoding a video signal, the video processing method comprising:
a setting step of setting a mosquito noise reduction parameter on a basis of quantization codes of each separate block constituting a target frame, as well as frequency characteristics of each separate block constituting the target frame or edge information of each separate pixels constituting the target frame; and
a noise reducing step of subjecting the target frame to a mosquito noise reduction process using the mosquito noise reduction parameter set in the setting step,
the video processing method further comprising a frequency determining step of deriving a histogram of frequency components in the target frame as the frequency characteristics on a basis of frequency components of each separate block constituting the target frame, wherein
the setting step derives, from the histogram of frequency components, a first frequency component whose frequency is lower than a predetermined first frequency, a second frequency component whose frequency is higher than the first frequency and lower than a predetermined second frequency, and a third frequency component whose frequency is higher than the predetermined second frequency, and sets the mosquito noise reduction parameter larger when a percentage of the third frequency component with respect to all of the frequency components is higher.

65. A video processing device for reducing noise in a picture obtained by decoding a video signal, the video processing device comprising:
an intensity determining unit configured to determine an intensity of a color noise reduction process on a basis of quantization codes of each separate block constituting a target frame, a number of primary color pixels included in the target frame, and an area formed by primary pixels adjacent to each other; and
a noise reducing unit configured to apply a color noise reduction process having an intensity determined by the intensity determining unit to the target frame.

66. The video processing device as set forth in claim 65, wherein:
the color noise reduction process includes a mosquito noise reduction process; and
the intensity determining unit makes an intensity of the mosquito noise reduction process higher when the number of primary color pixels included in the target frame is larger and when the area formed by primary pixels adjacent to each other is smaller.

67. The video processing device as set forth in claim 66, wherein the intensity determining unit makes an intensity of the mosquito noise reduction process higher when a number of blocks having quantization codes exceeding a predetermined threshold value is larger.

68. The video processing device as set froth in claim 65, wherein:
the color noise reduction process includes a color gain reduction process of reducing a gain of a primary color determined as noise; and
in a case where a number of blocks having quantization codes exceeding a predetermined threshold value exceeds a predetermined percentage, the intensity determining unit makes an intensity of the color gain reduction process higher when the area formed by primary pixels adjacent to each other is smaller.

69. A video processing method for reducing noise in a picture obtained by decoding a video signal, the video processing method comprising:
an intensity determining step of determining an intensity of a color noise reduction process on a basis of quantization codes of each separate block constituting a target frame, a number of primary color pixels included in the target frame, and an area formed by primary pixels adjacent to each other; and
a noise reducing step of applying a color noise reduction process having an intensity determined in the intensity determining step to the target frame.

70. A video processing device for reducing noise in a picture obtained by decoding a video signal, the video processing device comprising:
a noise reduction process selecting unit configured to, on a basis of quantization codes of each separate block constituting a target frame and motion vector information of each separate block constituting the target frame, select at least one noise reduction process that is applied to the target frame from among a plurality of noise reduction processes having different characteristics from each other; and
a noise reducing unit configured to apply the noise reduction process selected by the noise reduction process selecting unit to the target frame,
the video processing device further comprising an intensity changing unit configured to, on a basis of the quantization codes of each separate block constituting the target frame and the motion vector information of each separate block constituting the target frame, change an intensity of the noise reduction process selected by the noise reduction processing selecting unit, wherein:
the plurality of noise reduction processes include a block noise reduction process; and
the intensity changing unit increases an intensity of the block noise reduction process when a number of blocks determined as moving is larger.

71. The video processing device as set forth in claim 70, wherein:
the block noise reduction process is a process that is performed with reference to the target frame and one or more other frames; and
the intensity changing unit increases a number of the other frames that are referred to, when the number of blocks determined as moving is larger.

72. The video processing device as set forth in claim 70, wherein:
the block noise reduction process is a process that is performed with reference to a target pixel on the target frame and pixels included in a reference region surrounding the target pixel; and
the intensity changing unit sets the reference region wider when the number of blocks determined as moving is larger.

73. The video processing device as set forth in claim 70, wherein:
the plurality of noise reduction processes include a mosquito noise reduction process; and
the intensity changing unit increases an intensity of the mosquito noise reduction process when a number of blocks having quantization codes exceeding a predetermined threshold value is larger.

74. The video processing device as set forth in claim 73, wherein:
the mosquito noise reduction process is a process that is performed with reference to the target frame and one or more other frames; and
the intensity changing unit increases a number of the other frames that are referred to, when the number of blocks having quantization codes exceeding the predetermined threshold value is larger.

75. The video processing device as set forth in claim 73, wherein:
the mosquito noise reduction process is a process that is performed with reference to a target pixel on the target frame and pixels included in a reference region surrounding the target pixel; and
the intensity changing unit sets the reference region wider when the number of blocks having quantization codes exceeding the predetermined threshold value is larger.

76. The video processing device as set forth in claim 73, wherein the intensity changing unit makes the predetermined threshold value smaller when the number of blocks determined as moving is larger.

77. The video processing device as set forth in claim 70, wherein the noise reduction process selecting unit identifies a noise generation pattern in a target region set on the target frame and selects at least one noise reduction process that is applied to the target region from among the plurality of noise reduction processes on a basis of a result of the identification.

78. A video processing method for reducing noise in a picture obtained by decoding a video signal, the video processing method comprising:
a noise reduction process selecting step of, on a basis of quantization codes of each separate block constituting a target frame and motion vector information of each separate block constituting the target frame, selecting at least one noise reduction process that is applied to the target frame from among a plurality of noise reduction processes having different characteristics from each other; and
a noise reducing step of applying the noise reduction process selected in the noise reduction process selecting step to the target frame,
the video processing method further comprising an intensity changing step of, on a basis of the quantization codes of each separate block constituting the target frame and the motion vector information of each separate block constituting the target frame, changing an intensity of the noise reduction process selected in the noise reduction processing selecting step, wherein:
the plurality of noise reduction processes include a block noise reduction process; and
the intensity changing step increases an intensity of the block noise reduction process when a number of blocks determined as moving is larger.

79. A video processing device comprising:
a setting unit configured to set an offset of a noise reduction parameter on a basis of quantization codes of each separate block constituting an I picture contained in video data;
a changing unit configured to change the offset in accordance with a frame interval between I pictures; and
a noise reducing unit configured to subject the video data to a noise reduction process using the noise reduction parameter including the offset changed by the changing unit.

80. The video processing device as set forth in claim 79, wherein the changing unit changes the offset to have a positive correlation with the frame interval between I pictures.

81. The video processing device as set forth in claim 80, wherein the changing unit further changes the offset to have a positive correlation with a frame interval between P pictures contained in the video data.

82. The video processing device as set forth in claim 81, wherein the changing unit derives the offset on a basis of a sum of (a) a product of a first coefficient and the frame interval between I pictures and (b) a product of a second coefficient and the frame interval between P pictures, the second coefficient being smaller than the first coefficient.

83. The video processing device as set forth in claim 79, wherein the setting unit sets the offset larger when a number of blocks which, of blocks constituting the I picture, have quantization codes exceeding a predetermined threshold value is larger.

84. A video processing method for reducing noise in a picture obtained by decoding a video signal, the video processing method comprising:
a setting step of setting an offset of a noise reduction parameter on a basis of quantization codes of each separate block constituting an I picture contained in the video data;
a changing step of changing the offset in accordance with a frame interval between I pictures; and
a noise reducing step of subjecting the video data to a noise reduction process using the noise reduction parameter including the offset changed in the changing step.

85. A television receiver comprising a video processing device as set forth in claim 50.

86. A non-transient computer-readable recording medium containing a program for causing a computer to operate as each of the units of a video processing device as set forth in claim 50.

87. A television receiver comprising a video processing device as set forth in claim 59.

88. A non-transient computer-readable recording medium containing a program for causing a computer to operate as each of the units of a video processing device as set forth in claim 59.

89. A television receiver comprising a video processing device as set forth in claim 65.

90. A non-transient computer-readable recording medium containing a program for causing a computer to operate as each of the units of a video processing device as set forth in claim 65.

91. A television receiver comprising a video processing device as set forth in claim 70.

92. A non-transient computer-readable recording medium containing a program for causing a computer to operate as each of the units of a video processing device as set forth in claim 70.

93. A television receiver comprising a video processing device as set forth in claim 79.

94. A non-transient computer-readable recording medium containing a program for causing a computer to operate as each of the units of a video processing device as set forth in claim 79.
